(19) United States
(12) Patent Application Publication
(10) Pub. No.: US 2023/0328714 A1
(43) Pub. Date: Oct. 12, 2023

(54) METHOD AND APPARATUS FOR DOWNLINK CONTROL INFORMATION INTERPRETATION IN WIRELESS COMMUNICATION SYSTEM

(71) Applicant: Samsung Electronics Co., Ltd., Gyeonggi-do (KR)

(72) Inventors: Kyungjun CHOI, Gyeonggi-do (KR); Seongmok LIM, Gyeonggi-do (KR); Youngrok JANG, Gyeonggi-do (KR); Hyoungju JI, Gyeonggi-do (KR)

(21) Appl. No.: 18/132,653

(22) Filed: Apr. 10, 2023

(30) Foreign Application Priority Data
Apr. 8, 2022 (KR) 10-2022-0043926
Apr. 8, 2022 (KR) 10-2022-0043945
Nov. 11, 2022 (KR) 10-2022-0150953

(51) Int. Cl. H04W 72/1263; H04W 72/23; H04L 5/00

(52) U.S. Cl. CPC H04W 72/1263; H04W 72/23; H04L 5/0051

(57) ABSTRACT

The disclosure relates to a 5G or 6G communication system for supporting a higher data transmission rate. The disclosure provides a method performed by a terminal in a wireless communication system. The method includes receiving, from a base station, a higher layer signal including time domain resource assignment (TDRA) information; receiving, from the base station, downlink control information (DCI) including an antenna port field; and identifying an antenna port table of a first mapping type and an antenna port table of a second mapping type based on the antenna port field, in case that the DCI includes multiple scheduling information of different mapping types.

### CROSS-REFERENCE TO RELATED APPLICATION(S)

This application is based on and claims priority under 35 U.S.C. § 119 to Korean Patent Application Nos. 10-2022-0043926, 10-2022-0043945 and 10-2022-0150953, which were filed in the Korean Intellectual Property Office on Apr. 8, 2022, Apr. 8, 2022 and Nov. 11, 2022, respectively, the entire disclosure of each of which is incorporated herein by reference.

### BACKGROUND

### 1. Field

The disclosure relates generally to operations of a terminal and a base station in a wireless communication system. More specifically, the disclosure relates to a method for interpreting an antenna port field of a downlink control information (DCI) format by a terminal and an apparatus for performing the same, and a method for interpreting, by a terminal, a phase tracking reference signal (PTRS) association field in a DCI format and an apparatus capable of performing the same.

### 2. Description of Related Art

Fifth generation (5G) mobile communication technologies define broad frequency bands such that high transmission rates and new services are possible, and can be implemented not only in “sub 6 gigahertz (GHz)” bands such as 3.5 GHz, but also in “above 6 GHz” bands referred to as millimeter wave (mmWave) including 28 GHz and 39 GHz. In addition, implementing sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies is being considered.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave. In addition, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, layer two (L2) pre-processing, and network slicing for providing a dedicated network specialized to a specific service are also being used to support services and to satisfy performance requirements.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) technologies for aiding driving determination by autonomous vehicles based on information regarding positions and states of vehicles transmitted by the vehicles and for enhancing user convenience, new radio unlicensed (NR-U) technologies aimed at system operations conforming to various regulation-related requirements in unlicensed bands, new radio (NR) user equipment (UE) power saving technologies, non-terrestrial network (NTN) technologies, which are UE-satellite direct communication technologies for providing coverage in an area in which communication with terrestrial networks is unavailable, and positioning technologies.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (for example, 2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices will be connected to communication networks, and it is expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), and mixed reality (MR). 5G performance improvement and complexity reduction may be accomplished by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional multiple input multiple output (FD-MIMO), array and large-scale antennas, metamaterial-based lenses and antennas for improving coverage of THz band signals, high-dimensional space multiplexing technology using orbital angular momentum (OAM), reconfigurable intelligent surface (RIS) technology, full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure has been made to address the above-mentioned problems and disadvantages, and to provide at least the advantages described below.

According to an aspect of the disclosure, a method performed by a terminal in a wireless communication system is provided. The method includes receiving, from a base station, a higher layer signal including time domain resource assignment (TDRA) information, receiving, from the base station, DCI including an antenna port field and identifying an antenna port table of a first mapping type and an antenna port table of a second mapping type based on the antenna port field, in case that the DCI includes multiple scheduling information of different mapping types.

According to another aspect of the disclosure, a method performed by a base station in a wireless communication system is provided. The method includes transmitting, to a terminal, a higher layer signal including TDRA information and transmitting, to the terminal, DCI including an antenna port field, wherein an antenna port table of a first mapping type and an antenna port table of a second mapping type are identified based on the antenna port field, in case that the DCI includes multiple scheduling information of different mapping types.

According to another aspect of the disclosure, a terminal in a wireless communication system is provided. The terminal includes a transceiver and a controller configured to receive, from a base station, a higher layer signal including TDRA information, receive, from the base station, DCI including an antenna port field, and identify an antenna port table of a first mapping type and an antenna port table of a second mapping type based on the antenna port field, in case that the DCI includes multiple scheduling information of different mapping types.

According to another aspect of the disclosure, a base station in a wireless communication system is provided. The base station includes a transceiver and a controller configured to transmit, to a terminal, a higher layer signal including TDRA information, and transmit, to the terminal, DCI including an antenna port field, wherein an antenna port table of a first mapping type and an antenna port table of a second mapping type are identified based on the antenna port field, in case that the DCI includes multiple scheduling information of different mapping types.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system, according to an embodiment;

FIG. 2 illustrates a frame, a subframe, and a slot structure in a wireless communication system, according to an embodiment;

FIG. 3 illustrates a configuration of a BWP in a wireless communication system, according to an embodiment;

FIG. 4 illustrates a configuration of a control resource set of a downlink control channel in a wireless communication system, according to an embodiment;

FIG. 5 illustrates a structure of a downlink control channel in a wireless communication system, according to an embodiment;

FIG. 6 illustrates a method for transmitting and receiving data by a base station and a terminal by considering a downlink data channel and a rate matching resource in a wireless communication system, according to an embodiment;

FIG. 7 illustrates frequency axis resource allocation of a physical downlink shared channel (PDSCH) in a wireless communication system, according to an embodiment;

FIG. 8 illustrates time axis resource allocation of a PDSCH in a wireless communication system, according to an embodiment;

FIG. 9 illustrates time axis resource allocation according to subcarrier intervals of a data channel and a control channel in a wireless communication system, according to an embodiment;

FIG. 10 illustrates a radio protocol structure of a base station and a terminal in a single cell situation, a carrier aggregation situation, and a dual connectivity situation in a wireless communication system, according to an embodiment;

FIG. 11 illustrates a PDSCH scheduling scheme, according to an embodiment;

FIG. 12 illustrates DCI for single-PDSCH scheduling and multi-PDSCH scheduling, according to an embodiment;

FIG. 13 illustrates a hybrid automatic repeat request (HARQ)-acknowledgement (ACK) transmission of one or multiple PDSCHs scheduled by DCI when the DCI indicates multi-PDSCH scheduling, according to an embodiment;

FIG. 14 illustrates a structure of a terminal in a wireless communication system, according to an embodiment; and

FIG. 15 illustrates a structure of a base station in a wireless communication system, according to an embodiment.

### DETAILED DESCRIPTION

Various embodiments of the present disclosure are described with reference to the accompanying drawings. However, various embodiments of the present disclosure are not limited to particular embodiments, and it should be understood that modifications, equivalents, and/or alternatives of the embodiments described herein can be variously made. With regard to description of drawings, similar components may be marked by similar reference numerals.

The present disclosure provides an apparatus and a method capable of effectively providing a service in a mobile communication system.

In addition, the present disclosure provides a method for interpreting an antenna port field of a DCI format and an apparatus for performing the same.

Additionally, the present disclosure provides a method for interpreting a PTRS association field in a DCI format by a terminal, and an apparatus capable of performing the same.

Various embodiments of the disclosure provide a method for interpreting an antenna port field by a terminal configured with multi-PDSCH scheduling and multi-physical uplink shared channel (PUSCH) scheduling in a wireless communication system.

According to multi-PDSCH scheduling and multi-PUSCH scheduling configurations, a terminal may receive multiple pieces of scheduling information configured in one TDRA row, and each of the multiple pieces of scheduling information may include a starting and length indication value (SLIV) and a mapping type. Accordingly, a terminal may be configured to receive an indication of a TDRA row including pieces of scheduling information having different mapping types through one DCI.

Different pieces of DMRS configuration information may be configured for different mapping types. In case that DMRS configuration information is different, a different antenna port table for DMRS port indication may be configured. A DCI format for scheduling PDSCH to PUSCH may include an antenna port field for indicating one row in an antenna port table.

In case that a TDRA row including pieces of scheduling information having different mapping types is indicated through one DCI, the one DCI should indicate a row in multiple tables. The present disclosure provides a method for designing and interpreting an antenna port field included in a DCI format, so as to indicate each row of multiple antenna port tables.

Different pieces of DMRS configuration information may be configured for different mapping types. In case that the DMRS configuration information is different, a different antenna port table for DMRS information indication may be configured. Therefore, different DMRS port(s) may be allocated based on different mapping types.

In case that an indication of a TDRA row including pieces of scheduling information having different mapping types is received through one DCI, a PTRS-DMRS association field may indicate DMRS port(s) of two mapping types. To this end, the disclosure provides various methods for the indication of the PTRS-DMRS association field.

According to various embodiments of the disclosure, an apparatus and a method capable of effectively providing a service in a mobile communication system can be provided.

In addition, a method for interpreting an antenna port field of a DCI format by a terminal and an apparatus for performing the same can be provided.

In addition, a method for interpreting a PTRS association field of a DCI format by a terminal and an apparatus capable of performing the same can be provided

In describing embodiments of the disclosure, descriptions related to technical contents well-known in the art and not associated directly with the disclosure will be omitted. Such an omission of unnecessary descriptions is intended to prevent obscuring the main idea of the disclosure.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, as defined by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in a flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), which performs a predetermined function. However, the term “unit” does not always have a meaning limited to software or hardware. The term “unit” may be constructed either to be stored in an addressable storage medium or to execute one or more processors. Therefore, the term “unit” includes, for example, software elements, object-oriented software elements, class or task elements, processes, functions, properties, procedures, sub-routines, segments of program code, drivers, firmware, micro-codes, circuits, data, databases, data structures, tables, arrays, and parameters. The elements and functions provided by the term “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” may include one or more processors.

A broadband wireless communication system for providing high-speed and high-quality packet data services using communication standards is provided, including high-speed packet access (HSPA) of third generation partnership project (3GPP), long term evolution (LTE), evolved universal terrestrial radio access (E-UTRA), LTE-advanced (LTE-A), LTE-pro, high-rate packet data (HRPD) of 3GPP two (3GPP2), ultra-mobile broadband (UMB), Institute of Electrical and Electronics Engineers (IEEE) 802.16e, and typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The UL indicates a radio link through which a UE or a mobile station (MS) transmits data or control signals to a base station (e.g., eNode B), and the DL indicates a radio link through which the base station transmits data or control signals to the UE. The above multiple access scheme may separate data or control information of respective users by allocating and operating time-frequency resources for transmitting the data or control information for each user so as to avoid overlapping each other, to establish orthogonality.

Since a 5G communication system, which is a post-LTE communication system, must freely reflect various requirements of users, and service providers, services satisfying various requirements must be supported. The services considered in the 5G communication system include eMBB communication, mMTC, and URLLC.

eMBB aims at providing a data rate higher than that supported by existing LTE, LTE-A, or LTE-Pro. For example, in the 5G communication system, eMBB must provide a peak data rate of 20 gigabits per second (Gbps) in the DL and a peak data rate of 10 Gbps in the UL for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique should be improved. In addition, the data rate required for the 5G communication system may be obtained using a frequency bandwidth of more than 20 MHz in a frequency band of 3 to 6 GHz or a frequency band of 6 GHz or more, instead of transmitting signals using a transmission bandwidth up to 20 MHz in a band of 2 GHz used in LTE.

In addition, mMTC may be used to support application services such as the Internet of things (IoT) in the 5G communication system. mMTC may require supporting a connection of a large number of UEs in a cell, enhancement coverage of UEs, improved battery time, and a reduction in the cost of a UE, in order to effectively provide the IoT. Since the IoT provides communication functions while being provided to various sensors and various devices, it must support a large number of UEs (e.g., 1,000,000 UEs/kilometer (km)²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 16 years, because it is difficult to frequently replace the battery of the UE.

URLLC, which is a cellular-based mission-critical wireless communication service, may be used for remote control of robots or machines, industrial automation, unmanned aerial vehicles, remote health care, and emergency alerts. Thus, URLLC must provide communication with ultra-low latency and ultra-high reliability. For example, a service supporting URLLC must satisfy an air interface latency of less than 0.5 milliseconds (ms), and also requires a packet error rate of 10-5 or less. Therefore, for the services supporting URLLC, a 5G system must provide a transmit time interval (TTI) shorter than those of other services, and may also require a design to assign a large number of resources in a frequency band in order to secure reliability of a communication link.

The three 5G services, that is, eMBB, URLLC, and mMTC, may be multiplexed and transmitted in a single system. In this case, different transmission/reception techniques and transmission/reception parameters may be used between services in order to satisfy different requirements of the respective services. 5G is not limited to the above-described three services.

An NR time-frequency resource will now be described.

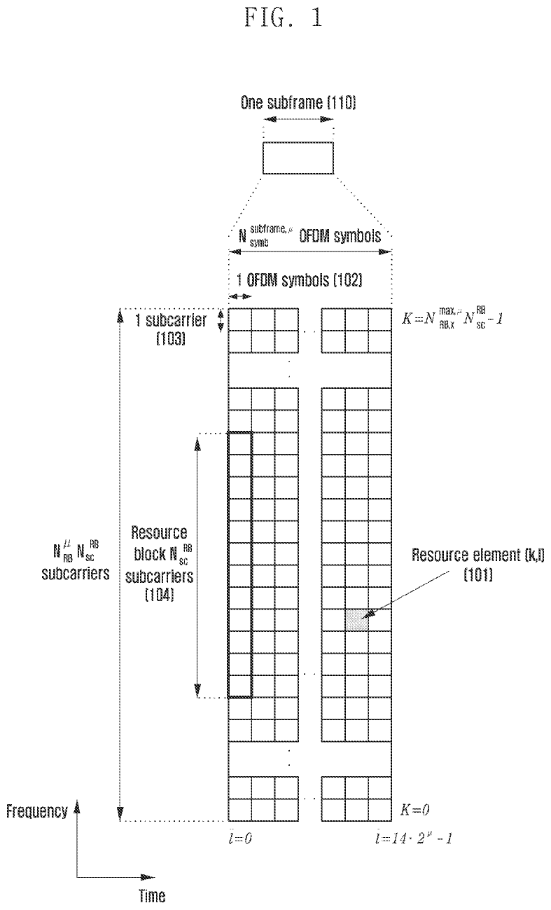

FIG. 1 illustrates a basic structure of a time-frequency domain, which is a radio resource domain in which data or a control channel is transmitted in a 5G system, according to an embodiment.

Referring to FIG. 1, the horizontal axis represents a time domain, and the vertical axis represents a frequency domain. A basic unit of resources in the time-frequency domain may be a resource element 101. The resource element 101 may be defined by 1 orthogonal frequency division multiplexing (OFDM) symbol 102 in a time domain and 1 subcarrier 103 in a frequency domain. In the frequency domain, N_{sc}^{RB} (for example, 12) consecutive REs may configure one resource block (RB) 104. One subframe 110 may be configured by multiple OFDM symbols. For example, the length of the subframe 110 may be 1 ms.

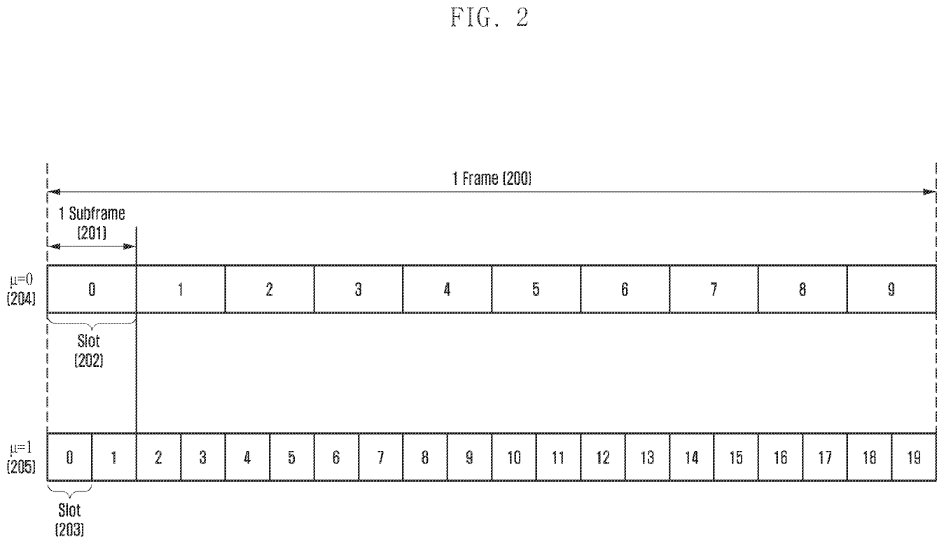

FIG. 2 illustrates a frame, a subframe, and a slot structure in a wireless communication system according to an embodiment.

Referring to FIG. 2, an example of a structure of a frame 200, a subframe 201, and a slot 202 is illustrated. One frame 200 may be defined as 10 ms. One subframe 201 may be defined as 1 ms, and thus one frame 200 may be configured by a total of 10 subframes 201. One slot 202 or 203 may be defined as 14 OFDM symbols (i.e., the number of symbols for one slot (N_{symb}^{slot}=14)). One subframe 201 may include one or multiple slots 202 and 203, and the number of slots 202 and 203 per one subframe 201 may differ according to configuration value μ 204 or 205 for a subcarrier spacing. In FIG. 2, a case in which the subcarrier spacing configuration value is μ=0 (indicated by reference numeral 204) and p=1 (indicated by reference numeral 205) is illustrated. In the case of μ=0 (indicated by reference numeral 204), one subframe 201 may include one slot 202, and in the case of μ=1 (indicated by reference numeral 205), one subframe 201 may include two slots 203. That is, the number of slots per one subframe (Nₛₗₒₜ^{subframe,μ}) may differ according to a subcarrier spacing configuration value p, and accordingly, the number of slots per one frame (Nₛₗₒₜ^{frame,μ}) may differ. According to each subcarrier spacing configuration μ, Nₛₗₒₜ^{subframe,μ} and Nₛₗₒₜ^{frame,μ} may be defined in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, the BWP configuration in a 5G communication system will be described in detail with reference to the drawings.

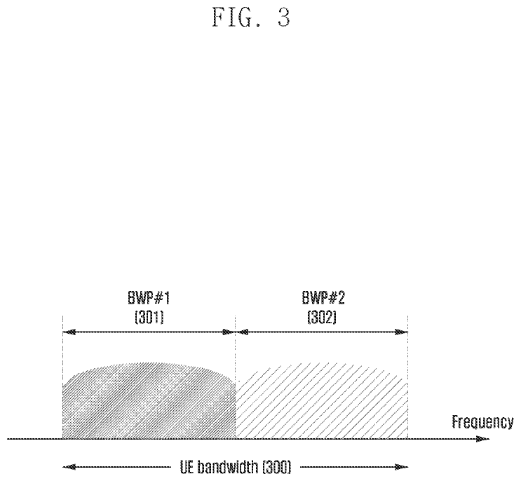

FIG. 3 illustrates a configuration a BWP in a wireless communication system, according to an embodiment.

Referring to FIG. 3, an example, in which a UE bandwidth 300 is configured by two BWPs, that is, BWP #1 301 and BWP #2 302, is shown. The base station may configure one or multiple BWPs for the UE, and may configure pieces of information as shown in Table 2 below for each BWP.

TABLE 2

| | |
|---|---|
| BWP ::= | SEQUENCE { |
| bwp-Id | BWP-Id, |
| (Bandwidth part identifier) | |
| locationAndBandwidth | INTEGER (1..65536), |
| (Bandwidth part location) | |
| subcarrierSpacing | ENUMERATED {n0, n1, n2, n3, n4, |
| n5}, | |
| (Subcarrier spacing) | |
| cyclicPrefix | ENUMERATED { extended } |
| (Cyclic prefix) | |
| } | |

The disclosure is not limited to the above example, and in addition to the configuration information, various parameters related to a BWP may be configured in the UE. The pieces of information may be transmitted by the base station to the UE via higher layer signaling, for example, radio resource control (RRC) signaling. At least one BWP among the configured one or multiple BWPs may be activated. Whether to activate the configured BWP may be semi-statically transmitted from the base station to the UE via RRC signaling or may be dynamically transmitted through DCI.

A UE before RRC connection may be configured with an initial BWP for initial access from a base station through a master information block (MIB). More specifically, the UE may receive configuration information about a search space and a control resource set (CORESET) through which the PDCCH for reception of system information required for initial access (which may correspond to remaining system information (RMSI) or system information block (SIB) 1 may be transmitted through the MIB in an initial access operation. The CORESET and search space, which are configured through the MIB, may be regarded as identity (ID) 0, respectively. The base station may notify the UE of configuration information, such as frequency allocation information, time allocation information, and numerology for the CORESET #0 through the MIB. In addition, the base station may notify the UE of configuration information regarding the monitoring periodicity and occasion for the CORESET #0, that is, configuration information regarding the search space #0, through the MIB. The UE may regard the frequency domain configured as the CORESET #0, obtained from the MIB, as an initial BWP for initial access. Here, the ID of the initial BWP may be regarded as zero.

The configuration of the BWP supported by 5G may be used for various purposes.

A case, in which a bandwidth supported by the UE is less than a system bandwidth, may be supported through the BWP configuration. For example, the base station configures, in the UE, a frequency location (configuration information 2) of the BWP to enable the UE to transmit or receive data at a specific frequency location within the system bandwidth.

Further, the base station may configure multiple BWPs in the UE for the purpose of supporting different numerologies. For example, in order to support both data transmission/reception to/from a predetermined UE by using a subcarrier spacing of 15 kHz and a subcarrier spacing of 30 kHz, two BWPs may be configured to use a subcarrier spacing of 15 kHz and a subcarrier spacing of 30 kHz, respectively. Different BWPs may be frequency division multiplexed, and when attempting to transmit or receive data at a specific subcarrier spacing, the BWP configured with the corresponding subcarrier spacing may be activated.

In addition, the base station may configure, in the UE, the BWPs having bandwidths of different sizes for the purpose of reducing power consumption of the UE. For example, when the UE supports a very large bandwidth, for example, a bandwidth of 100 MHz, and always transmits or receives data at the corresponding bandwidth, the transmission or reception may cause very high power consumption in the UE. In particular, when the UE performs monitoring on unnecessary DL control channels of a large bandwidth of 100 MHz when there is no traffic, the monitoring may be very inefficient in terms of power consumption. Therefore, in order to reduce power consumption of the UE, the base station may configure a BWP of a relatively small bandwidth, for example, a BWP of 20 MHz for the UE. In a situation without traffic, the UE may perform a monitoring operation on a BWP of 20 MHz. The UE may transmit or receive data in a BWP of 100 MHz according to an indication of the base station.

In a method of configuring the BWP, before the RRC connection, the UEs may receive configuration information about the initial BWP through the MIB in the initial connection operation. More specifically, the UE may be configured with a CORESET for a DL control channel through which DCI for scheduling a SIB may be transmitted from a MIB of a physical broadcast channel (PBCH). The bandwidth of the CORESET configured through the MIB may be regarded as the initial BWP. The UE may receive, through the configured initial BWP, a PDSCH through which the SIB is transmitted. The initial BWP may be used for other system information (OSI), paging, and random access as well as the reception of the SIB.

A BWP switch will now be described.

When one or more BWPs have been configured for a UE, a base station may indicate the UE to change (switch or transition) the BWP by using a BWP indicator field in DCI. As an example, in FIG. 3, when the currently activated BWP of the UE is BWP #1 301, the base station may indicate BWP #2 302 to the UE by using the BWP indicator in DCI, and the UE may perform a BWP switch to the BWP #2 302 indicated by the BWP indicator in the received DCI.

As described above, since the DCI-based BWP change may be indicated by the DCI scheduling the PDSCH or PUSCH, when receiving a request to switch the BWP, the UE should smoothly receive or transmit the PDSCH or PUSCH, which is scheduled by the DCI, without difficulty in the switched BWP. To this end, the requirements for a delay time (T_{BWP}) required when switching the BWP can be determined, and may be defined, for example, as shown in Table 3 below.

TABLE 3

| | |
|---|---|
| NR Slot | BWP switch delay T_{BWP} (slots) |

| μ | length (ms) | Type 1 | Type 2 |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

T_{BWP} may depend on UE capability. If the BWP switch involves changing of subcarrier spacing (SCS), the BWP switch delay is determined by the larger of the SCS before BWP switch and the SCS after BWP switch.

The requirements for the BWP switch delay time support type 1 or type 2 depending on UE capability. The UE may report a BWP delay time type that is supportable to the base station.

In case that the UE receives the DCI including the BWP switch indicator in slot n according to the requirements for the BWP switch delay time, the UE may complete a switch to a new BWP indicated by the BWP switch indicator at a time not later than slot n+T_{BWP}, and may perform transmission and reception with respect to a data channel scheduled by the corresponding DCI in the switched new BWP. When the base station intends to schedule the data channel to the new BWP, the base station may determine a time domain resource assignment for the data channel by considering the BWP switch delay time (T_{BWP}) of the UE. That is, when the base station schedules the data channel to the new BWP, the base station may schedule the corresponding data channel after the BWP switch delay time according to the method for determining time domain resource assignment for the data channel. Therefore, the UE may not expect the DCI indicating the BWP switch to indicate a slot offset (K0 or K2) value less than the BWP switch delay time (T_{BWP}).

If the UE has received the DCI (for example, DCI format 1_1 or 0_1) indicating the BWP switch, the UE may not perform transmission or reception during a time interval from a third symbol of the slot in which the PDCCH including the DCI is received to a start time of the slot indicated by the slot offset (K0 or K2) value indicated by the time domain resource assignment indicator field in the DCI. For example, if the UE has received the DCI indicating the BWP switch in slot n and the slot offset value indicated by the DCI is K, the UE may be configured not to perform transmission or reception from the third symbol of the slot n to the symbol prior to slot n+K (for example, the last symbol of slot n+K−1).

A synchronization signal (SS)/PBCH block will now be described.

The SS/PBCH block may refer to a physical layer channel block including a primary SS (PSS), a secondary SS (SSS), and a PBCH. Specifically, the SS/PBCH block is as follows:

PSS is a signal that serves as a reference for DL time/frequency synchronization and provides some information of a cell ID.

SSS is a signal that serves as a reference for DL time/frequency synchronization, and provides the remaining cell ID information that is not provided by the PSS. In addition, the SSS may serve as a reference signal for demodulation of the PBCH.

PBCH is a channel that provides essential system information required for transmission or reception of a data channel and a control channel of a UE. The essential system information may include search space related control information indicating radio resource mapping information of a control channel and scheduling control information for a separate data channel for transmission of system information.

SS/PBCH block includes a combination of a PSS, an SSS, and a PBCH. One or multiple SS/PBCH blocks may be transmitted within 5 ms, and each of the transmitted SS/PBCH blocks may be distinguished by indices.

The UE may detect the PSS and the SSS in the initial access operation, and may decode the PBCH. The UE may obtain the MIB from the PBCH, and may be configured with the CORESET #0 (which may correspond to the CORESET having the CORESET index of 0) therefrom. The UE may monitor the CORESET #0 under the assumption that a DMRS transmitted in the selected SS/PBCH block and the CORESET #0 is quasi-co-located (QCLed). The UE may receive system information based on DCI transmitted from the CORESET #0. The UE may obtain, from the received system information, configuration information related to a RACH required for initial access. The UE may transmit a physical RACH (PRACH) to the base station by considering the selected SS/PBCH index, and the base station having received the PRACH may obtain information about an SS/PBCH block index selected by the UE. The base station may know which block is selected among the SS/PBCH blocks by the UE, and may know that the CORESET #0 associated therewith is monitored.

Next, DCI in a 5G system will be described.

In the 5G system, scheduling information about UL data (PUSCH) or DL data (PDSCH) is transmitted from a base station to a UE through the DCI. The UE may monitor a fallback DCI format and a non-fallback DCI format with regard to the PUSCH or the PDSCH. The fallback DCI format may include a fixed field predefined between the base station and the UE, and the non-fallback DCI format may include a configurable field.

The DCI may be transmitted through a PDCCH which is a physical DL control channel after channel coding and modulation is performed thereon. A cyclic redundancy check (CRC) may be attached to a DCI message payload, and the CRC may be scrambled by a radio network temporary identifier (RNTI) corresponding to the identification information of the UE. Different RNTIs may be used according to the purpose of the DCI message, for example, a UE-specific data transmission, a power control command, or a random access response. That is, the RNTI is not explicitly transmitted, but is included in a CRC calculation process and then transmitted. When receiving the DCI message transmitted through the PDCCH, the UE may check a CRC by using an assigned RNTI. When a CRC check result is correct, the UE may know that the corresponding message has been transmitted to the UE.

For example, DCI for scheduling a PDSCH for system information (SI) may be scrambled by an SI-RNTI. DCI for scheduling a PDSCH for a random access response (RAR) message may be scrambled by a random access (RA)-RNTI. DCI for scheduling a PDSCH for a paging message may be scrambled by a paging RNTI (P-RNTI). DCI for notifying of a slot format indicator (SFI) may be scrambled by an SFI-RNTI. DCI for notifying of transmit power control (TPC) may be scrambled by a TPC-RNTI. DCI for scheduling UE-specific PDSCH or PUSCH may be scrambled by a cell RNTI (C-RNTI).

DCI format 0_0 may be used as a fallback DCI for scheduling a PUSCH. Here, a CRC may be scrambled by a C-RNTI. The DCI format 0_0 in which the CRC is scrambled by the C-RNTI may include, for example, pieces of information included in Table 4 below.

TABLE 4
- Identifier for DCI formats - 1 bit
- Frequency domain resource assignment −[┌log₂(N_{RB}^{UL,BWP}(N_{RB}^{UL,BWP} +1) / 2) ┐ ] bits
- Time domain resource assignment - X bits
- Frequency hopping flag - 1 bit
- Modulation and coding scheme - 5 bits
- New data indicator - 1 bit
- Redundancy version - 2 bits
- HARQ process number - 4 bits
- TPC command for scheduled PUSCH- 2 bits
- UL/Supplementary UL (SUL) indicator- 0 or 1 bit

DC format 0_1 may be used as a non-fallback DCI for scheduling a PUSCH. Here, a CRC may be scrambled by a C-RNTI. The DCI format 0_1 in which the CRC is scrambled by the C-RNTI may include, for example, pieces of information included in Table 5 below.

```
TABLE 5
- Carrier indicator - 0 or 3 bits
- UL/SUL indicator − 0 or 1 bit
- Identifier for DCI formats − 1 bit
- Bandwidth part indicator − 0, 1 or 2 bits
- Frequency domain resource assignment
    • For resource allocation type 0, ┌N_{RB}^{UL,BWP} / P┐ bits
    • For resource allocation type 1, ┌log₂(N_{RB}^{UL,BWP}(N_{RB}^{UL,BWP} +
    1)/2)┐ bits
- Time domain resource assignment −1, 2, 3, or 4 bits
- Virtual resource block (VRB)-to- physical resource block (PRB)
mapping) − 0 or 1 bit, only for resource allocation type 1.
    • 0 bits if only resource allocation type 0 is configured;
    • 1 bit otherwise.
- Frequency hopping flag − 0 or 1 bit, only for resource allocation type 1.
    • 0 bits if only resource allocation type 0 is configured;
    • 1 bit otherwise.
- Modulation and coding scheme − 5 bits
- New data indicator − 1 bit
- Redundancy version − 2 bits
- HARQ process number − 4 bits
- 1st DL assignment index − 1 or 2 bits
    • 1 bit for semi-static HARQ-ACK codebook;
    • 2 bits for dynamic HARQ-ACK codebook with single HARQ-ACK
    codebook.
- 2nd DL assignment index − 0 or 2 bits
    • 2 bits for dynamic HARQ-ACK codebook with two HARQ-ACK
    sub-codebooks;
    • 0 bits otherwise.
- TPC command for scheduled PUSCH − 2 bits
$‐ SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
    $\begin{matrix} ⌈ {log}_{2} ( {\sum }_{k = 1}^{{L}_{max}} ( \begin{matrix}{N}_{SRS} \\ k\end{matrix} ) ) ⌉ bits for non ‐ codebook based PUSCH \\ transmission ;\end{matrix}$
    • ┌log₂(N_{SRS})┐ bits for codebook based PUSCH transmission.
- Precoding information and number of layers −up to 6 bits
- Antenna ports − up to 5 bits
- SRS request − 2 bits
- Channel state information (CSI) request − 0, 1, 2, 3, 4, 5, or 6 bits
- Code block group (CBG) transmission information − 0, 2, 4, 6, or 8 bits
- Phase tracking reference signal (PTRS)-Demodulation reference signal
(DMRS) association − 0 or 2 bits.
- beta_offset indicator − 0 or 2 bits
- DMRS sequence initialization − 0 or 1 bit
```

DCI format 1_0 may be used as a fallback DCI for scheduling a PDSCH. Here, a CRC may be scrambled by a C-RNTI. The DCI format 1_0 in which the CRC is scrambled by the C-RNTI may include, for example, the following pieces of information of Table 6 below.

TABLE 6
Identifier for DCI formats—1 bit
Frequency domain resource assignment—[┌log₂(N_{RB}^{DL, BWP}(N_{RB}^{DL, BWP} +
1)/2)┐]bits
Time domain resource assignment—X bits
VRB-to-PRB mapping—1 bit
Modulation and coding scheme—5 bits
New data indicator—1 bit
Redundancy version—2 bits
HARQ process number—4 bits
DL assignment index—2 bits
TPC command for scheduled PUCCH—2 bits
PUCCH resource indicator—3 bits
PDSCH-to-HARQ feedback timing indicator—3 bits

DCI format 1_1 may be used as a non-fallback DCI for scheduling a PDSCH. Here, a CRC may be scrambled by a C-RNTI. The DCI format 1_1 in which the CRC is scrambled by the C-RNTI may include, for example, pieces of information included in Table 7 below.

```
TABLE 7
    Carrier indicator—0 or 3 bits
    Identifier for DCI formats—1 bit
    Bandwidth part indicator—0, 1 or 2 bits
    Frequency domain resource assignment
        For resource allocation type 0, ┌N_{RB}^{DL, BWP}/P┐ bits
        For resource allocation type 1, ┌log₂(N_{RB}^{DL, BWP}(N_{RB}^{DL, BWP} +
1)/2)┐ bits
    Time domain resource assignment—1, 2, 3, or 4 bits
    VRB-to-PRB mapping—0 or 1 bit, only for resource allocation
type 1.
        0 bits if only resource allocation type 0 is configured;
        1 bit otherwise.
    PRB bundling size indicator—0 or 1 bit
    Rate matching indicator—0, 1, or 2 bits
    Zero power channel state information reference signal (ZP CSI-RS)
trigger—0, 1, or 2 bits
For transport block 1:
    Modulation and coding scheme—5 bits
    New data indicator—1 bit
    Redundancy version—2 bits
For transport block 2:
    Modulation and coding scheme—5 bits
    New data indicator—1 bit
    Redundancy version—2 bits
    HARQ process number—4 bits
    DL assignment index—0 or 2 or 4 bits
    TPC command for scheduled PUCCH—2 bits
    PUCCH resource indicator—3 bits
    PDSCH-to-HARQ_feedback timing indicator—3 bits
    Antenna ports—4, 5 or 6 bits
    Transmission configuration indication—0 or 3 bits
    SRS request—2 bits
    CBG transmission information—0, 2, 4, 6, or 8 bits
    CBG flushing out information—0 or 1 bit
    DMRS sequence initialization—1 bit
```

Hereinafter, a DL control channel in a 5G communication system will be described in more detail with reference to the drawings.

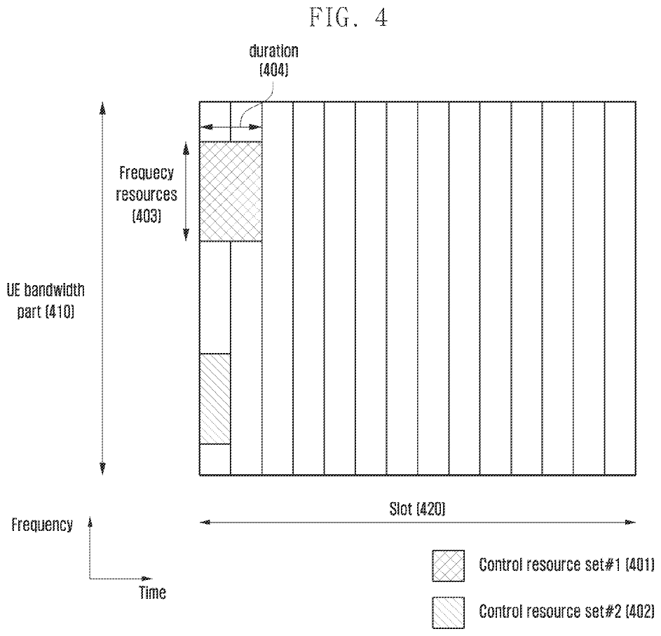

FIG. 4 illustrates a configuration of a CORESET of a DL control channel in a wireless communication system, according to an embodiment.

FIG. 4 illustrates an example in which a UE BWP 410 is configured in a frequency domain and two CORESETs (CORESET #1 401 and CORESET #2 402) are configured in one slot 420 in a time domain. The CORESETs 401 and 402 may be configured in a specific frequency resource 403 within the entire UE BWP 410 in the frequency domain.

The CORESET may be configured with one or multiple OFDM symbols in the time domain, and this may be defined as a CORESET duration 404. Referring to FIG. 4, the CORESET #1 401 is configured with the CORESET duration of two symbols, and the CORESET #2 402 is configured with the CORESET duration of one symbol.

The above described CORESET in 5G may be configured for the UE by the base station via higher layer signaling (e.g., system information, an MIB, RRC signaling). Configuration of the CORESET for the UE may be understood as providing information such as a CORESET identity, a frequency location of the CORESET, and a symbol length of the CORESET. The configuration information may include, for example, pieces of information included in Table 8 below.

TABLE 8

| | |
|---|---|
| ControlResourceSet ::= | SEQUENCE { |
| -- Corresponds to L1 parameter ′CORESET-ID′ | |
| controlResourceSetId | ControlResourceSetId, |
| (Control resource set Identity) | |
| frequency DomainResources | BIT STRING (SIZE |
| (45)), | |
| (Frequency domain resource allocation information) | |
| duration | |
| INTEGER (1..maxCoReSetDuration), | |
| (Time domain resource allocation information) | |
| cce-REG-Mapping Type | CHOICE { |
| (CCE-to-REG mapping type) | |
| interleaved | SEQUENCE { |
| reg-BundleSize | |
| ENUMERATED {n2, n3, n6}, | |
| (REG bundle size) | |
| precoderGranularity | |
| ENUMERATED {sameAsREG-bundle, allContiguousRBs}, | |
| interleaverSize | |
| ENUMERATED {n2, n3, n6} | |
| (Interleaver size) | |
| shiftIndex | |
| INTEGER(0..maxNrofPhysicalResourceBlocks-1) | |
| OPTIONAL | |
| (Inverter Shift)) | NULL |
| }, | |
| nonInterleaved | |
| }, | |
| tci-StatesPDCCH | |

SEQUENCE(SIZE (1..maxNrofTCI-StatesPDCCH)) OF TCI-StateId

| | |
|---|---|
| OPTIONAL, | |
| (QCL configuration information) | ENUMERATED |
| tci-PresentInDCI | |
| {enabled} | |
| OPTIONAL, -- Need S | |
| } | |

In Table 8, tci-StatesPDCCH (simply referred to as transmission configuration indication (TCT) state) configuration information may include information about one or multiple SS/PBCH blocks (that is, SSB) indices having a quasi-co-located (QCLed) relationship with a DMRS transmitted in the corresponding CORESET or a channel state information reference signal (CSI-RS) index.

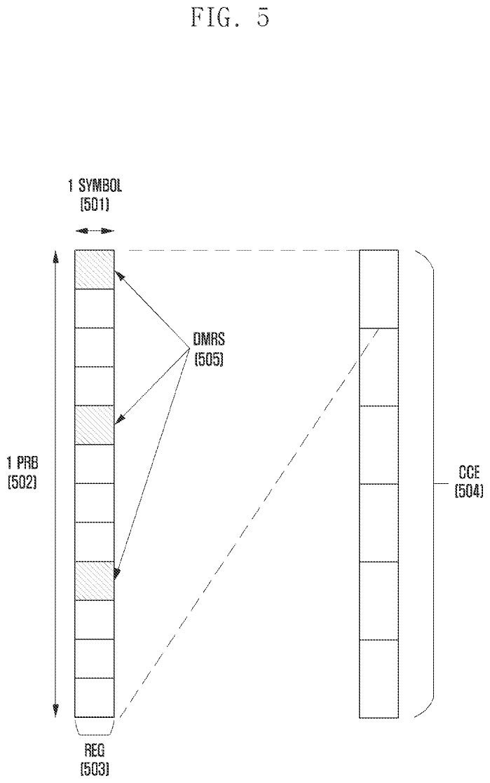

FIG. 5 illustrates an example of a basic unit of time and frequency resources configuring a DL control channel that can be used in 5G, according to an embodiment.

Referring to FIG. 5, the basic unit of time and frequency resources configuring a control channel may be referred to as a resource element group (REG) 503. The REG 503 may be defined by one OFDM symbol 501 in a time domain and one PRB 502, that is, 12 subcarriers, in a frequency domain. The base station may concatenate the REG 503 to configure a DL control channel allocation unit.

As shown in FIG. 5, when a basic unit to which a DL control channel is allocated in 5G is referred to as a control channel element (CCE) 504, one CCE 504 may include multiple REGs 503. When describing the REG 503 illustrated in FIG. 5A as an example, the REG 503 may include 12 resource elements (REs), and when one CCE 504 includes six REGs 503, one CCE 504 may include 72 REs. When the DL CORESET is configured, the corresponding region may include multiple CCEs 504. A specific DL control channel may be transmitted after being mapped to one or more CCEs 504 according to an aggregation level (AL) in the CORESET. The CCEs 504 in the CORESET are distinguished by numbers. Here, the numbers of the CCEs 504 may be assigned according to a logical mapping scheme.

The basic unit of the DL control channel shown in FIG. 5, that is, the REG 503, may include both REs to which DCI is mapped and a region to which a DMRS 505 which is a reference signal for decoding the DCI is mapped. As illustrated in FIG. 5, three DMRSs 505 may be transmitted in one REG 503. The number of CCEs required for transmission of the PDCCH may be 1, 2, 4, 8, or 16 according to the AL. Different numbers of CCEs may be used to implement link adaptation of the DL control channel. For example, if AL=L, one DL control channel may be transmitted through L CCEs. The UE needs to detect a signal in a state in which the UE does not know information about the DL control channel, and a search space representing a set of CCEs has been defined for blind decoding. The search space is a set of DL control channel candidates including CCEs that the UE has to attempt to decode at a given AL. Since there are various ALs that make one bundle of 1, 2, 4, 8, or 16 CCEs, the UE may have multiple search spaces. A search space set may be defined as a set of search spaces at all configured ALs.

The search space may be classified into a common search space and a UE-specific search space. A predetermined group of UEs or all the UEs may examine the common search space of the PDCCH so as to receive cell common control information such as dynamic scheduling of system information or a paging message. For example, PDSCH scheduling allocation information for transmission of the SIB including cell operator information may be received by examining the common search space of the PDCCH. In a case of the common search space, since a predetermined group of UEs or all the UEs need to receive the PDCCH, the common search space may be defined as a set of previously appointed CCEs. Scheduling allocation information about the UE-specific PDSCH or PUSCH may be received by examining the UE-specific search space of the PDCCH. The UE-specific search space may be defined specifically for a UE as a function of the UE identity and various system parameters.

In 5G, the parameter for the search space of the PDCCH may be configured for the UE by the base station via higher layer signaling (e.g., SIB, MIB, or RRC signaling). For example, the base station may configure, in the UE, the number of PDCCH candidates at each aggregation level L, the monitoring periodicity for the search space, the monitoring occasion of symbol units in the slots for the search space, the search space type (common search space or UE-specific search space), the combination of RNTI and DCI format to be monitored in the search space, and the CORESET index to monitor the search space. For example, the configuration information for the search space of the PDCCH may include the following pieces of information included in Table 9 below.

TABLE 9

| | |
|---|---|
| SearchSpace ::= | SEQUENCE { |

-- Identity of the search space. SearchSpaceId = 0 identifies the SearchSpace
configured via PBCH (MIB) or ServingCellConfigCommon.

| searchSpaceId | | |
|---|---|---|
| SearchSpaceId, | | |
| (Search space identity) | | |
| controlResourceSetId | | ControlResourceSetId, |
| (Control resource set identity) | | |
| monitoringSlotPeriodicityAndOffset | | CHOICE { |
| (Monitoring slot level period) | | |
| | sl1 | NULL, |
| | sl2 | INTEGER (0..1), |
| | sl4 | INTEGER (0..3), |
| | sl5 | INTEGER (0..4), |
| | sl8 | INTEGER (0..7), |
| | sl10 | INTEGER (0..9), |
| | sl16 | INTEGER (0..15), |
| | sl20 | INTEGER (0..19) |
| } | | |
| | OPTIONAL, | |

| | |
|---|---|
| duration(Monitoring length) | INTEGER |
| (2..2559) | |
| monitoringSymbols WithinSlot | BIT STRING (SIZE |
| (14)) | OPTIONAL, |
| (Monitoring symbol in slot) | |
| nrofCandidates | SEQUENCE { |

(number of PDCCH candidates for each aggregation level)

| | aggregationLevel1 | ENUMERATED {n0, |
|---|---|---|
| n1, n2, n3, n4, n5, n6, n8}, | | |
| | aggregationLevel2 | ENUMERATED (n0, |
| n1, n2, n3, n4, n5, n6, n8}, | | |
| | aggregationLevel4 | ENUMERATED {n0, |
| n1, n2, n3, n4, n5, n6, n8}, | | |
| | aggregationLevel8 | ENUMERATED {n0, |
| nl, n2, n3, n4, n5, n6, n8}, | | |
| | aggregationLevel16 | ENUMERATED {n0, |
| n1, n2, n3, n4, n5, n6, n8} | | |
| }, | | |
| searchSpaceType | | CHOICE { |
| (Search space type) | | |
| | -- Configures this search space as common search space (CSS) and DCI | |
| formats to monitor. | | |
| | common | |
| | SEQUENCE { | |
| (Common search space) | | |
| } | | |

| | |
|---|---|
| ue-Specific | SEQUENCE { |
| (UE-specific search space) | |

-- Indicates whether the UE monitors in this USS for DCI

```
formats 0-0 and 1-0 or for formats 0-1 and 1-1.
      formats
      ENUMERATED {formats0-0-And-1-0, formats0-1-And-1-1},
```

...

}

The base station may configure one or more search space sets for the UE according to configuration information. According to some embodiments, the base station may configure search space set 1 and search space set 2 in the UE. The base station may configure the search space set 1 in the UE so that DCI format A scrambled by an X-RNTI is monitored in the common search space. The base station may configure the search space set 2 in the UE so that DCI format B scrambled by a Y-RNTI is monitored in the UE-specific search space.

According to the configuration information, one or multiple search space sets may exist in the common search space or the UE-specific search space. For example, search space set #1 and search space set #2 may be configured as the common search space, and search space set #3 and search space set #4 may be configured as the UE-specific search space.

In the common search space, the following combinations of the DCI format and the RNTI may be monitored. However, the disclosure is not limited thereto.
DCI format 0_0/1_0 with CRC scrambled by C-RNTI, configured scheduling RNTI (CS-RNTI), semi-persistent RNTI (SP-CSI-RNTI), RA-RNTI, temporary cell RNTI (TC-RNTI), paging RNTI (P-RNTI), system information (SI-RNTI)
DCI format 2_0 with CRC scrambled by SFI-RNTI
DCI format 2_1 with CRC scrambled by interruption RNTI (INT-RNTI)
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of the DCI format and the RNTI may be monitored. However, the disclosure is not limited thereto.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may follow the definitions and usages described below.

C-RNTI: For UE-specific PDSCH scheduling

TC-RNTI: For UE-specific PDSCH scheduling

CS-RNTI: For semi-statically configured UE-specific PDSCH scheduling

RA-RNTI: For PDSCH scheduling in random access operation

P-RNTI: For scheduling of PDSCH through which paging is transmitted

SI-RNTI: For PDSCH scheduling in which system information is transmitted

INT-RNTI: For notifying of whether to puncture PDSCH

TPC-PUSCH-RNTI: For indication of power control command for PUSCH

TPC-PUCCH-RNTI: For indication of power control command for PUCCH

TPC-SRS-RNTI: For indication of power control command for SRS

The above-described specified DCI formats may follow the definitions shown in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

In 5G, the search space of the aggregation level L in the CORESET p and the search space set s may be expressed by Equation 1.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equaiton 1$$

L: aggregation level
n_{CI}: Carrier index
N_{CCE,p}: Total number of CCEs existing in the CORESET p
n^{μ}_{s,f}: Slot index
M^{(L)}_{p,s,max}: Number of PDCCH candidates of aggregation level L
m_{s,nCI}=0, . . . , M^{(L)}_{p,s,max}−1: PDCCH candidate group index of aggregation level L
i=0, . . . , L₋₁
Y_{p,n}_{_{s,f}}_{^{μ}}μ=(Aₚ·Y_{p,n}_{_{s,f}}_{^{μ}}₋₁)mod D, Y_{p,-1}=n_{RNTI}≠0. Aₚ=39827 for pmod3=0.
Aₚ=39829 for pmod3=1. Aₚ=39839 for pmod3=2. D=65537
n_{RNTI}: UE identifier

The value of Y_{p,n}_{_{s,f}}_{^{μ}} may correspond to zero in the common search space. In a case of the UE-specific search space, the Y_{p,n}_{_{s,f}}_{^{μ}} value may correspond to a value that changes according to the UE identity (C-RNTI or ID configured by the base station for the UE) and the time index.

In 5G, multiple search space sets may be configured with different parameters (e.g., parameters shown in Table 9), and accordingly, the set of search space sets monitored by the UE may differ at each time point. For example, if search space set #1 is configured with the X-slot period, search space set #2 is configured with the Y-slot period, and X and Y are different, the UE may monitor both search space set #1 and search space set #2 in a specific slot, and may monitor one of search space set #1 and search space set #2 in a specific slot.

Frequency resource allocation related with PDSCH will now be described.

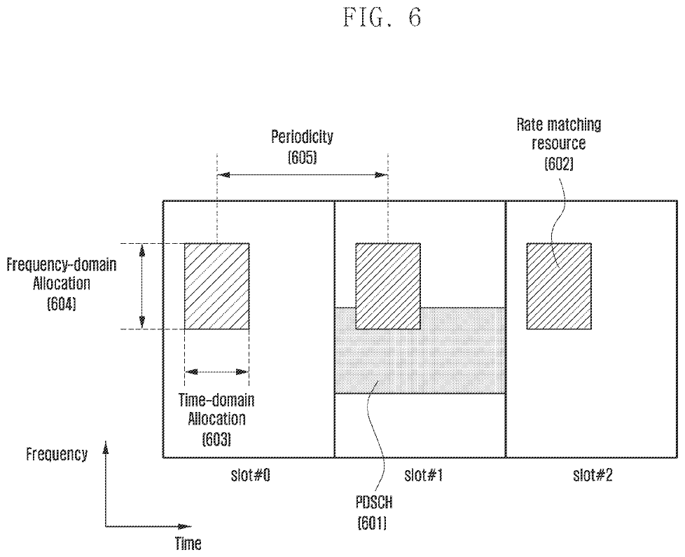

FIG. 6 illustrates a method for transmitting and receiving data by a base station and a terminal by considering a downlink data channel and a rate matching resource in a wireless communication system, according to an embodiment.

FIG. 6 shows a downlink data channel 601 and a rate matching resource 602. A BS may configure one or multiple rate matching resources 602 in a UE through higher layer signaling (e.g., RRC signaling). Configuration information of the rate matching resource 602 may include time-domain resource allocation information 603, frequency-domain resource allocation information 604, and periodicity information 605. If some or all of the time and frequency resources of the scheduled data channel 601 overlap the configured rate matching resource 602, a BS may rate-match the data channel 601 in the rate matching resource 602 part and transmit it. A UE may perform reception and decoding, assuming that the data channel 601 has been rate-matched in the rate matching resource 602 part.

The BS may dynamically notify the UE whether the data channel will be rate-matched in the configured rate matching resource part through DCI through an additional configuration. Specifically, the BS may select some of the configured rate matching resources, may group the selected resources into a rate matching resource group, and may indicate whether the data channel has been rate-matched with each rate matching resource group through DCI using a bitmap method with respect to the UE. For example, if four rate matching resources RMR #1, RMR #2, RMR #3 and RMR #4 have been configured, the BS may configure RMG #1={RMR #1, RMR #2} and RMG #2={RMR #3, RMR #4} as rate matching groups, and may indicate whether rate matching in each of RMG #1 and RMG #2 has been performed using 2 bits of a DCI field with respect to the UE in the form of a bitmap. For example, the BS may indicate “1” if rate matching needs to be performed, and may indicate “0” if rate matching do not need to be performed.

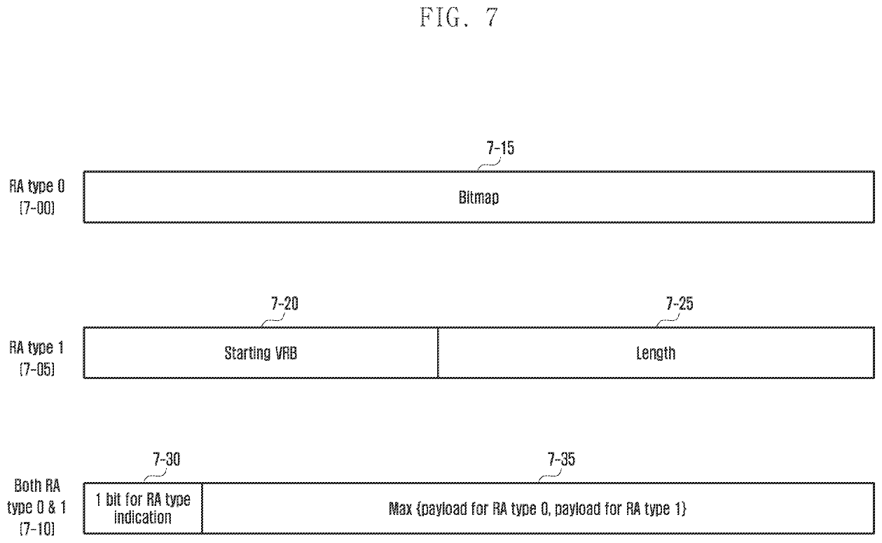

FIG. 7 illustrates frequency-domain resource allocation of a PDSCH in a wireless communication system, according to an embodiment. More specifically, FIG. 7 shows three frequency-domain resource allocation methods of type 0 7-00, type 1 7-05, and dynamic switch 7-10 configurable through a higher layer in an NR wireless communication system.

Referring to FIG. 7, in case that a UE is configured to use only resource type 0 via higher layer signaling (indicated by reference numeral 7-00), some DCI for allocation of PDSCH to the corresponding UE includes a bitmap formed of NRBG bits. Conditions for this will be described later. In this case, NRBG denotes the number of resource block groups (RBGs) determined as shown in Table 11, below, according to a BWP size allocated by a BWP indicator and a higher layer parameter rbg-Size, and data is transmitted to RBG indicated as “1” in the bitmap.

TABLE 11

| BWP Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

If the UE is configured to use only resource type 1 via higher layer signaling (indicated by reference numeral 7-05), some DCI for allocation of the PDSCH to the UE includes frequency-domain resource allocation information configured by └log₂ (N_{RB}^{DL,BWP}(N_{RB}^{DL,BWP}+1)/2┘ bits. Conditions for this will be described again later. Through this information, the base station may configure a starting VRB 7-20 and the length of frequency-domain resources 7-25 continuously allocated therefrom.

If the UE is configured to use both resource type 0 and resource type 1 via higher layer signaling (indicated by reference numeral 7-10), some DCI for allocation of PDSCH to the UE includes frequency-domain resource allocation information configured by bits of a greater value 7-35 among a payload 7-15 for configuration of resource type 0 and payloads 7-20 and 7-25 for configuration of resource type 1, a condition for which will be described later. Here, one bit is added to the most significant bit (MSB) of the frequency-domain resource allocation information in the DCI, in case that the corresponding bit has a value of “0”, 0 indicates that resource type 0 is used, and in case that the corresponding bit has a value of “1”, 1 indicates that resource type 1 is used.

Hereinafter, a method of allocating time domain resources for a data channel in a next-generation mobile communication system (5G or NR system) will be described.

A base station may configure, for a UE, a table for time-domain resource allocation information for a DL data channel (PDSCH) and an UL data channel (PUSCH) via higher layer signaling (e.g., RRC signaling). With regard to PDSCH, a table including maxNrofDL-Allocations=16 entries may be configured, and with regard to PUSCH, a table including maxNrofUL-Allocations=16 entries may be configured. In an embodiment, the time-domain resource allocation information may include PDCCH-to-PDSCH slot timing (corresponding to a time interval in slot units between a time point at which a PDCCH is received and a time point at which a PDSCH scheduled by the received PDCCH is transmitted, and denoted by K0), PDCCH-to-PUSCH slot timing (corresponding to a time interval in slot units between a time point at which a PDCCH is received and a time point at which a PUSCH scheduled by the received PDCCH is transmitted, and denoted by K2), information on the position and length of a start symbol in which the PDSCH or PUSCH is scheduled within a slot, and a mapping type of PDSCH or PUSCH. For example, information included in Table 12 or Table 13, below, may be transmitted from the base station to the UE.

```
TABLE 12
      PDSCH-TimeDomainResourceAllocation information element
PDSCH-TimeDomainResourceAllocationList ::= SEQUENCE
(SIZE(1..maxNrofDL-Allocations))   OF PDSCH-
TimeDomainResourceAllocation
PDSCH-TimeDomainResourceAllocation := SEQUENCE {
    k0 INTEGER(0..32)
OPTIONAL, -- Need S
    mapping Type ENUMERATED {typeA, typeB},
    startSymbolAndLength INTEGER (0..127)
}
```

```
TABLE 13
      PDSCH-TimeDomainResourceAllocation information element
PUSCH-TimeDomainResourceAllocationList ::= SEQUENCE
(SIZE(1..maxNrofUL-Allocations))   OF PUSCH-
TimeDomainResourceAllocation
PUSCH-TimeDomainResourceAllocation := SEQUENCE {
    k2 INTEGER(0..32)
OPTIONAL, -- Need S
    mapping Type ENUMERATED {typeA, typeB},
    startSymbolAndLength INTEGER (0..127)
}
```

The base station may notify one of the entries in Tables 12-13 representing the time-domain resource allocation information to the UE via L1 signaling (e.g., DCI) (e.g., may be indicated by a “time-domain resource allocation” field in DCI). The UE may acquire time-domain resource allocation information for the PDSCH or PUSCH based on the DCI received from the base station.

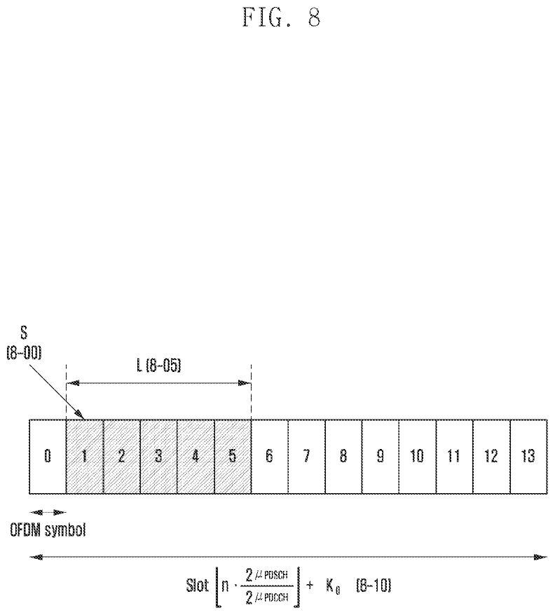

FIG. 8 illustrates time-domain resource allocation of a PDSCH in a wireless communication system, according to an embodiment.

Referring to FIG. 8, a base station may indicate a time-domain position of a PDSCH resource according to a start position 8-00 and a length 8-05 of an OFDM symbol in a slot dynamically indicated via the SCS (μ_{PDSCH}, μ_{PDCCH}) of a data channel and a control channel configured using a higher layer, a scheduling offset (K0) value, and DCI.

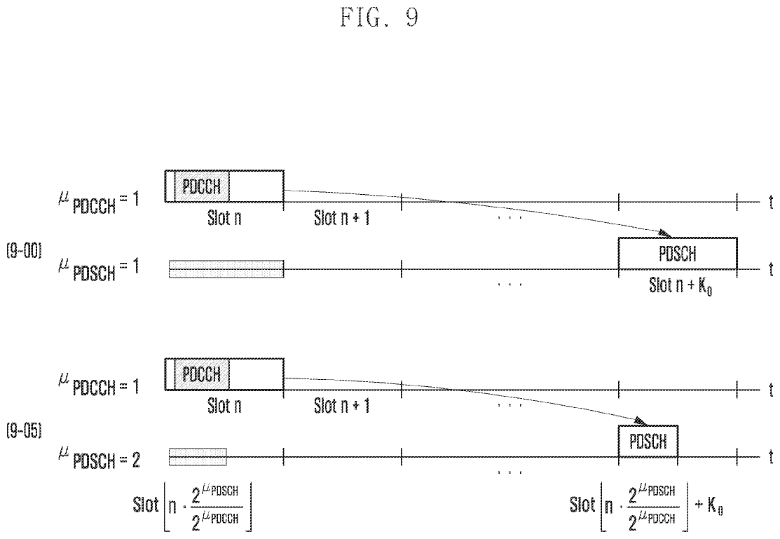

FIG. 9 illustrates time-domain resource allocation according to subcarrier spacings of a data channel and a control channel in a wireless communication system, according to an embodiment.

Referring to FIG. 9, in case that a data channel and a control channel have the same subcarrier spacing (indicated by reference numeral 9-00, μ_{PDSCH}=μ_{PDCCH}), since a data slot number and a control slot number are the same, a base station and a UE may generate a scheduling offset adjusted according to predetermined slot offset K0. On the other hand, when the subcarrier spacing of the data channel and the subcarrier spacing of the control channel are different (indicated by reference numeral 9-05, μ_{PDSCH}≠μ_{PDCCH}), since a data slot number and a control slot number are different, the base station and the UE may generate a scheduling offset adjusted according to the predetermined slot offset K0 based on the subcarrier spacing of the PDCCH.

Next, a method of scheduling PUSCH transmission will be described. PUSCH transmission may be dynamically scheduled by a UL grant in DCI or may be operated by a configured grant Type 1 or Type 2. Dynamic scheduling indication for PUSCH transmission is possible using DCI format 0_0 or 0_1.

Configured grant Type 1 PUSCH transmission does not receive a UL grant in DCI, and may be semi-statically configured through reception of configuredGrantConfig including rrc-ConfiguredUplinkGrant of Table 14 via higher layer signaling. Configured grant Type 2 PUSCH transmission may be semi-persistently scheduled by UL grant in DCI after reception of configuredGrantConfig that does not include the rrc-ConfiguredUplinkGrant of Table 14 via higher layer signaling. When PUSCH transmission is operated by a configured grant, parameters applied to PUSCH transmission are applied through configuredGrantConfig, which is higher layer signaling of Table 14, except for dataScramblingIdentityPUSCH, txConfig, codebookSubset, maxRank, and scaling of UCI-OnPUSCH, which are provided by pusch-Config in Table 15, which is higher layer signaling. When the UE is provided with transformPrecoder in configuredGrantConfig, which is higher layer signaling of Table 14, the UE applies tp-pi2BPSK in the pusch-Config of Table 15 with regard to PUSCH transmission operated by the configured grant.

TABLE 14
ConfiguredGrantConfig := SEQUENCE {

| | |
|---|---|
| frequency Hopping | ENUMERATED {intraSlot, |
| interSlot} | OPTIONAL, -- |
| Need S, | |
| cg-DMRS-Configuration | DMRS-UplinkConfig, |
| mcs-Table | ENUMERATED {qam256, |
| qam64LowSE} | OPTIONAL, |
| -- Need S | |
| mcs-TableTransformPrecoder | ENUMERATED {qam256, |
| qam64LowSE} | OPTIONAL, |
| -- Need S | |
| uci-OnPUSCH | SetupRelease { CG-UCI- |
| OnPUSCH } | OPTIONAL, |
| -- Need M | |
| resourceAllocation | ENUMERATED |

{ resourceAllocationType0, resourceAllocationType1, dynamicSwitch },

| | |
|---|---|
| rbg-Size | ENUMERATED {config2} |
| OPTIONAL, -- Need S | |
| powerControlLoopToUse | ENUMERATED {n0, n1}, |
| p0-PUSCH-Alpha | P0-PUSCH-AlphaSetld, |
| transform Precoder | ENUMERATED {enabled, |
| disabled} | OPTIONAL, -- |
| Need S | |
| nrofHARQ-Processes | INTEGER(1..16), |
| repK | ENUMERATED {n1, n2, n4, |
| n8), | |
| repK-RV | ENUMERATED {s1-0231, |
| s2-0303, s3-0000} | OPTIONAL, -- |
| Need R | |
| periodicity | ENUMERATED { |
| | sym2, sym7, |

sym1x14, sym2x14, sym4x14, sym5x14, sym8x14, sym10x14, sym16x14,
sym20x14,

sym32x14,

sym40x14, sym64x14, sym80x14, sym128x14, sym160x14, sym256x14,
sym320x14, sym512x14,

sym640x14,

sym 1024x14, sym 1280x14, sym2560x14, sym5120x14,

sym6, sym 1x12,

sym2x12, sym4x12, sym5x12, sym8x12, sym10x12, sym16x12, sym20x12,
sym32x12,

sym40x12,

sym64x12, sym80x12, sym128x12, sym160x12, sym256x12, sym320x12,

| | |
|---|---|
| sym512x12, sym640x12, | |
| | sym 1280x12, |
| sym2560x12 | |
| }, | |
| configuredGrantTimer | INTEGER (1..64) |
| OPTIONAL, -- Need R | |
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING |
| (SIZE(18)), | |
| antennaPort | INTEGER (0..31), |
| dmrs-SeqInitialization | INTEGER (0..1) |
| OPTIONAL, -- Need R | |
| precodingAndNumberOfLayers | INTEGER (0..63), |
| srs-ResourceIndicator | INTEGER (0..15) |
| OPTIONAL, -- Need R | |
| mcsAndTBS | INTEGER (0..31), |
| frequencyHoppingOffset | INTEGER (1.. |
| maxNrofPhysicalResourceBlocks-1) | OPTIONAL, -- |
| Need R | |
| pathlossReferenceIndex | INTEGER |

(0..maxNrofPUSCH-PathlossReferenceRSs-1),

```
        ...
    }
OPTIONAL, -- Need R
    ...
}
```

Next, a PUSCH transmission method will be described. A DMRS antenna port for PUSCH transmission is the same as an antenna port for SRS transmission. PUSCH transmission may be dependent on a codebook-based transmission method and a non-codebook-based transmission method, respectively, depending on whether the value of txConfig in pusch-Config of Table 14, which is higher layer signaling, is “codebook” or “nonCodebook”.

As described above, PUSCH transmission may be dynamically scheduled through DCI format 0_0 or 0_1, and may be semi-statically configured by a configured grant. If the UE receives an indication to schedule PUSCH transmission through DCI format 0_0, the UE performs beam configuration for PUSCH transmission by using pucch-spatial RelationInfolD corresponding to the UE-specific PUCCH resource corresponding to the minimum ID in the UL BWP activated in a serving cell, and here, PUSCH transmission is based on a single antenna port. The UE does not expect scheduling for PUSCH transmission through DCI format 0_0 within a BWP in which the PUCCH resource including the pucch-spatialRelationInfo is not configured. If the UE has not configured with txConfig in pusch-Config of Table 15, the UE does not expect to be scheduled in DCI format 0_1.

TABLE 15

| | |
|---|---|
| PUSCH-Config ::= | SEQUENCE { |
| dataScramblingIdentityPUSCH | INTEGER (0..1023) |
| OPTIONAL, --Need S | |
| txConfig | ENUMERATED |
| {codebook, nonCodebook} | |
| OPTIONAL, -- Need S | |
| dmrs-UplinkForPUSCH-MappingTypeA | SetupRelease { DMRS- |
| UplinkConfig } | OPTIONAL, -- |
| Need M | |
| dmrs-UplinkForPUSCH-MappingTypeB | SetupRelease { DMRS- |
| UplinkConfig } | OPTIONAL, -- |
| Need M | |
| pusch-PowerControl | PUSCH-PowerControl |
| OPTIONAL, -- Need M | |
| frequencyHopping | ENUMERATED |
| {intraSlot, interSlot} | OPTIONAL, |
| -- Need S | |
| frequencyHoppingOffsetLists | SEQUENCE (SIZE (1..4)) |

OF INTEGER (1..maxNrofPhysicalResourceBlocks-1)

| | |
|---|---|
| OPTIONAL, -- Need M | |
| resourceAllocation | ENUMERATED |

{ resourceAllocation Type0, resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need |
| M | |
| pusch-AggregationFactor | ENUMERATED { n2, n4, |
| n8 } | OPTIONAL, -- |
| Need S | |
| mcs-Table | ENUMERATED |
| {qam256, qam64LowSE} | |
| OPTIONAL, -- Need S | |
| mcs-TableTransform Precoder | ENUMERATED {qam256, |
| qam64LowSE} | OPTIONAL, -- |
| Need S | |
| transform Precoder | ENUMERATED {enabled, |
| disabled} | OPTIONAL, -- |
| Need S | |
| codebookSubset | ENUMERATED |

{fullyAndPartialAndNonCoherent, partialAndNonCoherent,nonCoherent}

| | |
|---|---|
| OPTIONAL, -- Cond codebookBased | |
| maxRank | INTEGER (1..4) |
| OPTIONAL, -- Cond codebookBased | |
| rbg-Size | ENUMERATED |
| { config2} | OPTIONAL, -- Need S |
| uci-OnPUSCH | SetupRelease { UCI- |
| OnPUSCH} | OPTIONAL, -- Need M |
| tp-pi2BPSK | ENUMERATED |
| {enabled} | OPTIONAL, -- Need S |
| ... | |
| } | |

Next, codebook-based PUSCH transmission will be described. Codebook-based PUSCH transmission may be dynamically scheduled through DCI format 0_0 or 0_1, and may operate semi-statically by a configured grant. When the codebook-based PUSCH is dynamically scheduled by DCI format 0_1 or is configured semi-statically by a configured grant, the UE determines a precoder for PUSCH transmission based on an SRS resource indicator (SRI), a transmission precoding matrix indicator (TPMI), and a transmission rank (the number of PUSCH transport layers).

Here, the SRI may be given through a field SRS resource indicator in DCI or may be configured through srs-ResourceIndicator, which is higher layer signaling. The UE is configured with at least one SRS resource when transmitting a codebook-based PUSCH, and may be configured with up to two SRS resources. When the UE is provided with an SRI through DCI, the SRS resource indicated by the corresponding SRI denotes an SRS resource corresponding to the SRI among SRS resources transmitted before the PDCCH including the corresponding SRI. In addition, TPMI and transmission rank may be given through field precoding information and number of layers in DCI, or may be configured through precodingAndNumberOfLayers, which is higher layer signaling. TPMI is used to indicate a precoder applied to PUSCH transmission. If the UE is configured with one SRS resource, the TPMI is used to indicate a precoder to be applied in the configured one SRS resource. If the UE is configured with multiple SRS resources, the TPMI is used to indicate a precoder to be applied in the SRS resource indicated through the SRI.

A precoder to be used for PUSCH transmission is selected from a UL codebook having the same number of antenna ports as the value of SRS-Ports in SRS-Config, which is higher layer signaling. In codebook-based PUSCH transmission, the UE determines a codebook subset based on the TPMI and codebookSubset in pusch-Config, which is higher layer signaling. CodebookSubset in pusch-Config, which is higher layer signaling, may be configured with one of “fullyAndPartialAndNonCoherent”, “partialAndNonCoherent”, or “nonCoherent” based on the UE capability reported by the UE to the base station. If the UE reports “partialAndNonCoherent” as UE capability, the UE does not expect that the value of codebookSubset, which is higher layer signaling, is configured to be “fullyAndPartialAndNonCoherent”. In addition, if the UE reports “nonCoherent” as UE capability, the UE does not expect that the value of codebookSubset, which is higher layer signaling, is configured to be “fullyAndPartialAndNonCoherent” or “partialAndNonCoherent”. When nrofSRS-Ports in SRS-ResourceSet, which is higher layer signaling, indicates two SRS antenna ports, the UE does not expect that the value of codebookSubset, which is higher layer signaling, is configured to be “partialAndNonCoherent”.

The UE may be configured with one SRS resource set in which the value of usage in the SRS-ResourceSet, which is higher layer signaling, is configured to be “codebook”, and one SRS resource in the corresponding SRS resource set may be indicated through SRI. If multiple SRS resources are configured in the SRS resource set in which the usage value in the SRS-ResourceSet, which is higher layer signaling, is configured to be “codebook”, the UE expects that the values of nrofSRS-Ports in the SRS-Resource, which is higher layer signaling, are configured to be the same value with respect to all SRS resources.

The UE transmits, to the base station, one or multiple SRS resources included in the SRS resource set in which the value of usage is configured to be “codebook” according to higher layer signaling, and the base station indicates the UE to perform PUSCH transmission by selecting one of the SRS resources transmitted by the UE and using transmission beam information of the corresponding SRS resource. Here, in the codebook-based PUSCH transmission, the SRI is used as information for selection of the index of one SRS resource and is included in the DCI. Additionally, the base station includes, in the DCI, information indicating a rank and a TPMI to be used by the UE for PUSCH transmission. The UE performs PUSCH transmission by using the SRS resource indicated by the SRI and applying a rank indicated based on the transmission beam of the SRS resource and a precoder indicated by the TPMI.

Next, non-codebook-based PUSCH transmission will be described. Non-codebook-based PUSCH transmission may be dynamically scheduled through DCI format 0_0 or 0_1, and may be semi-statically operated by a configured grant. When at least one SRS resource is configured in the SRS resource set in which the value of usage in the SRS-ResourceSet, which is higher layer signaling, is configured to be “nonCodebook”, the UE may be scheduled with non-codebook-based PUSCH transmission through DCI format 0_1.

For the SRS resource set in which the value of usage in the SRS-ResourceSet, which is higher layer signaling, is configured to be “nonCodebook”, the UE may be configured with one connected non-zero power (NZP) CSI-RS resource. The UE may perform calculation of the precoder for SRS transmission by measuring the NZP CST-RS resource connected to the SRS resource set. If the difference between the last received symbol of the aperiodic NZP CSI-RS resource connected to the SRS resource set and the first symbol of aperiodic SRS transmission in the UE is less than 42 symbols, the UE does not expect information on the precoder for SRS transmission to be updated.

When the value of resourceType in the SRS-ResourceSet, which is higher layer signaling, is configured to be “aperiodic”, the connected NZP CSI-RS is indicated by SRS request, which is a field in DCI format 0_1 or 1_1. Here, if the connected NZP CSI-RS resource is an aperiodic NZP CSI-RS resource, the connected NZP CSI-RS exists when the value of the SRS request field in DCI format 0_1 or 1_1 is not “00”. In this case, the DCI should not indicate cross carrier or cross BWP scheduling. In addition, when the value of the SRS request indicates the existence of the NZP CSI-RS, the corresponding NZP CSI-RS is located in a slot in which a PDCCH including the SRS request field is transmitted. Here, TCI states configured via the scheduled subcarrier are not configured to be QCL-TypeD.

If a periodic or semi-persistent SRS resource set is configured, the connected NZP CSI-RS may be indicated through associated CSI-RS in the SRS-ResourceSet, which is higher layer signaling. For non-codebook-based transmission, the UE does not expect that spatialRelationInfo, which is higher layer signaling for an SRS resource, and associated CSI-RS in SRS-ResourceSet, which is higher layer signaling, are configured together.

When the UE is configured with multiple SRS resources, the UE may determine a precoder to be applied to PUSCH transmission and a transmission rank, based on the SRI indicated by the base station. Here, the SRI may be indicated through a field SRS resource indicator in DCI or may be configured through srs-ResourceIndicator, which is higher layer signaling. As in the above-described codebook-based PUSCH transmission, when the UE is provided with an SRI through DCI, an SRS resource indicated by the SRI denotes an SRS resource corresponding to the SRI among SRS resources transmitted before the PDCCH including the SRI. The UE may use one or multiple SRS resources for SRS transmission, and the maximum number of SRS resources that can be simultaneously transmitted in the same symbol in one SRS resource set are determined by UE capability reported by the UE to the base station. Here, the SRS resources simultaneously transmitted by the UE occupy the same RB. The UE configures one SRS port for each SRS resource. Only one SRS resource set in which the value of usage in the SRS-ResourceSet, which is higher layer signaling, is configured to be “nonCodebook” can be configured, and up to four SRS resources for non-codebook-based PUSCH transmission can be configured.

The base station transmits one NZP-CSI-RS connected to the SRS resource set to the UE, and the UE performs calculation of a precoder to be used for transmission of one or multiple SRS resources in the corresponding SRS resource set based on a result of measurement at the time of reception of the NZP-CSI-RS. The UE applies, to the base station, the calculated precoder when transmitting one or multiple SRS resources in the SRS resource set in which usage is configured to be “nonCodebook”, and the base station selects one or multiple SRS resources among the received one or multiple SRS resources. In this case, in non-codebook-based PUSCH transmission, the SRI indicates an index capable of expressing one or a combination of multiple SRS resources, and the SRI is included in the DCI. Here, the number of SRS resources indicated by the SRI transmitted by the base station may be the number of transmission layers of the PUSCH, and the UE performs PUSCH transmission by applying a precoder applied for SRS resource transmission to each layer.

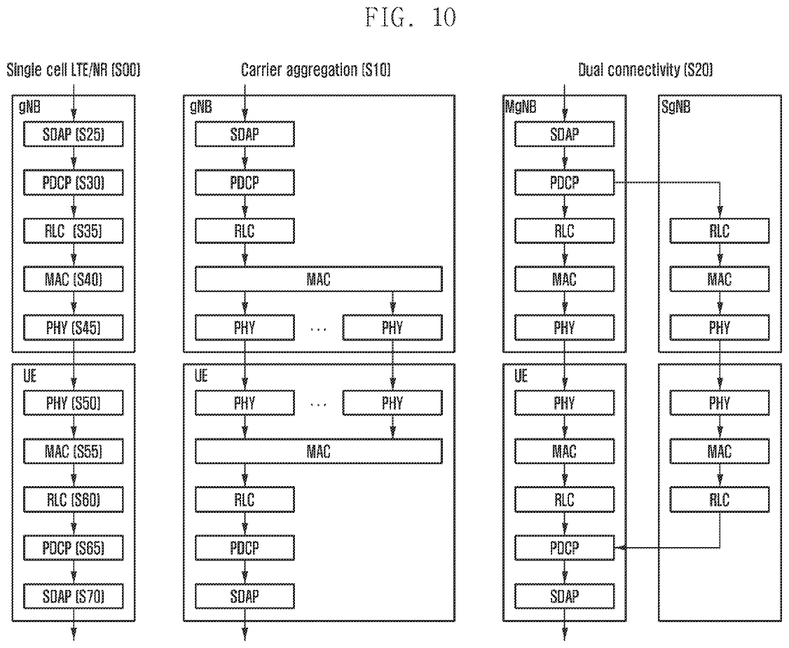

FIG. 10 illustrates a radio protocol structure of a base station and a UE in a single cell situation, a carrier aggregation situation, and a dual connectivity situation in a wireless communication system, according to an embodiment.

Referring to FIG. 10, the radio protocol of the next generation mobile communication system includes, for each of a UE and an NR base station, NR service data adaptation protocols (NR SDAPs) S25 and S70, NR packet data convergence protocols (NR PDCPs) S30 and S65, and NR radio link controls (NR RLCs) S35 and S60, and NR medium access control (NR MACs) S40 and S55.

The functions of the NR SPAPs S25 and S70 may include one or more of the following functions:
Transfer of user plane data
Mapping between a quality of service (QoS) flow and a data bearer (DRB) for both DL and UL
Marking QoS flow ID in both DL and UL packets
Reflective QoS flow to DRB mapping for the UL SDAP PDUs.

With respect to the SDAP layer device, a UE may receive, through an RRC message, a configuration associated with whether to use a header of the SDAP layer device or whether to use a function of the SDAP layer device, for each PDCP layer device, each bearer, and each logical channel. In case that the SDAP header is configured, the UE is instructed with a one-bit non-access stratum (NAS) reflective QoS indicator (NAS reflective QoS) and a one-bit access stratum (AS) reflective QoS indicator (an AS reflective QoS) of the SDAP header to update or reconfigure mapping information between a data bearer and a QoS flow of UL and DL. The SDAP header may include QoS flow ID information indicating QoS. The QoS information may be used as a data processing priority for supporting smooth services or scheduling information.

The functions of the NR PDCPs S30 and S65 may include one or more of the following functions:
Header compression and decompression: robust header compression (ROHC) only
Transfer of user data
In-sequence delivery of higher layer PDUs
Out-of-sequence delivery of higher layer PDUs
PDCP PDU reordering for reception
Duplicate detection of lower layer SDUs
Retransmission of PDCP SDUs
Ciphering and deciphering
Timer-based SDU discard in UL

In the embodiments described above, a reordering function of the NR PDCP device refers to a function of sequentially reordering PDCP PDUs, received from a lower layer, based on a PDCP sequence number (SN), and may include a function of transmitting data to a higher layer in the sequence of reordering. Alternatively, the reordering function of the NR PDCP device may include a function of transmitting data without considering the sequence, a function of reordering the sequence and recording missing PDCP PDUs, a function of providing a state report on the missing PDCP PDUs to a transmission side, and a function of requesting retransmission for the missing PDCP PDUs.

The functions of the NR RLCs S35 and S60 may include one or more of the following functions:
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery function of the NR RLC device refers to a function of transmitting RLC SDUs, received from a lower layer, to a higher layer in the sequence of reception. The in-sequence delivery function of the NR RLC device may include: in case that one RLC SDU is originally segmented into multiple RLC SDUs and received, a function of reassembling and transmitting the multiple RLC SDUs; a function of reordering the received RLC PDUs based on an RLC SN or PDCP SN; a function of reordering the sequence and recording missing RLC PDUs; a function of providing a state report on the missing RLC PDUs to a transmission side; and a function of requesting retransmission for the missing RLC PDUs. In case that the missing RLC SDU occurs, the in-sequence delivery function of the NR RLC device may include a function of sequentially transmitting only the RLC SDUs prior to the missing RLC SDU to a higher layer or sequentially transmitting all the RLC SDUs received before a timer starts to a higher layer in case that a predetermined timer expires although there is a missing RLC SDU. Alternatively, the in-sequence delivery function of the NR RLC device may include a function of sequentially transmitting all RLC SDUs received so far to a higher layer in case that a predetermined timer expires although there is a missing RLC SDU. In addition, the RLC PDUs may be processed in the sequence that the RLC PDUs are received (in the sequence of arrival regardless of the sequence of serial number and sequence number), and may be transmitted to a PDCP device out of sequence delivery. In a case of segments, the in-sequence delivery function may include a function of receiving segments stored in a buffer or segments to be received later, reconfiguring the segments in one complete RLC PDU, processing the RLC PDU, and transmitting the RLC PDU to the PDCP device. The NR RLC layer may not include a concatenation function, and the concatenation function may be performed by the NR MAC layer or may be replaced by a multiplexing function of the NR MAC layer.

In the above described embodiments, the out-of-sequence delivery function of the NR RLC device refers to a function of directly transmitting the RLC SDUs, received from the lower layer, to a higher layer regardless of the order, and may include, in case that one RLC SDU has been originally segmented into multiple RLC SDUs and received, a function of reassembling the multiple RLC SDUs and transmitting the same, and a function of storing the RLC SNs or PDCP SNs of the received RLC PDUs, reordering the sequence, and recording the missing RLC PDUs.

The NR MACs S40 and S55 may be connected to multiple NR RLC layer devices configured in one UE, and the functions of the NR MAC may include one or more of the following functions:
Mapping between logical channels and transport channels
Multiplexing/de-multiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR physical (PHY) layers S45 and S50 may perform an operation of channel-coding and modulating higher layer data, generating the higher layer data into an OFDM symbol, transmitting the OFDM symbols via a radio channel, demodulating and channel decoding of the OFDM symbols received via the radio channel, and/or transferring the OFDM symbol to a higher layer.

The detailed structure of the radio protocol structure may be variously changed according to a carrier (or cell) operating method. For example, when the base station performs single carrier (or cell)-based data transmission to the UE, the base station and the UE use a protocol structure, which has a single structure for each layer, as indicated by reference numeral S00. On the other hand, when the base station transmits data to the UE based on carrier aggregation (CA) using multiple carriers in a single TRP, the base station and the UE has a single structure up to the RLC but uses a protocol structure of multiplexing a PHY layer through a MAC layer, as indicated by reference numeral S10. As another example, when the base station transmits data to the UE based on dual connectivity using multiple carriers in multiple TRP, the base station and the terminal have a single structure up to the RLC, but use a protocol structure of multiplexing a PHY layer through a MAC layer, as indicated by reference numeral S20.

Meanwhile, referring to the PDCCH and beam configuration related descriptions above, since PDCCH repetitive transmission is not supported currently in Rel-15 and Rel-16 NR, it is difficult to achieve the required reliability in a scenario requiring high reliability, such as URLLC. The disclosure proposes a method for improving PDCCH reception reliability of a UE by providing a PDCCH repetitive transmission method through multiple transmission points (TRP). A specific method is described in detail in the following embodiments.

The contents of the disclosure are applicable to frequency division duplex (FDD) and time division duplex (TDD) systems. Hereinafter, higher signaling (or higher layer signaling) is a signal transmission method in which signal transmission occurs from a base station to a UE by using a DL data channel of a PHY layer, or in which transmission occurs from a UE to a base station by using an UL data channel of a PHY layer, and may be referred to as RRC signaling, PDCP signaling, or a MAC control element (MAC CE).

In determining whether to apply cooperative communication, the UE may use various methods, such as, in which PDCCH(s) for allocation of PDSCH to which the cooperative communication is applied has a specific format, PDCCH(s) for allocation of PDSCH to which the cooperative communication is applied include a specific indicator indicating whether cooperative communication is applied, PDCCH(s) for allocation of PDSCH to which cooperative communication is applied is scrambled by a specific RNTI, or cooperative communication is assumed to be applied in a specific interval indicated by a higher layer. For convenience of description, a case in which a UE receives a PDSCH to which cooperative communication is applied based on conditions similar to the above will be referred to as a non-coherent joint transmission (NC-JT) case.

Determining the priority between A and B is variously referred to as selecting one having a higher priority according to a predetermined priority rule and performing an operation corresponding thereto or omitting or dropping an operation corresponding to one having a lower priority.

The examples mentioned above will be described through multiple embodiments, but these are not independent and it is possible that one or more embodiments may be applied simultaneously or in combination.

A base station is a subject that performs resource allocation of a UE, and may be at least one of a gNode B, a gNB, an eNode B, a Node B, a base station, a radio access unit, a base station controller, or a node on a network. The UE may include a UE, a mobile station (MS), a cellular phone, a smart phone, a computer, or a multimedia system capable of performing a communication function. An embodiment of the disclosure will be described using a 5G system as an example, but the embodiment of the disclosure may be applied to other communication systems having a similar technical background or channel type. For example, LTE or LTE-A mobile communication and mobile communication technology developed after 5G may be included therein. Accordingly, the embodiments of the disclosure may be applied to other communication systems through some modifications within a range that does not significantly depart from the scope of the disclosure as determined by those of ordinary skill in the art. The contents of the disclosure are applicable to FDD and TDD systems.

In addition, in the description of the disclosure, in case that it is determined that a detailed description of a related function or configuration may unnecessarily obscure the subject matter of the disclosure, the detailed description thereof will be omitted. In addition, the terms to be described later are terms defined considering functions in the disclosure, which may vary according to intentions or customs of users and operators. Therefore, the definition should be made based on the content throughout this specification.

Higher layer signaling may be signaling corresponding to at least one or a combination of one or more of the following signaling.
MIB
SIB or SIB X (X=1, 2, . . . )
RRC
MAC CE

In addition, L1 signaling may be signaling corresponding to at least one or a combination of one or more signaling methods using the following PHY layer channel or signaling.
PDCCH
DCI
UE-specific DCI
Group common DCI
Common DCI
Scheduling DCI (for example, DCI used for scheduling DL or UL data)
Non-scheduling DCI (for example, DCI not for the purpose of scheduling DL or UL data)
PUCCH
UL control information (UCI)

Hereinafter, in the disclosure, determining the priority between A and B is variously referred to as selecting one having a higher priority according to a predetermined priority rule and performing an operation corresponding thereto or omitting or dropping an operation corresponding to one having a lower priority.

The above examples will be described through multiple embodiments, but these are not independent and it is possible that one or more embodiments may be applied simultaneously or in combination.

According to a 3GPP NR system, a UE may use two PDSCH mapping types to determine the location of a DMRS for PDSCH reception. The two PDSCH mapping types may be referred to as PDSCH mapping type A or PDSCH mapping type B for convenience.

According to PDSCH mapping type A, a first DMRS (first DMRS or front-loaded DMRS) of a PDSCH may start from a K-th symbol of a slot. Here, K is a value of 2 or 3 and is indicated in a PBCH. For reference, a symbol (0th symbol) corresponding to K=0 is the first symbol of a slot. In order for the UE to receive a PDSCH of PDSCH mapping type A, a time domain of the PDSCH should include the K-th symbol. That is, with regard to time domain allocation of the PDSCH of PDSCH mapping type A, a start symbol (S) should have one symbol among 0, 1, 2, and 3 symbols, and the length (L) should have the value of one of 3, 4, . . . , 14. Table 16, below, shows a possible combination of start symbol (S) and length (L) when PDSCH mapping type A is used.

According to PDSCH mapping type B, a first DMRS (first DMRS or front-loaded DMRS) of a PDSCH may be located in a first symbol of a scheduled PDSCH. Unlike PDSCH mapping type A, in PDSCH mapping type B, the location of the first DMRS may be determined according to time resource allocation of a scheduled PDSCH. With regard to time domain allocation of PDSCH of PDSCH mapping type B, a start symbol (S) may have one symbol among 0, 1, . . . , 12 symbols, and the length (L) may have the value of one of 2, 3, . . . , 13. Table 16 shows a possible combination of start symbols (S) and lengths (L) when PDSCH mapping type B is used.

TABLE 16
Valid S and L combinations

| | Normal cyclic prefix | | | Extended cyclic prefix | | |
|---|---|---|---|---|---|---|
| PDSCH | S | L | S + L | S | L | S + L |
| Type A | {0, 1, 2, 3} | {3, . . . , 14} | {3, . . . , 14} | (0, 1, 2, 3} | {3, . . . , 12} | {3, . . . , 12} |
| | (Note 1) | | | (Note 1) | | |
| Type B | {0, . . . , 12} | {2, . . . , 13} | {2, . . . , 14} | (0, . . . , 10} | {2, 4, 6} | {2, . . . , 12} |

Note 1:
S = 3 is applicable only if dmrs-TypeA-Position = 3

Although the PDSCH mapping type has been described here, two PUSCH mapping types (PUSCH mapping type A and PUSCH mapping type B) may be used equally for PUSCH. In the following description, for convenience, PDSCH to PUSCH are omitted and referred to as a mapping type.

A UE may receive an indication of time domain information and a mapping type through a time domain resource assignment (TDRA) field of DCI format.

A base station may configure a TDRA table to be used in DCI format for the UE. The TDRA table has multiple rows. Each row may include one or more of an index of a TDRA row, time domain information (S, L) included in a TDRA row, a mapping type of a TDRA row, and/or a slot offset value (K0 value) for reception of PDSCH or a slot offset value (K2 value) for transmission of PUSCH according to time domain information of a TDRA row.

The UE may receive an index of a TDRA row in a TDRA field of the DCI format. Accordingly, the UE may obtain time domain information of the TDRA row corresponding to the index of the TDRA row and information on a mapping type and the like thereof.

In the case of mapping type A and mapping type B, they may have different use cases. For example, in the case of PDSCH (or PUSCH) of mapping type A, a first DMRS always starts at the K-th symbol of a slot regardless of time domain resource allocation of the PDSCH (or PUSCH). Therefore, although different UEs receive scheduling of PDSCHs (or PUSCHs) with different time domain resource allocations, the locations of first DMRSs of the PDSCHs (or PUSCHs) are the same. Therefore, mapping type A may be suitable for multiplexing between different UEs, that is, multi-user MIMO (MU-MIMO). In the case of mapping type B, when different UEs receive (transmit) PDSCHs (or PUSCHs) of different starting locations, the locations of first DMRSs of the PDSCHs (or PUSCHs) of the different UEs may be different. In the case of mapping type B, since the DMRS is always located in the first symbol of the scheduled PDSCH (or PUSCH), a UE is capable of receiving the DMRS the fastest and performing channel estimation or PDSCH decoding (a base station is capable of receiving the DMRS the fastest and performing channel estimation or PUSCH decoding). Accordingly, mapping type B may be suitable for environments requiring fast PDSCH (or PUSCH) reception (transmission) and decoding. Therefore, different mapping types may have different DMRS configurations.

A UE may have different DMRS configurations for each mapping type.

A DMRS configuration may include one or more of the following three pieces of information.
dmrs-Type: configures as one of DMRS configuration type 1 and 2
maxLength: configures the maximum number of symbols that DMRS can occupy
dmrs-AdditionalPosition: configures an additional DMRS other than the first DMRS (first DMRS or front-loaded DMRS)

The three pieces of information of the DMRS configuration may be configured differently for each mapping type. For example, in the case of mapping type A, dmrs-Type may be configured as 1, and in the case of mapping type B, dmrs-Type may be configured as 2. For example, in the case of mapping type A, maxLength may be configured as 2, and in the case of mapping type B, maxLength may be configured as 1. For example, dmrs-AdditionalPosition of mapping type A and dmrs-AdditionlaPosition of mapping type B may be different.

An antenna port field will now be described.

A UE needs information about a DMRS port for PDSCH reception or PUSCH transmission. The information may be indicated in an antenna port field of a DCI format for scheduling the PDSCH or PUSCH.

The antenna port field may indicate one row of an antenna port table. Here, a row of the antenna port table may include one or more of an index of a row in the antenna port table, an index (or indices) of DMRS port(s) corresponding to the row of the antenna port table, the number of DMRS symbols corresponding to a row of the antenna port table (which exists when maxLength is equal to or greater than 2), and/or the number of code division multiplexing (CDM) groups without data corresponding to rows of the antenna port table.

A UE may receive different DMRS configurations for each mapping type. For example, mapping type A may be configured as a 1st DMRS configuration, and mapping type B may be configured as a 2nd DMRS configuration. Accordingly, a first antenna port table for PDSCH (or PUSCH) scheduled with mapping type A may be different from a second antenna port table for PDSCH (or PUSCH) scheduled with mapping type B. In addition, the two antenna port tables may have different numbers of rows. In the same row index of the two antenna port tables, index (or indices) of different DMRS port(s), different numbers of DMRS symbols, or different numbers of CDM groups without data may be included.

The UE may receive a row of one table indicated among the two antenna port tables in a DCI format. More specifically, the UE may determine the length of the antenna port field of the DCI format, based on the maximum value of the number of rows of each of the two antenna port tables. For example, assume that the first antenna port table includes a total of 32 rows and the second antenna port table includes 64 rows. In this case, the UE may determine the length of the antenna port field based on the maximum value of 64. That is, it may be determined as ceil(log 2(64))=6 bits.

The UE may determine a mapping type of the PDSCH (or PUSCH) scheduled through the TDRA field of the DCI format. The UE may determine an antenna port table based on the DMRS configuration of the mapping type. In addition, the required number of bits may be determined according to the determined number of rows of the antenna port table. The required number of bits may be equal to or smaller than the number of bits of an antenna port. The UE may obtain an index of a row of an antenna port table from some bits (e.g., a least significant bit (LSB)) of the required number of bits in the antenna port field. Through a series of processes, the UE may obtain the mapping type of the scheduled PDSCH (or PUSCH) and DMRS-association information (index (indices) of DMRS port(s), the number of DMRS symbols, the number of CDM groups without data, etc.).

For reference, in the case of PUSCH, an antenna port table may be determined according to the DMRS configuration of the mapping type of the scheduled PUSCH and the rank of the PUSCH.

Table 17 is an antenna port field of DCI format 0_1 for PUSCH scheduling, and Tables 18 to 37 are antenna port tables corresponding thereto.

TABLE 17
DCI format 0_1

| - | Antenna ports - number of bits determined by the following | |
|---|---|---|
| | - | 2 bits as defined by Tables 7.3.1.1.2-6 in 3GPP TS38.211 (defined below), if |
| | | transform precoder is enabled, dmrs-Type=1, and maxLength=1, except that |
| | | dmrs-UplinkTransformPrecoding and tp-pi2BPSK are both configured and π/2 |
| | | binary phase shift keying (BPSK) modulation is used; |
| | - | 2 bits as defined by Tables 7.3.1.1.2-6A in 3GPP TS38.211 (defined below), if |
| | | transform precoder is enabled and dmrs-UplinkTransformPrecoding and tp- |
| | | pi2BPSK are both configured, π/2 BPSK modulation is used, dmrs-Type=1, and |
| | | maxLength=1, where n_{SCID} is the scrambling identity for antenna ports defined in |
| | | [Clause 6.4.1.1.1.2, 3GPP TS38.211]; |
| | - | 4 bits as defined by Tables 7.3.1.1.2-7 in 3GPP TS38.211 (defined below), if |
| | | transform precoder is enabled, dmrs-Type=1, and maxLength=2, except that |
| | | dmrs-UplinkTransformPrecoding and tp-pi2BPSK are both configured and π/2 |
| | | BPSK modulation is used; |
| | - | 4 bits as defined by Tables 7.3.1.1.2-7A in 3GPP TS38.211 (defined below), if |
| | | transform precoder is enabled and dmrs-UplinkTransformPrecoding and tp- |
| | | pi2 BPSK are both configured, π/2 BPSK modulation is used, dmrs-Type=1, and |
| | | maxLength=2, where n_{SCID} is the scrambling identity for antenna ports defined in |
| | | [Clause 6.4.1.1.1.2, TS38.211]; |
| | - | 3 bits as defined by Tables 7.3.1.1.2-8/9/10/11 in 3GPP TS38.211 (defined |
| | | below), if transform precoder is disabled, dmrs-Type=1, and maxLength=1, and |
| | | the value of rank is determined according to the SRS resource indicator field if |
| | | the higher layer parameter txConfig = nonCodebook and according to the |
| | | precoding information and number of layers field if the higher layer parameter |
| | | txConfig = codebook; |
| | - | 4 bits as defined by Tables 7.3.1.1.2-12/13/14/15 in 3GPP TS38.211 (defined |
| | | below), if transform precoder is disabled, dmrs-Type=1, and maxLength=2, and |
| | | the value of rank is determined according to the SRS resource indicator field if |
| | | the higher layer parameter txConfig = nonCodebook and according to the |
| | | precoding information and number of layers field if the higher layer parameter |
| | | txConfig = codebook; |
| | - | 4 bits as defined by Tables 7.3.1.1.2-16/17/18/19 in 3GPP TS38.211 (defined |
| | | below), if transform precoder is disabled, dmrs-Type=2, and maxLength=1, and |
| | | the value of rank is determined according to the SRS resource indicator field if |
| | | the higher layer parameter txConfig = nonCodebook and according to the |
| | | precoding information and number of layers field if the higher layer parameter |
| | | txConfig = codebook; |
| | - | 5 bits as defined by Tables 7.3.1.1.2-20/21/22/23 in 3GPP TS38.211 (defined |
| | | below), if transform precoder is disabled, dmrs-Type=2, and maxLength=2, and |
| | | the value of rank is determined according to the SRS resource indicator field if |
| | | the higher layer parameter txConfig = nonCodebook and according to the |
| | | precoding information and number of layers field if the higher layer parameter |
| | | txConfig = codebook. |

where the number of CDM groups without data of values 1, 2, and 3 in Tables
7.3.1.1.2-6 to 7.3.1.1.2-23 refers to CDM groups {0}, {0,1}, and {0, 1,2}
respectively.
If a UE is configured with both dmrs-UplinkForPUSCH-MappingTypeA and dmrs-
UplinkForPUSCH-MappingTypeB, the bitwidth of this field equals max{x_{A},x_{B}},
where x_{A} is the “Antenna ports” bitwidth derived according to dmrs-
UplinkForPUSCH-MappingTypeA and x_{B} is the “Antenna ports” bitwidth derived
according to dmrs-UplinkForPUSCH-MappingTypeB. A number of |x_{A} − x_{B}| zeros
are padded in the MSB of this field, if the mapping type of the PUSCH corresponds
to the smaller value of x_{A} and x_{B}.

TABLE 18
(Table 7.3.1.1.2-6): Antenna port(s), transform precoder
is enabled, dmrs-Type = 1, maxLength = 1,
except that dmrs-UplinkTransformPrecoding and tp-pi2BPSK
are both configured and π/2-BPSK modulation is used

| | Number of | |
|---|---|---|
| | DMRS CDM | |
| | group(s) | DMRS |
| Value | without data | port(s) |
| 0 | 2 | 0 |
| 1 | 2 | 1 |
| 2 | 2 | 2 |
| 3 | 2 | 3 |

TABLE 19
(Table 7.3.1.1.2-6A): Antenna port(s), transform
precoder is enabled, dmrs-UplinkTransformPrecoding
and tp-pi2BPSK are both configured, π/2-BPSK
modulation is used, dmrs-Type = 1, maxLength = 1

| | Number of | |
|---|---|---|
| | DMRS CDM | |
| | group(s) | DMRS |
| Value | without data | port(s) |
| 0 | 2 | 0, |
| | | nSCID = |
| | | 0 |
| | 2 | 0, |
| | | nSCID = |
| | | 1 |
| 2 | 2 | 2, |
| | | nSCID = |
| | | 0 |
| 3 | 2 | 2, |
| | | nSCID = |
| | | 1 |

TABLE 20
(Table 7.3.1.1.2-7): Antenna port(s), transform precoder
is enabled, dmrs-Type = 1, maxLength = 2,
except that dmrs-UplinkTransformPrecoding and tp-pi2BPSK
are both configured and π/2-BPSK modulation is used

| | Number of DMRS | | Number of |
|---|---|---|---|
| | CDM group(s) | DMRS | front-load |
| Value | without data | port(s) | symbols |
| 0 | 2 | 0 | 1 |
| 1 | 2 | 1 | 1 |
| 2 | 2 | 2 | 1 |
| 3 | 2 | 3 | 1 |
| 4 | 2 | 0 | 2 |
| 5 | 2 | 1 | 2 |
| 6 | 2 | 2 | 2 |
| 7 | 2 | 3 | 2 |
| 8 | 2 | 4 | 2 |
| 9 | 2 | 5 | 2 |
| 10 | 2 | 6 | 2 |
| 11 | 2 | 7 | 2 |
| 12-15 | Reserved | Reserved | Reserved |

TABLE 21
(Table 7.3.1.1.2-7A): Antenna port(s), transform
precoder is enabled, dmrs-UplinkTransformPrecoding
and tp-pi2BPSK are both configured, π/2-BPSK
modulation is used, dmrs-Type = 1, maxLength = 2

| | Number of DMRS | | Number of |
|---|---|---|---|
| | CDM group(s) | DMRS | front-load |
| Value | without data | port(s) | symbols |
| 0 | 2 | 0, nSCID = 0 | 1 |
| 1 | 2 | 0, nSCID = 1 | 1 |
| 2 | 2 | 2, nSCID = 0 | 1 |
| 3 | 2 | 2, nSCID = 1 | 1 |
| 4 | 2 | 0, nSCID = 0 | 2 |
| 5 | 2 | 0, nSCID = 1 | 2 |
| 6 | 2 | 2, nSCID = 0 | 2 |
| 7 | 2 | 2, nSCID = 1 | 2 |
| 8 | 2 | 4, nSCID = 0 | 2 |
| 9 | 2 | 4, nSCID = 1 | 2 |
| 10 | 2 | 6, nSCID = 0 | 2 |
| 11 | 2 | 6, nSCID = 1 | 2 |
| 12-15 | Reserved | Reserved | Reserved |

TABLE 22
(Table 7.3.1.1.2-8): Antenna port(s), transform precoder is disabled,
dmrs-Type = 1, maxLength = 1, rank = 1

| | Number of DMRS | |
|---|---|---|
| | CDM group(s) | DMRS |
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

TABLE 23
(Table 7.3.1.1.2-9): Antenna port(s), transform precoder is disabled,
dmrs-Type = 1, maxLength = 1, rank = 2

| | Number of DMRS | |
|---|---|---|
| | CDM group(s) | DMRS |
| Value | without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

TABLE 24
(Table 7.3.1.1.2-10): Antenna port(s), transform precoder is disabled,
dmrs-Type = 1, maxLength = 1, rank = 3

| | Number of DMRS | |
|---|---|---|
| | CDM group(s) | DMRS |
| Value | without data | port(s) |
| 0 | 2 | 0-2 |
| 1-7 | Reserved | Reserved |

TABLE 25
(Table 7.3.1.1.2-11): Antenna port(s), transform precoder is disabled,
dmrs-Type = 1, maxLength = 1, rank = 4

| | Number of DMRS | |
|---|---|---|
| | CDM group(s) | DMRS |
| Value | without data | port(s) |
| 0 | 2 | 0-3 |
| 1-7 | Reserved | Reserved |

TABLE 26
(Table 7.3.1.1.2-12): Antenna port(s), transform precoder is disabled,
dmrs-Type = 1, maxLength = 2, rank = 1

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

TABLE 27
(Table 7.3.1.1.2-13): Antenna port(s), transform precoder is disabled,
dmrs-Type = 1, maxLength = 2, rank = 2

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

TABLE 28
(Table 7.3.1.1.2-14): Antenna port(s), transform precoder is disabled,
dmrs-Type = 1, maxLength = 2, rank = 3

| | Number of DMRS | | Number of |
|---|---|---|---|
| | CDM group(s) | DMRS | front-load |
| Value | without data | port(s) | symbols |
| 0 | 2 | 0-2 | |
| | 2 | 0, 1, 4 | 2 |
| 2 | 2 | 2, 3, 6 | 2 |
| 3-15 | Reserved | Reserved | Reserved |

TABLE 29
(Table 7.3.1.1.2-15): Antenna port(s), transform precoder is disabled,
dmrs-Type = 1, maxLength = 2, rank = 4

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

TABLE 30
(Table 7.3.1.1.2-16): Antenna port(s), transform precoder is disabled,
dmrs-Type = 2, maxLength = 1, rank = 1

| | Number of DMRS | |
|---|---|---|
| | CDM group(s) | DMRS |
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-15 | Reserved | Reserved |

TABLE 31
(Table 7.3.1.1.2-17): Antenna port(s), transform precoder is disabled,
dmrs-Type = 2, maxLength = 1, rank = 2

| | Number of DMRS | |
|---|---|---|
| | CDM group(s) | DMRS |
| Value | without data | port(s) |
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-15 | Reserved | Reserved |

TABLE 32
(Table 7.3.1.1.2-18): Antenna port(s), transform precoder is disabled,
dmrs-Type = 2, maxLength = 1, rank = 3

| | Number of DMRS | |
|---|---|---|
| | CDM group(s) | DMRS |
| Value | without data | port(s) |
| 0 | 2 | 0-2 |
| 1 | 3 | 0-2 |
| 2 | 3 | 3-5 |
| 3-15 | Reserved | Reserved |

TABLE 33
(Table 7.3.1.1.2-19): Antenna port(s), transform precoder is disabled,
dmrs-Type = 2, maxLength = 1, rank = 4

| | Number of DMRS | |
|---|---|---|
| | CDM group(s) | DMRS |
| Value | without data | port(s) |
| 0 | 2 | 0-3 |
| 1 | 3 | 0-3 |
| 2-15 | Reserved | Reserved |

TABLE 34
(Table 7.3.1.1.2-20): Antenna port(s), transform precoder is disabled,
dmrs-Type = 2, maxLength = 2, rank = 1

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28-31 | Reserved | Reserved | Reserved |

TABLE 35
(Table 7.3.1.1.2-21): Antenna port(s), transform precoder is disabled,
dmrs-Type = 2, maxLength = 2, rank = 2

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19-31 | Reserved | Reserved | Reserved |

TABLE 36
(Table 7.3.1.1.2-22): Antenna port(s), transform precoder is disabled,
dmrs-Type = 2, maxLength = 2, rank = 3

| | Number of DMRS | | Number of |
|---|---|---|---|
| | CDM group(s) | DMRS | front-load |
| Value | without data | port(s) | symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

TABLE 37
(Table 7.3.1.1.2-23): Antenna port(s), transform precoder is disabled,
dmrs-Type = 2, maxLength = 2, rank = 4

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

Table 38 is an antenna port field of DCI format 1_1 for PDSCH scheduling, and Tables 39 to 46 are antenna port tables corresponding thereto.

TABLE 38
DCI format 1_1

| | |
|---|---|
| - | Antenna port(s) - 4, 5, or 6 bits as defined by Tables |

7.3.1.2.2-1/2/3/4 and Tables 7.3.1.2.2-1A/2A/3A/4A in 3GPP
TS38.211 (defined below), where the number of CDM groups
without data of values 1, 2, and 3 refers to CDM groups {0},
{0,1}, and {0, 1,2} respectively. The antenna ports ^{{p}^{_{0,...,}}^{p}^{_{0−1}}^{}}
shall be determined according to the ordering of DMRS port(s)
given by Tables 7.3.1.2.2-1/2/3/4 or Tables 7.3.1.2.2-
1A/2A/3A/4A in 3GPP TS38.211 (defined below). When a UE
receives an activation command that maps at least one codepoint
of DCI field “Transmission Configuration Indication” to two TCI
states, the UE shall use Table 7.3.1.2.2-1A/2A/3A/4A in 3GPP
TS38.211 (defined below); otherwise, it shall use Tables 7.3.1.2.2-
1/2/3/4 in 3GPP TS38.211 (defined below). The UE may receive
an entry with DMRS ports equal to 1000, 1002, 1003 when two
TCI states are indicated in a codepoint of DCI field “Transmission
Configuration Indication”.
If a UE is configured with both dmrs-DownlinkForPDSCH-
Mapping TypeA and dmrs-DownlinkForPDSCH-MappingTypeB,
the bitwidth of this field equals ^{max{x}_{_{A}}^{,x}_{_{B}}^{}}, where ^{x}^{_{A}} is the
“antenna ports” bitwidth derived according to dmrs-
DownlinkForPDSCH-MappingTypeA and ^{x}^{_{B}} is the “antenna
ports” bitwidth derived according to dmrs-DownlinkForPDSCH-
MappingTypeB. A number of ^{|x}^{_{A}} ⁻ ^{x}^{_{B}}^{|} zeros are padded in the
MSB of this field, if the mapping type of the PDSCH corresponds
to the smaller value of ^{x}^{_{A}} and ^{x}^{_{B}}.

TABLE 39
(Table 7.3.1.2.2-1): Antenna port(s) (1000 + DMRS port),
dmrs-Type = 1, maxLength = 1
One Codeword:
Codeword 0 enabled,
Codeword 1 disabled

| | Number of | |
|---|---|---|
| | DMRS CDM | |
| | group(s) | DMRS |
| Value | without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

TABLE 40
(Table 7.3.1.2.2-1A): Antenna port(s) (1000 + DMRS port),
dmrs-Type = 1, maxLength = 1
One Codeword:
Codeword 0 enabled,
Codeword 1 disabled

| | Number of | |
|---|---|---|
| | DMRS CDM | |
| | group(s) | DMRS |
| Value | without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 1 | 2 | 0, 2 |
| 12 | 2 | 0, 2, 3 |
| 13-15 | Reserved | Reserved |

TABLE 41
(Table 7.3.1.2.2-2): Antenna port(s) (1000 + DMRS port), dmrs-Type = 1,
maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number | | Number of | | Number |
| | DMRS CDM | | of front- | | DMRS CDM | | of front- |
| | group(s) | DMRS | load | | group(s) | DMRS | load |
| Value | without data | port(s) | symbols | Value | without data | port(s) | symbols |
| 0 | 1 | 0 | 1 | | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

TABLE 42
(Table 7.3.1.2.2-2A): Antenna port(s) (1000 + DMRS port), dmrs-Type = 1,
maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number | | Number of | | Number |
| | DMRS CDM | | of front- | | DMRS CDM | | of front- |
| | group(s) | DMRS | load | | group(s) | DMRS | load |
| Value | without data | port(s) | symbols | Value | without data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 2 | 0, 2, 3 | 1 | | | | |

TABLE 43(Table 7.3.1.2.2-3): Antenna port(s) (1000 + DMRS
port), dmrs-Type = 2, maxLength = 1

| One codeword: | | | Two codewords: | | |
|---|---|---|---|---|---|
| Codeword 0 enabled, | | | Codeword O enabled, | | |
| Codeword 1 disabled | | | Codeword 1 enabled | | |
| | Number | | | Number | |
| | of DMRS | | | of DMRS | |
| | CDM group(s) | DMRS | | CDM group(s) | DMRS |
| Value | without data | port(s) | Value | without data | port(s) |
| 0 | 1 | 0 | 0 | 3 | 0-4 |
| 1 | 1 | | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24-31 | Reserved | Reserved | | | |

TABLE 44
(Table 7.3.1.2.2-3A): Antenna port(s) (1000 + DMRS
port), dmrs-Type = 2, maxLength = 1

| One codeword: | | | Two codewords: | | |
|---|---|---|---|---|---|
| Codeword 0 enabled, | | | Codeword 1 enabled | | |
| Codeword 1 disabled | | | Codeword 0 enabled, | | |
| | Number | | | Number | |
| | of DMRS | | | of DMRS | |
| | CDM group(s) | DMRS | | CDM group(s) | DMRS |
| Value | without data | port(s) | Value | without data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24 | 2 | 0, 2, 3 | | | |
| 25-31 | Reserved | Reserved | | | |

TABLE 45
(Table 7.3.1.2.2-4): Antenna port(s) (1000 + DMRS port), dmrs-Type = 2,
maxLength = 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number | | Number of | | Number |
| | DMRS CDM | | of front- | | DMRS CDM | | of front- |
| | group(s) | DMRS | load | | group(s) | DMRS | load |
| Value | without data | port(s) | symbols | Value | without data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58-63 | Reserved | Reserved | Reserved | | | | |

TABLE 46
(Table 7.3.1.2.2-4A): Antenna port(s) (1000 + DMRS port), dmrs-Type =2 ,
maxLength = 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number | | Number of | | Number |
| | DMRS CDM | | of front- | | DMRS CDM | | of front- |
| | group(s) | DMRS | load | | group(s) | DMRS | load |
| Value | without data | port(s) | symbols | Value | without data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58 | 2 | 0, 2, 3 | 1 | | | | |
| 59-63 | Reserved | Reserved | Reserved | | | | |

It is assumed that dmrs-Type=1 and maxLength=2 are configured as DMRS configuration for any one PDSCH mapping type of a UE. In this case, the corresponding antenna port table is Table 42. The UE may receive a DCI format for scheduling the PDSCH of the PDSCH mapping type, and the DCI format may include an antenna port field. The antenna port field may indicate one row among 32 rows (value 0 to value 31) of Table 42. For reference, referring to Table 42, when only one codeword in a PDSCH is enabled, one of all 32 rows (value 0 to value 31) may be indicated. In case that two codewords are simultaneously enabled in the PDSCH, one of 4 rows (value 0 to value 3) among 32 rows may be indicated. In addition, other rows (value 3 to value 31) may not be indicated.

It is assumed that dmrs-Type=2 and maxLength=2 are configured as DMRS configuration for any one PUSCH mapping type of a UE. In this case, the corresponding antenna port table is one of Tables 34 to 37. Here, one antenna port table is determined according to rank. It is assumed that rank=3. In this case, Table 36 may be used as the antenna port table. The UE may receive a DCI format for scheduling the PUSCH of the PUSCH mapping type, and the DCI format may include an antenna port field. The antenna port field may indicate one row among 32 rows (value 0 to value 31) of Table 36. For reference, referring to Table 36, one of 6 rows (value 0 to value 5) among 32 rows may be indicated. In addition, other rows (value 6 to value 31) may not be indicated.

In a subsequent embodiment, at least one TDRA row of a TDRA table for a UE includes multiple pieces of scheduling information, one piece of scheduling information among the multiple pieces of scheduling information of the TDRA row includes mapping type A, and the other scheduling information includes mapping type B. That is, when receiving the indication of a TDRA row, the UE may receive (or transmit) a PDSCH (or PUSCH) of mapping type A according to one piece of scheduling information, and may receive (or transmit) a PDSCH (or PUSCH) of mapping type B according to the other scheduling information.

In a subsequent embodiment, for convenience of description, “a TDRA row including different mapping types” implies that a TDRA row includes multiple pieces of scheduling information, one piece of scheduling information among the multiple pieces of scheduling information includes mapping type A, and the other scheduling information includes both mapping type A and mapping type B.

A procedure of using UL PTRS will now be described.

A UE may configure phaseTrackingRS, which is a higher layer parameter for PTRS, on a higher layer parameter DMRS-UplinkConfig. When transmitting a PUSCH to a base station, the UE may transmit a PTRS for phase tracking a UL channel. The procedure for transmitting the UL PTRS by the UE may be determined according to whether or not transform precoding is performed during PUSCH transmission. When transform precoding is performed and a transformPrecoderEnabled area is configured in the higher layer parameter PTRS-UplinkConfig, sampleDensity in the transformPrecoderEnabled area may indicate sample density thresholds indicated by N_{RB0} to N_{RB4} in Table 47, below. When transform precoding is performed and the transformPrecoderEnabled area is configured in the higher layer parameter PTRS-UplinkConfig, the UE may determine a PTRS group pattern for the scheduled resource N_{RB} according to Table 47. Additionally, if the transform precoder is applied to PUSCH transmission, the number of bits of a PTRS-DMRS association field for indicating an association between PTRS and DMRS in DCI format 0_1 or 02 may be 0.

TABLE 47

| | | Number of |
|---|---|---|
| | Number of | samples per |
| Scheduled bandwidth | PT-RS groups | PT-RS group |
| N_{RB0} ≤ N_{RB} < N_{RB1} | 2 | 2 |
| N_{RB1} ≤ N_{RB} < N_{RB2} | 2 | 4 |
| N_{RB2} ≤ N_{RB} < N_{RB3} | 4 | 2 |
| N_{RB3} ≤ N_{RB} < N_{RB4} | 4 | 4 |
| N_{RB4} ≤ N_{RB} | 8 | 4 |

When transform precoding is not applied to PUSCH transmission and the higher layer parameter phaseTrackingRS is configured, the UE may indicate, in a transformPrecoderDisabled area of the higher layer parameter PTRS-UplinkConfig, N_{RB0} to N_{RB1} as frequencyDensity and ptrs-MCS₁ to ptrs-MCS₃ as timeDensity. As described in Tables 48-1 and 48-2, according to the MCS (I_{MCS}) and RB (N_{RB}) of the scheduled PUSCH, the UE may determine PTRS density in a time domain (L_{PT-RS}) and PTRS density (K_{PT-RS}) in a frequency domain. In Table 48-1, below, ptrs-MCS₄ is not specified as a higher layer parameter, but the base station and the UE may know that ptrs-MCS₄ is 29 or 28 according to the configured MCS table.

TABLE 48-1

| Scheduled MCS | Time Density (L_{PT-RS}) |
|---|---|
| I_{MCS} < ptrs-MCS₁ | PT-RS is not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

TABLE 48-2

| Scheduled bandwidth | Frequency density (K_{PT-RS}) |
|---|---|
| N_{RB} < N_{RB0} | PT-RS is not present |
| N_{RB0} ≤ NRB < N_{RB1} | 2 |
| N_{RB1} ≤ NRB | 4 |

If transform precoder is not applied to PUSCH transmission and PTRS-UplinkConfig is configured, the base station may indicate a 2-bit “PTRS-DMRS association” area to the UE to indicate association between PTRS and DMRS in DCI format 0_1 or 0_2. The indicated 2-bit PTRS-DMRS association field may be applied to Table 49-1 or Table 49-2, below, according to the maximum number of PTRS ports configured as maxNrofPorts in the higher layer parameter PTRS-UplinkConfig. If the maximum number of PTRS ports is 1, the UE may determine the association between the PTRS and DMRS as 2 bits indicated in Table 49-1 and the PTRS-DMRS association field, and transmit the PTRS according to the determined association. If the maximum number of PTRS ports is 2, the UE may determine the association between the PTRS and DMRS as 2 bits indicated in Table 49-2 and the PTRS-DMRS association field, and may transmit PTRS according to the determined association.

TABLE 49-1

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

TABLE 49-2

| Value of | | Value of | |
|---|---|---|---|
| MSB | DMRS port | LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

The DMRS ports in Table 49-1 and Table 49-2 may be determined through a table determined by the “antenna ports field indicated by the DCI indicating the PTRS-DMRS association and the higher layer parameter configuration. In case that the transform precoder is not configured as the higher layer configuration of PUSCH, dmrs-Type is configured as 1 and maxLength is configured as 2 with respect to DMRS, and the rank of PUSCH is 2, the UE may determine a DMRS port through the table for “antenna port(s)” as shown in Table 50, below, and bits indicated through the antenna port area. In the case of supporting non codebook-based PUSCH, the UE may determine the rank value by referring to an SRI region indicated by the DCI including the “antenna ports” field (for example, if the SRI region does not exist, rank may be considered as 1). If the rank supports the codebook-based PUSCH, the UE may determine the rank value by referring to the TPMI region indicated by the DCI including the “antenna ports” field. Table 50 is an example of the antenna port table referred to when configuring the PUSCH described above, but is not limited thereto, and when the PUSCH is configured with other parameters, the DMRS port may be determined according to the “antenna port” table according to the configuration and bits of the “antenna ports” field indicated by DCI.

TABLE 50

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

The 1^{st} scheduled DMRS to 4^{th} scheduled DMRS in Table 49-1 may be defined as values obtained by sequentially mapping the bits of the “antenna ports” field of DCI and the DMRS ports indicated through the “antenna port” table according to the higher layer configuration. For example, in case that the bits of the “antenna ports” field of the DCI are 0001 and the DMRS port is determined by referring to Table 50, the scheduled DMRS ports may be 0 and 1, DMRS port 0 may be defined as 1^{st} scheduled DMRS, and DMRS port 1 may be defined as 2^{nd} scheduled DMRS. The DMRS port determined by referring to the “antenna port” table according to another higher layer configuration and the bits of another “antenna ports” field may be similarly applied. The UE may determine one DMRS port among the DMRS ports defined above, the one DMRS port being associated with the PTRS port by referring to the bit indicated by the PTRS-DMRS association in the DCI, and may transmit the PTRS according to the determined DMRS port.

In Table 49-2, a DMRS port that shares PTRS port 0 and a DMRS port that shares PTRS port 1 may be defined according to codebook-based PUSCH transmission or non-codebook-based PUSCH transmission. When a UE transmits PUSCH based on partial-coherent or non-coherent codebook, UL layers transmitted through PUSCH antenna ports 1000 and 1002 may be associated with PTRS port 0, and UL layers transmitted through PUSCH antenna ports 1001 and 1003 may be associated with PTRS port 1. More specifically, when layer 3: TPMI=2 is selected for codebook-based PUSCH transmission, a first layer may be associated with PTRS port 0 because the first layer is transmitted to PUSCH antenna ports 1000 and 1002, a second layer may be transmitted through the PUSCH antenna port 1001, a third layer is transmitted through PUSCH antenna port 1002, and thus the second and third layers may be associated with PTRS port 1. Each of the three layers may imply a DMRS port. The DMRS port for the first layer may correspond to “1s DMRS port which shares PTRS port 0” in Table 49-2, the DMRS port for the second layer may correspond to “1^{st} DMRS port which shares PTRS port 1” in Table 49-2, and the DMRS port for the third layer may correspond to “2^{nd} DMRS port which shares PTRS port 1” in Table 49-2. Similarly, the DMRS port associated with PTRS port 0 and the DMRS port associated with PTRS port 1 may be determined according to different numbers of layers and TPMI. In case that a UE transmits a PUSCH based on a non-codebook, a DMRS port associated with PTRS port 0 and a DMRS port associated with PTRS port 1 may be distinguished according to antenna ports and SRI indicated by DCI. More specifically, whether an SRS resource, which is included in an SRS resource set and for which usage is “nonCodebook”, is associated with PTRS port 0 or PTRS port 1 may be configured through the higher layer parameter ptrs-PortIndex. The base station may indicate, using an SRI, an SRS resource for non-codebook based PUSCH transmission. Ports of indicated SRS resources may be mapped one-to-one to the respective PUSCH DMRS ports. The association between the PUSCH DMRS port and the PTRS port may be determined according to the higher layer parameter ptrs-PortIndex of the SRS resource mapped to the DMRS port. More specifically, in case that ptrs-PortIndex of SRS resources 1 to 4 included in the SRS resource set for which usage is nonCodebook are configured as n0, n0, n1, n1, respectively, the PUSCH is indicated, using an SRI, to be transmitted through SRS resources 1, 2, and 4, and DMRS ports 0, 1, and 2 are indicated as the antenna ports field, the ports of SRS resources 1, 2, and 4 may be mapped to DMRS ports 0, 1, and 2, respectively. In addition, according to the ptrs-PortIndex in the SRS resource, DMRS ports 0 and 1 may have an association with PTRS port 0, and DMRS port 2 may have an association with PTRS port 1. Therefore, in Table 49-2, DMRS port 0 may correspond to “1^{st} DMRS port which shares PTRS port 0”, DMRS port 1 may correspond to “2nd DMRS port which shares PTRS port 0”, and DMRS port 2 may correspond to “1st DMRS port which shares PTRS port 1”. Similarly, the DMRS port associated with PTRS port 0 and the DMRS port associated with PTRS port 1 may be determined according to a different SRI value and a method of configuring ptrs-PortIndex in an SRS resource of a different pattern. The UE may determine an association between the DMRS port and the PTRS port as above with regard to the two PTRS ports. The UE may determine a DMRS port to be associated with PTRS port 0 by referring to an MSB bit of the PTRS-DMRS association among multiple DMRS ports associated with the respective PTRS ports. The UE may transmit PTRS by determining a DMRS port to be associated with PTRS port 1 by referring to an LSB bit.

Multi-PDSCH/PUSCH scheduling will now be described.

A new scheduling method has been introduced in Rel-17 NR of the 3GPP. The disclosure relates to the new scheduling method. The new scheduling method introduced in Rel-17 NR is “Multi-PDSCH scheduling” by which one DCI may schedule one or multiple PDSCHs and “Multi-PUSCH scheduling” by which one DCI may schedule one or multiple PUSCHs. Here, in multiple PDSCHs or multiple PUSCHs, each PDSCH or PUSCH transmits a different transport block (TB). Since a base station does not schedule multiple pieces of DCI for scheduling each of multiple PDSCHs or multiple PUSCHs in a UE, by using the multi-PDSCH scheduling and the multi-PUSCH scheduling, overhead of a DL control channel may be reduced. However, since one piece of DCI for the multi-PDSCH scheduling and multi-PUSCH scheduling should include scheduling information for multiple PDSCHs or multiple PUSCHs, the size of the DCI may be increased. To this end, a method for preferably interpreting DCI by a UE, when multi-PDSCH scheduling and multi-PUSCH scheduling are configured for the UE, is required.

Although multi-PDSCH scheduling is described in this disclosure, embodiments using the technology proposed in this disclosure may be used in multi-PUSCH scheduling.

A base station may configure multi-PDSCH scheduling for a UE. The base station may explicitly configure multi-PDSCH scheduling for the UE via a higher layer signal (e.g., an RRC signal). In addition, the base station may implicitly configure multi-PDSCH scheduling via a higher layer signal (e.g., an RRC signal) in the UE.

The base station may configure a TDRA table via a higher layer signal (e.g., an RRC signal) as follows, to perform multi-PDSCH scheduling to the UE. The TDRA table may include one or multiple rows. The number of rows may be configured up to N_row, and each row may be assigned an intrinsic index. The intrinsic index may be the value of one of 1, 2, . . . , N_row. Here, N_row may be 64, but is not limited thereto. One or multiple pieces of scheduling information may be configured for each row. Here, when one piece of scheduling information is configured in one row, the row schedules one PDSCH. That is, when the row is indicated, this may represent that single-PDSCH scheduling has been indicated. If multiple pieces of scheduling information are configured in one row, the multiple pieces of scheduling information sequentially schedule multiple PDSCHs. That is, when the row is indicated, this may represent that multi-PDSCH scheduling has been indicated.

The scheduling information may include at least one of a K0, SLIV, and PDSCH mapping type. That is, when multi-PDSCH scheduling is indicated, a row may include multiple pieces of scheduling information (a K0, SLIV, PDSCH mapping type). Among the multiple pieces of scheduling information, N_th scheduling information (a K0, SLIV, PDSCH mapping type) is scheduling information of the N_th PDSCH. For reference, one row may include up to N_pdsch pieces of scheduling information (a K0, SLIV, PDSCH mapping type). Here, N_pdsch may be 8, but is not limited thereto. For example, one row may schedule up to 8 PDSCHs.

Here, K0 indicates a slot in which a PDSCH is scheduled, and represents a slot difference between a slot in which a PDCCH that transmits DCI scheduling the PDSCH is received and a slot in which the PDSCH is scheduled. That is, if K0=0, PDSCH and PDCCH are the same slot. A starting and length indicator value (SLIV) represents an index of a symbol in which a PDSCH starts within one slot and the number of consecutive symbols to which the PDSCH is allocated. The PDSCH mapping type indicates information related to the location of a first DMRS (a front-loaded DMRS) of the PDSCH. In the case of PDSCH mapping type A, the first DMRS (a front-loaded DMRS) of the PDSCH starts from the 3rd symbol to the 4th symbol of a slot, and in the case of PDSCH mapping type B, the first DMRS (a front-loaded DMRS) of the PDSCH starts from the first symbol of symbols for which the PDSCH has been scheduled.

When configuring a row of the TDRA table via the higher layer signal, some of the K0, SLIV, and PDSCH mapping types of scheduling information may be omitted. In this case, omitted information may be interpreted as a default value or a preconfigured value. For example, when K0 is omitted, the value of K0 may be interpreted as 0. In addition, when configuring a row of the TDRA table, information other than the K0, SLIV, and PDSCH mapping type may be additionally configured.

In the following description, multi-PDSCH scheduling is configured for a UE. Here, multi-PDSCH scheduling configuration implies that multiple pieces of scheduling information are configured in at least one row of the TDRA table. For reference, one piece of scheduling information may be configured in another row of the TDRA table. Therefore, even if multi-PDSCH scheduling is configured for the UE, the UE may be indicated to perform single-PDSCH scheduling or multi-PDSCH scheduling according to a TDRA field of the received DCI. In other words, the multi-PDSCH scheduling indication corresponds to a case in which a row of the TDRA table, which is received by the UE through the DCI, includes multiple pieces of scheduling information, and the single-PDSCH scheduling indication corresponds to a case in which a row of the TDRA table, which is received by the UE through the DCI, includes one piece of scheduling information.

In the case of a single-PDSCH scheduling indication, one PDSCH is scheduled, and the one PDSCH requires information such as an MCS, a new data indicator (NDI), a redundancy version (RV), and a HARQ process number (HPN). To this end, the DCI indicating scheduling of the single-PDSCH should include information such as MCS, NDI, RV, and HPN for the one PDSCH. More specifically, the following DCI are proposed:
DCI indicating scheduling of a single-PDSCH may include one MCS field. The MCS indicated in the MCS field (i.e., a modulation scheme and code rate of a channel code) may be applied to one PDSCH scheduled by the DCI.
DCI indicating scheduling of single-PDSCH may include a 1-bit NDI field. An NDI value may be obtained from the 1-bit NDI field, and based on the NDI value, a determination as to whether one PDSCH transmits a new transport block or retransmits a previous transport block may be made.
DCI indicating scheduling of single-PDSCH may include a 2-bit RV field. An RV value may be obtained from the 2-bit RV field, and a redundancy version of one PDSCH may be determined based on the RV value.
DCI scheduling single-PDSCH may include one HPN field. The one HPN field may be 4 bits. (For reference, when a UE supports up to 32 HARQ processes, the HPN field is extended to 5 bits, but the HPN field is assumed to be 4 bits for convenience of explanation of the disclosure). One HARQ process ID may be indicated through the one HPN field. The one HARQ process ID may be a HARQ process ID of one scheduled PDSCH.

When multi-PDSCH scheduling is indicated, since multiple PDSCHs are scheduled, each PDSCH requires information such as MCS, NDI, RV, and HPN. To this end, DCI indicating multi-PDSCH scheduling should include information such as MCS, NDI, RV, and HPN for each scheduled PDSCH. More specifically, the following DCI are proposed:
DC indicating multi-PDSCH scheduling may include one MCS field. The MCS indicated in the MCS field (for example, a modulation scheme and a code rate of a channel code) may be equally applied to all PDSCHs scheduled by the DCI. That is, DCI for multi-PDSCH scheduling is unable to schedule different PDSCHs by using different MCSs.
DCI indicating multi-PDSCH scheduling may include a K-bit NDI field. Here, K may be the largest value among the numbers of scheduling information included in respective rows of the TDRA table. For example, in case that the TDRA table includes two rows, the first row includes 4 pieces of scheduling information, and the second row includes 8 pieces of scheduling information, the value of K (for example, K=8) may be obtained. The k-th bit of the K-bit NDI field may indicate an NDI value of a PDSCH corresponding to the k-th scheduling information. That is, the k-th PDSCH may obtain an NDI value from the k-th bit of the K-bit NDI field, and based on the NDI value, a determination as to whether the k-th PDSCH transmits a new transport block or retransmits a previous transport block may be made.
DCI indicating multi-PDSCH scheduling may include a K-bit RV field. The k-th bit of the K-bit RV field may indicate the RV value of the PDSCH corresponding to the k-th scheduling information. That is, the k-th PDSCH may obtain an RV value from the k-th bit of the K-bit RV field, and may determine the redundancy version of the k-th PDSCH based on the RV value.
DCI indicating multi-PDSCH scheduling may include one HPN field. The one HPN field may be 4 bits. (For reference, if a UE supports up to 32 HARQ processes, the HPN field may be extended to 5 bits, however, as described herein, it is assumed to be 4 bits for convenience of explanation). One HARQ process ID may be indicated through the one HPN field. The one HARQ process ID may be the HARQ process ID of the first PDSCH among PDSCHs scheduled by the DCI indicating multi-PDSCH scheduling. Here, the first PDSCH corresponds to the first scheduling information. Then, the HPNs of the PDSCHs are sequentially increased by 1. That is, in the case of the second PDSCH (corresponding to the second scheduling information), the HPN is a value obtained by increasing the HARQ process ID of the first PDSCH by 1. For reference, if the HARQ process ID exceeds the maximum number of HARQ process IDs (numOfHARQProcess/D) configured in a UE, a modulo calculation is performed. In other words, when the HARQ process ID indicated by the DCI is “x”, the HARQ process ID of the kth PDSCH is determined according to Equation 2, below.

HPN of the kth PDSCH=(x+k−1) modulo numOfHARQPRocessID Equation 2

As described above, when single-PDSCH scheduling is indicated, DCI includes a 1-bit NDI field or a 2-bit RV field, and when multi-PDSCH scheduling is indicated, DCI includes a K-bit NDI field or includes K-bit RV field. For reference, the single-PDSCH scheduling indication or the multi-PDSCH scheduling indication is indicated in the TDRA field of the DCI (that is, whether it is a single-PDSCH scheduling indication or a multi-PDSCH scheduling indication is determined according to the number of scheduling information included in the row of the indicated TDRA field). Therefore, one DCI should support both single-PDSCH scheduling and multi-PDSCH scheduling. If the length of the DCI for the single-PDSCH scheduling indication and the length of the DCI for the multi-PDSCH scheduling indication are different from each other, “0” may be padded to the DCI of the shorter length to have the same length.

A DCI interpretation procedure of a UE is as follows. The UE receives DCI. In this case, the length of DCI may be assumed to be a larger value among the length of DCI for single-PDSCH scheduling indication and the length of DCI for multi-PDSCH scheduling indication. The UE may know the location of the TDRA field in the DCI. The location of the TDRA field may be the same in the DCI for single-PDSCH scheduling indication and the DCI for multi-PDSCH scheduling indication. The UE may determine whether the received DCI is DCI for single-PDSCH scheduling indication or DCI for multi-PDSCH scheduling indication through the TDRA field. When the number of scheduling information included in the indicated row of the TDRA field is one, the UE may determine the DC for the single-PDSCH scheduling indication, and if the number of scheduling information included in the row of the TDRA field is two or more, the UE may determine the DCI for the multi-PDSCH scheduling indication. When the UE determines DCI as the single-PDSCH scheduling indication, the DCI may be interpreted according to the determination. That is, the DCI may be interpreted such that the NDI field is 1 bit and the RV field is 2 bits. When the UE determines DCI as the multi-PDSCH scheduling indication, the DCI may be interpreted according to the determination. That is, the DCI may be interpreted such that the NDI field is K bits and the RV field is K bits. For reference, locations of other fields in the DCI may differ according to the lengths of the NDI field or the RV field. Therefore, other fields may have the same bit length but have different locations within the DCI according to whether they are single-PDSCH scheduling indication or multi-PDSCH scheduling indication.

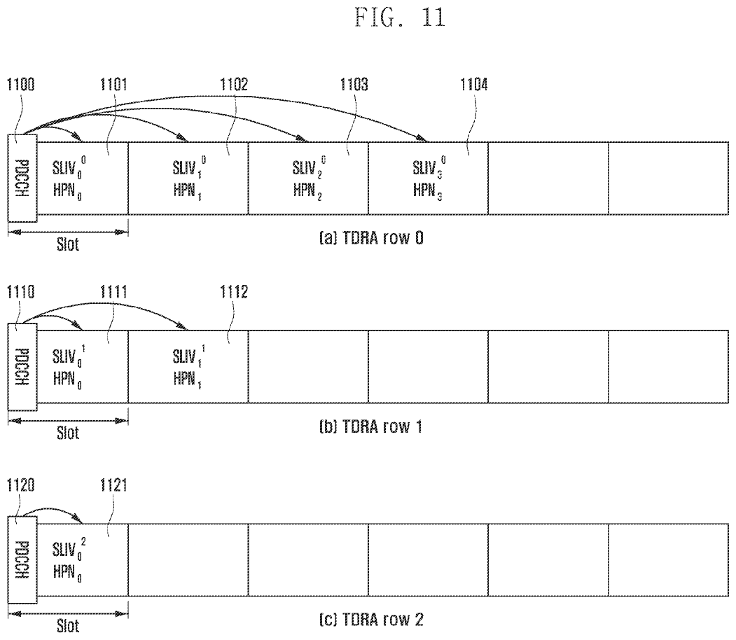

FIG. 11 illustrates a PDSCH scheduling scheme, according to an embodiment.

The first row (row 0) of a TDRA table includes four of scheduling information (for example, K0, SLIV, and/or a PDSCH mapping type). Here, the first SLIV is called SLIV⁰₀, the second SLIV is called SLIV⁰₁, the third SLIV is called SLIV⁰₂, and the fourth SLIV is SLIV⁰₃. Accordingly, when receiving an indication of the first row (row 0) of the TDRA table, a UE may determine that multi-PDSCH scheduling is indicated.

The second row (row 1) of the TDRA table includes two scheduling information (for example, K0, SLIV, and/or a PDSCH mapping type). Here, the first SLIV is called SLIV¹₀ and the second SLIV is called SLIV¹₁. Therefore, when the UE receives an indication of the second row (row 1) of the TDRA table, it may be determined that multi-PDSCH scheduling is indicated.

The third row (row 2) of the TDRA table includes one piece of scheduling information (for example, K0, SLIV, and/or a PDSCH mapping type). Here, SLIV is referred to as SLIV²₀. Therefore, when the UE receives an indication of the third row (row 2) of the TDRA table, it may be determined that single-PDSCH scheduling is indicated.

(a) of FIG. 11 illustrates a case in which a UE receives an indication of the first row (row 0) of the TDRA table. A TDRA field of DCI received by the UE on a PDCCH 1100 may indicate the first row (row 0) of the TDRA table. Accordingly, the UE may receive four PDSCHs based on four scheduling information (for example, K0, SLIV, and/or a PDSCH mapping type) of the first row (row 0). The UE may determine symbols for reception of a first PDSCH 1101 based on SLIV⁰₀, which is the first SLIV, may determine symbols for reception of a second PDSCH 1102 based on SLIV⁰₁, which is the second SLIV, may determine symbols for reception of a third PDSCH 1103 based on SLIV⁰₂, which is the third SLIV, and may determine symbols for reception of a fourth PDSCH 1104 based on SLIV® 3, which is the fourth SLIV. Each of the four PDSCHs may have an intrinsic HARQ process ID. That is, the first PDSCH may have HPN₀ as the HARQ process ID, the second PDSCH may have HPN₁ as the HARQ process ID, the third PDSCH may have HPN₂ as the HARQ process ID, and the fourth PDSCH may have HPN₃ as the HARQ process ID. Here, an HPN field of DCI may indicate the HARQ process ID of the first PDSCH, and the HARQ process ID of the remaining PDSCHs may be determined based on the HARQ process ID of the first PDSCH. For example, HPN₀=0 may be indicated as the HARQ process ID of the first PDSCH through DCI. In this case, HPN₁=1 may be indicated as the HARQ process ID of the second PDSCH, HPN₁=2 may be indicated as the HARQ process ID of the third PDSCH, and HPN₁=3 may be indicated as the HARQ process ID of the fourth PDSCH.

(b) of FIG. 11 illustrates a case in which a UE receives an indication of the second row (row 1) of the TDRA table. A TDRA field of DC received by the UE on a PDCCH 1110 may indicate the second row (row 1) of the TDRA table. Accordingly, the UE may receive two PDSCHs based on two scheduling information (for example, K0, SLIV, and/or a PDSCH mapping type) of the second row (row 1). The UE may determine symbols for reception of a first PDSCH 1111 based on SLIV¹₀ which is the first SLIV, and may determine symbols for reception of a second PDSCH 1112 based on SLIV¹₁, which is the second SLIV. Each of the two PDSCHs may have an intrinsic HARQ process ID. That is, the first PDSCH may have HPN₀ as the HARQ process ID, and the second PDSCH may have HPN₁ as the HARQ process ID. Here, an HPN field of DCI may indicate the HARQ process ID of the first PDSCH, and the HARQ process ID of the remaining PDSCHs may be determined based on the HARQ process ID of the first PDSCH. For example, HPN₀=0 may be indicated as the HARQ process ID of the first PDSCH through DCI. In this case, HPN₁=1 may be indicated as the HARQ process ID of the second PDSCH.

(c) of FIG. 11 illustrates a case in which a UE receives an indication of the second row (row 1) of the TDRA table. A TDRA field of DCI received by the UE on a PDCCH 1120 may indicate the third row (row 2) of the TDRA table. Accordingly, the UE may receive one PDSCH based on one piece of scheduling information (for example, K0, SLIV, and/or a PDSCH mapping type) of the third row (row 2). The UE may determine symbols for reception of one PDSCH 1121 based on SLIV²₀ which is a single SLIV. The HARQ process ID of one PDSCH, that is, HPN₀ is indicated through DCI. For example, the HPN field of the DCI may indicate HPN₀=0 as the HARQ process ID of the first PDSCH.

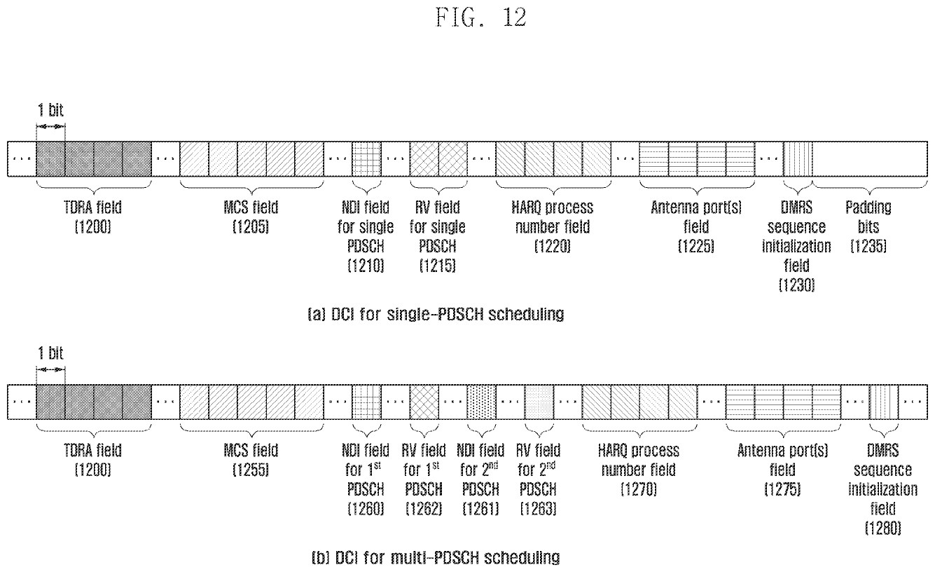

FIG. 12 illustrates DCI for single-PDSCH scheduling and multi-PDSCH scheduling, according to an embodiment.

Referring to (a) of FIG. 12 and (b) of FIG. 12, a UE may determine the location of a TDRA field 1200 in received DCI. The location of the TDRA field of DCI for single-PDSCH scheduling is the same as that of DCI for multi-PDSCH scheduling. The UE may determine whether the received DCI is DCI indicating single-PDSCH scheduling or DCI indicating multi-PDSCH scheduling based on a value of the TDRA field.

In case that a row corresponding to the value of the TDRA field of the received DCI includes one piece of scheduling information (for example, K0, SLIV, and/or a PDSCH mapping type) (e.g., the third row (row 2) of the TDRA table), the UE construes the case as DCI for single-PDSCH scheduling as shown in (a) of FIG. 12.

Referring to (a) of FIG. 12, the DCI for single-PDSCH scheduling may include a 5-bit MCS field 1205, a 1-bit NDI field 1210, a 2-bit RV field 1215, and a 4-bits HARQ field 1220. In addition, the DCI for single-PDSCH scheduling may further include fields other than the fields described above. For example, the DCI may further include an antenna port(s) field 1225 or a DMRS sequence initialization field 1230. In addition, when the DCI for single-PDSCH scheduling is shorter than the DCI for multi-PDSCH scheduling, padding bits 1235 may be further included therein.

In case that a row corresponding to the value of a TDRA field of the received DCI includes two or more scheduling information (for example, K0, SLIV, and/or a PDSCH mapping type) (e.g., the first row (row 0) to the second row (row 1) of the TDRA table), the UE construes the case as DCI for multi-PDSCH scheduling as shown in (b) of FIG. 12. Referring to (b) of FIG. 12, the DCI for multi-PDSCH scheduling may include a 5-bit MCS field 1255, K-bit NDI fields 1260 and 1261, K-bit RV fields 1262 and 1263, and a 4-bit HARQ field 1270. In addition, the DCI for multi-PDSCH scheduling may further include fields other than the fields described above. For example, the DCI may further include an antenna port(s) field 1275 to a DMRS sequence initialization field 1280. For reference, (b) of FIG. 12 illustrates DCI in which up to two PDSCHs are scheduled. Here, the 2-bit NDI fields 1260 and 1261 are shown as separated, but may be integrated as one 2-bit NDI field. In addition, in (b) of FIG. 12, the 2-bit RV fields 1262 and 1263 are shown as separated, but may be integrated as one 2-bit RV field. For reference, referring to (a) of FIGS. 12 and (b) of FIG. 12, assuming that the length of DCI indicating single-PDSCH scheduling is shorter than the length of DCI indicating multi-PDSCH scheduling, the padding bits 1235 are added to DCI for single-PDSCH scheduling. If the length of the DCI indicating single-PDSCH scheduling is longer than the length of the DCI indicating multi-PDSCH scheduling, the padding bits may be added to the DCI indicating multi-PDSCH scheduling.

Hereafter, unless otherwise specified, PDSCH assumes transmission of a single codeword. If transmission of two codewords is configured for the UE, fields of the DCI are for the first codeword unless otherwise specified.

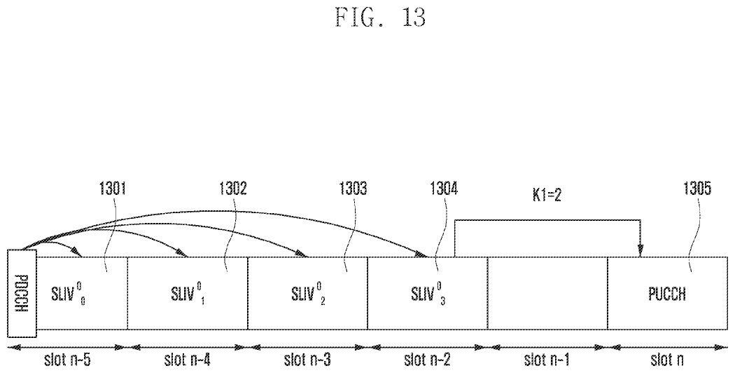

FIG. 13 illustrates a HARQ-ACK transmission of one or multiple PDSCHs scheduled by DCI when the DCI indicates multi-PDSCH scheduling, according to an embodiment.

A base station may configure one or multiple K1 value(s) for a UE. The one or multiple K1 value(s) may be called a K1 set. DCI indicating multi-PDSCH scheduling may include an indicator indicating one K1 value in the K1 set. More specifically, the DCI may include a PDSCH-to-HARQ_feedback timing indicator field of up to 3 bits. The field may indicate one K1 value in the K1 set.

The UE may determine a slot for transmission of HARQ-ACK of multiple PDSCHs based on one K1 value and a slot in which the last PDSCH of the multiple PDSCHs is scheduled. For reference, HARQ-ACKs of all PDSCHs scheduled by one DCI may be transmitted through one PUCCH in a slot for transmission of the HARQ-ACK. A slot located after K1 slots from the slot in which the last PDSCH is scheduled is a slot for transmission of HARQ-ACKs of multiple PDSCHs. That is, PUCCHs including HARQ-ACKs of multiple PDSCHs may be transmitted in a slot after K1 slots from the slot in which the last PDSCH is scheduled.

Referring to FIG. 13, assuming that DCI received by a UE on a PDCCH 1300 indicates row 0 of the TDRA table as shown in FIG. 12, and according to row 0 of the TDRA table, PDSCHs are scheduled in slot n-5, slot n-4, slot n-3, and slot n-2. In addition, assuming that the UE receives an indication of the value of K1 as 2, the UE may determine, as a slot for transmission of the HARQ-ACK, slot n located after two slots, the value of K1, from slot n-2 which is the last slot in which the PDSCH is scheduled. That is, the UE may transmit, through a PUCCH 1305 of the slot n, HARQ-ACK information of a PDSCH 1301 of slot n-5, a PDSCH 1302 of slot n-4, a PDSCH 1303 of slot n-3, and a PDSCH 1304 of slot n-2.

Multi-cell multi-PDSCH/PUSCH scheduling will now be described.

A new scheduling method has been introduced in the Rel-18 NR of the 3GPP. In the aforementioned multi-PDSCH/PUSCH scheduling, one DCI schedules one or multiple PDSCHs or PUSCHs in one cell. As a new scheduling method of Rel-18 NR, one DCI may schedule PDSCH or PUSCH in one or each of multiple cells. This scheduling method may be referred to as multi-cell multi-PDSCH/PUSCH scheduling.

A UE may receive an indication for cells in which PDSCH or PUSCH is scheduled through one DCI. For example, one DCI may include an indication for cell A and cell B. In addition, the UE may receive an indication of scheduling information of the cell A (for example, a K0/SLIV/PDSCH mapping type in the case of PDSCH, or a K2/SLIV/PUSCH mapping type in the case of PUSCH) and scheduling information of the cell B. The UE may receive the PDSCH or transmit the PUSCH based on the scheduling information indicated by the cell A and cell B.

Here, the scheduling information of each cell may include an indication of different mapping types.

Hereafter, the disclosure is described based on multi-PDSCH/PUSCH scheduling, but the same disclosure may be applied to multi-cell multi-PDSCH/PUSCH scheduling.

Hereinafter, in the disclosure, a problem in which multiple PDSCHs or PUSCHs of multi-PDSCH/PUSCH scheduling may have different mapping types and different antenna port tables are applied to respective mapping types will be described. Equally, in multi-cell multi-PDSCH/PUSCH scheduling, PDSCHs or PUSCHs of multiple cells may have different mapping types. Therefore, a problem in which different antenna port tables are applied to each mapping type may occur. Furthermore, in multi-cell multi-PDSCH/PUSCH scheduling, even if PDSCH to PUSCH of different cells have the same mapping type, different antenna port tables may be applied according to the scheduled cell. Therefore, although the problem of different antenna port tables according to different mapping types will be described later, this may be extended to the problem of different antenna port tables according to different cells.

According to multi-PDSCH scheduling and multi-PUSCH scheduling configurations, a UE may receive multiple pieces of scheduling information configured in one TDRA row, and each of the multiple pieces of scheduling information may include a SLIV and a mapping type. Accordingly, a UE may be configured to receive an indication of a TDRA row including pieces of scheduling information having different mapping types through one DCI.

Different pieces of DMRS configuration information may be configured for different mapping types. In case that the DMRS configuration information is different, a different antenna port table for DMRS port indication may be configured. DCI format for scheduling PDSCH to PUSCH includes an antenna port field for indicating one row in an antenna port table. However, as mentioned above, the antenna port field of the DCI format may be used to indicate one row of one antenna port table. However, when a TDRA row having multiple pieces of scheduling information of different mapping types is indicated to a UE, the UE should receive an indication of one row in each of the two antenna port tables. A method for achieving this will be described below.

An introduction of restriction on DMRS configuration is described below.

According to an embodiment of the disclosure, a UE may expect that mapping type A and mapping type B use the same antenna port table. Here, in order to use the same antenna port table, the UE may receive the same DMRS type (dmrs-Type) and DMRS maximum length (maxLength) configured via a higher layer. The base station may configure the same DMRS type (dmrs-Type) and maximum DMRS length (maxLength) for the UE.

When a TDRA table including a TDRA row including different mapping types is configured, the UE may expect that mapping type A and mapping type B use the same antenna port table. That is, when a TDRA table including a TDRA row including different mapping types is configured, the UE may expect that the DMRS type (dmrs-Type) and the maximum DMRS length (maxLength) of mapping type A and mapping type B are the same.

When a base station is to configure a TDRA table including a TDRA row including different mapping types for a UE, the base station should configure the TDRA table for the UE so that mapping type A and mapping type B use the same antenna port table. That is, when the base station is to configure a TDRA table including a TDRA row including different mapping types for the UE, the base station should configure DMRS types (dmrs-Type) and DMRS maximum lengths (maxLength) of mapping type A and mapping type B to be the same for the UE.

When a TDRA table that does not include a TDRA row including different mapping types is configured, the UE may have an antenna port table of mapping type A and mapping type B being the same or different. That is, when a TDRA table that does not include a TDRA row including different mapping types is configured, the UE may expect that the DMRS types (dmrs-Type) and maximum DMRS lengths (maxLength) of mapping type A and mapping type B are the same or different. In other words, when a TDRA table that does not include a TDRA row including different mapping types is configured in the UE, there is no configuration restriction on the DMRS type (dmrs-Type) and maximum DMRS length (maxLength) of mapping type A and mapping type B.

When a base station is to configure a TDRA table that does not include a TDRA row including different mapping types for a UE, the base station may configure a TDRA table for the UE so that mapping type A and mapping type B use the same or different antenna port tables. That is, when the base station is to configure a TDRA table that does not include a TDRA row including different mapping types for the UE, the base station may configure DMRS types (dmrs-Type) and DMRS maximum lengths (maxLength) of mapping type A and mapping type B to be the same or different for the UE. In other words, when the base station is to configure a TDRA table that does not include a TDRA row including different mapping types for the UE, the base station may configure for the UE the DMRS types (dmrs-Type) and maximum DMRS lengths (maxLength) of mapping type A and mapping type B without configuration restrictions thereon.

Accordingly, when at least one row in a TDRA table configured for the UE corresponds to a TDRA row including different mapping types, the DMRS types (dmrs-Type) and the maximum DMRS lengths (maxLength) of mapping type A and mapping type B should be the same. This also affects other TDRA rows in the TDRA table.

For example, assuming that a first TDRA row includes scheduling information of mapping type A and a second TDRA row includes scheduling information of mapping type B in the TDRA table. In the existing operation (when an operation is not performed), a base station could configure different DMRS types (dmrs-Type) or DMRS maximum lengths (maxLength) for mapping type A and mapping type B in a UE. Accordingly, the PDSCH (or PUSCH) scheduled in the first TDRA row and the PDSCH (or PUSCH) scheduled in the second TDRA row could have a DMRS of different DMRS types (dmrs-Type) or DMRS maximum lengths (maxLength). However, in the embodiment described above, the PDSCH (or PUSCH) scheduled in the first TDRA row and the PDSCH (or PUSCH) scheduled in the second TDRA row always has a DMRS of the same DMRS type (dmrs-Type) or DMRS maximum length (maxLength). This may make it difficult for the base station to configure DMRS suitable for a mapping type.

In order to solve this problem, the following embodiment may be considered.

A UE may additionally receive DMRS configuration only for a TDRA row including different mapping types via a higher layer signal (e.g., an RRC signal). The DMRS configuration may include at least a DMRS type (dmrs-Type) and a maximum DMRS length (maxLength). The UE may receive three DMRS configurations as follows.
1st DMRS configuration: DMRS configuration for a TDRA row including only scheduling information of mapping type A
2nd DMRS configuration: DMRS configuration for a TDRA row including only scheduling information of mapping type B
3rd DMRS configuration: DMRS configuration for a TDRA row including scheduling information of mapping type A and scheduling information of mapping type B

For reference, the 1st DMRS configuration may be a DMRS configuration configured in mapping type A (“dmrs-DownlinkForPDSCH-MappingTypeA” in the case of PDSCH mapping type A, “dmrs-UplinkForPUSCH-MappingTypeA” in the case of PUSCH mapping type A), the 2nd DMRS configuration may be DMRS configuration configured in mapping type B (“dmrs-DownlinkForPDSCH-MappingTypeB” in the case of PDSCH mapping type B, “dmrs-UplinkForPUSCH-MappingTypeB” in the case of PUSCH mapping type B), and the 3rd DMRS configuration may be DMRS configuration which is newly configured.

Upon receiving the DCI format, the UE may perform the following operation.

The UE may obtain an index of a TDRA row from a TDRA field of a received DCI format. The UE may obtain scheduling information included in a TDRA row and a mapping type of the scheduling information.

In case that the TDRA row includes only scheduling information of mapping type A, the UE may assume a 1st DMRS configuration. Therefore, the UE may determine a DMRS type (dmrs-Type) or a maximum DMRS length (maxLength) according to the 1st DMRS configuration, and may use an antenna port table according to the DMRS type (dmrs-Type) or the maximum DMRS length (maxLength).

When the TDRA row includes only scheduling information of mapping type B, the UE may assume a 2nd DMRS configuration. Therefore, the UE may determine a DMRS type (dmrs-Type) or a maximum DMRS length (maxLength) according to the 2nd DMRS configuration, and may use an antenna port table according to the DMRS type (dmrs-Type) or the maximum DMRS length (maxLength).

When the TDRA row includes scheduling information of mapping type A and scheduling information of mapping type B, the UE may assume a 3rd DMRS configuration. Therefore, the UE may determine a DMRS type (dmrs-Type) or a maximum DMRS length (maxLength) according to the 3rd DMRS configuration, and may use an antenna port table according to the DMRS type (dmrs-Type) or the maximum DMRS length (maxLength). Here, mapping type A and mapping type B scheduled in the TDRA row use the same antenna port table. Accordingly, DMRS configuration for mapping type A and mapping type B may have the same DMRS port(s), the same number of DMRS symbols, and the same number of CDM groups without data. However, the location of the actually transmitted DMRS may be determined differently according to mapping type A and mapping type B.

The UE may interpret an antenna port field based on the antenna port table.

The method of interpreting the antenna port field is as follows.

When the number of rows of the antenna port table corresponding to the 1st DMRS configuration is N₁, the number of necessary bits is X₁ (X₁=ceil(log₂(N₁))).

When the number of rows of the antenna port table corresponding to the 2nd DMRS configuration is N₂, the number of necessary bits is X₂ (X₂=ceil(log₂(N₂))).

When the number of rows of the antenna port table corresponding to the 3rd DMRS configuration is N₃, the number of necessary bits is X₃ (X₃=ceil(log₂(N₃))).

In the DCI format monitored by the UE, the length of the antenna port field may be determined as follows.

In case that only one DMRS configuration among three DMRS configurations is configured for the UE, the length of the antenna port field is one of X₁ bits, X₂ bits, and X₃ bits according to the configured DMRS configuration. That is, when only the 1st DMRS configuration is configured for the UE, the length of the antenna port field is X₁ bits. When only the 2nd DMRS configuration is configured for the UE, the length of the antenna port field is X₂ bits. When only the 3rd DMRS configuration is configured for the UE, the length of the antenna port field is X₃ bits.

In case that only two DMRS configurations among three DMRS configurations are configured for the UE, the length of the antenna port field is the maximum value of the number of bits required for the two configured DMRS configurations. That is, the length of the antenna port field is max{Xₙ,Xₘ} bits. Here, n and m are determined according to the configured DMRS configuration. That is, when the 1st DMRS configuration and the 2nd DMRS configuration are configured for the UE, the length of the antenna port field is max{X₁,X₂} bits. When the 1st DMRS configuration and the 3rd DMRS configuration are configured for the UE, the length of the antenna port field is max{X₁,X₃} bits. When the 2nd DMRS configuration and the 3rd DMRS configuration are configured for the UE, the length of the antenna port field is max(X₂,X₃) bits.

In case that all three DMRS configurations are configured for the UE, the length of the antenna port field is the maximum value of the number of bits required for the three DMRS configurations. That is, the length of the antenna port field is max{X₁,X₂,X₃} bits.

When the UE analyzes the antenna port field based on the antenna port table, not all bits of the antenna port field may be needed. For example, when all three DMRS configurations are configured for the UE, the DCI format monitored by the UE includes the antenna port field of max{X₁, X₂, X₃} bits. In case that a TDRA row indicated by the TDRA field of the DCI format includes only scheduling information of mapping type A, LSB X₁ bits of the antenna port field of max{X₁,X₂,X₃} bits are required, but MSB max(X₁,X₂,X₃)−X₁ bits may be unrequired. Therefore, the UE may assume that the MSB max{X₁,X₂,X₃}−X₁ bits of the antenna port field are padded with “0”, and may interpret the antenna port field based on the assumption.

In case that the TDR row A indicated by the TDRA field of the DCI format includes only mapping type B scheduling information, LSB X₂ bits of the antenna port field of max{X₁,X₂,X₃} bits are required, but MSB max{X₁, X₂, X₃}−X₂ bits may be unrequired. Therefore, the UE may assume that MSB max{X₁, X₂, X₃}−X₂ bits of the antenna port field are padded with “0”, and may interpret the antenna port field based on the assumption.

In case that the TDRA row indicated by the TDRA field of the DCI format includes scheduling information of mapping type A and scheduling information of mapping type B, LSB X₃ bits of the antenna port field of max {X₁,X₂,X₃} bits are required, MSB max{X₁,X₂,X₃}−X₃ bits may be unrequired. Therefore, the UE may assume that the MSB max{X₁,X₂,X₃}−X₃ bits of the antenna port field are padded with “0”, and may interpret the antenna port field based on the assumption.

The 3rd DMRS configuration may be the same as one of the 2nd DMRS configuration or the 1st DMRS configuration. That is, upon being configured with the 3rd DMRS configuration, the UE may be configured with the same configuration as one of the 1st DMRS configuration or the 2nd DMRS configuration, but may not be configured with a configuration different from the 1st DMRS configuration and the 2nd DMRS configuration. Through this restriction, the UE may be configured with up to two different DMRS configurations.

A new higher layer signal (for example, an RRC signal) may be required for the 3rd DMRS configuration. This may cause design and overhead of a higher layer signal. A method for improving this problem will be described in the below.

A UE may not receive a configured higher layer signal for the 3rd DMRS configuration. Instead, the 3rd DMRS configuration may be determined from the following three methods.
1st method: A UE may assume that the 3rd DMRS configuration is always the same as the 1st DMRS configuration. The UE may use, for the 3rd DMRS configuration, the DMRS configuration for a TDRA row including only scheduling information of mapping type A. In other words, the UE may determine a DMRS of mapping type B, which is scheduled by a TDRA row including different mapping types, by using DMRS configuration of mapping type A, that is, DMRS type (dmrs-Type) or DMRS maximum length (maxLength) thereof. Accordingly, the UE may use an antenna port table of mapping type A, with regard to mapping type B scheduled by a TDRA row including different mapping types. Here, the location of DMRS of mapping type B may follow the scheme of mapping type B as it is.
2nd method: A UE may assume that the 3rd DMRS configuration is always the same as the 2nd DMRS configuration. That is, the UE may use, for the 3rd DMRS configuration, the DMRS configuration for a TDRA row including only scheduling information of mapping type B. In other words, the UE may determine a DMRS of mapping type A, which is scheduled by a TDRA row including different mapping types, by using DMRS configuration of mapping type B, that is, DMRS type (dmrs-Type) or DMRS maximum length (maxLength) thereof. Accordingly, the UE may use an antenna port table of mapping type B, with regard to mapping type A scheduled by a TDRA row including different mapping types. Here, the location of DMRS of mapping type A may follow the scheme of mapping type A as it is.
3rd method: A UE may assume that the 3rd DMRS configuration is the same as either the 1st DMRS configuration or the 2nd DMRS configuration based on the mapping type of one piece of scheduling information among pieces of scheduling information scheduled by a TDRA row including different mapping types.

For example, a UE may assume that the 3rd DMRS configuration is the same as either the 1^{st} DMRS configuration or the 2nd DMRS configuration based on the mapping type of the earliest scheduling information among pieces of scheduling information scheduled by a TDRA row including different mapping types. When the mapping type of the earliest scheduling information is mapping type A, the UE may assume that the DMRS configuration of mapping type A, that is, the 1st DMRS configuration is the same as the 3rd DMRS configuration. When the mapping type of the earliest scheduling information is mapping type B, the UE may assume that the DMRS configuration of mapping type B, that is, the 2nd DMRS configuration is the same as the 3rd DMRS configuration.

Here, the earliest scheduling information may be replaced by the latest scheduling information. The earliest scheduling information may be the earliest scheduling information in time.

According to an embodiment, multi-PDSCH/PUSCH scheduling may introduce one or more restrictions on the same mapping type When a UE has an antenna port table corresponding to mapping type A different from an antenna port table corresponding to mapping type B, the UE may expect that the mapping types of pieces of scheduling information included in a TDRA row are the same.

When the DMRS type (dmrs-Type) or maximum DMRS length (maxLength) of mapping type A for the UE is different from the DMRS type (dmrs-Type) or maximum length (maxLength) of mapping type B, the UE may expect that the mapping types of pieces of scheduling information included in a TDRA row are the same.

In addition, when a TDRA row including different mapping types is configured in a TDRA table, the UE may assume that an antenna port table corresponding to mapping type A and an antenna port table corresponding to mapping type B are the same. When a TDRA row including different mapping types is configured in a TDRA table, the UE may assume that a DMRS type (dmrs-Type) or DMRS maximum length (maxLength) of mapping type A and a DMRS type (dmrs-Type) or DMRS maximum length (maxLength) of mapping type B are identical to each other.

That is, the UE may be configured not to expect that a DMRS type (dmrs-Type) or DMRS maximum length (maxLength) of mapping type A and a DMRS type (dmrs-Type) or DMRS maximum length (maxLength) of mapping type B are different from each other, and that a TDRA row including different mapping types is configured in the TDRA table. The UE may be configured not to expect that an antenna port table corresponding to mapping type A and an antenna port table corresponding to mapping type B are different from each other, and that a TDRA row including different mapping types is configured in the TDRA table.

When the base station configures the DMRS type (dmrs-Type) or maximum DMRS length (maxLength) of mapping type A and the DMRS type (dmrs-Type) or maximum length (maxLength) of mapping type B to be different for the UE, the base station may configure the mapping types of pieces of scheduling information included in a TDRA row to always be the same.

When the base station configures a TDRA row including different mapping types in a TDRA table for the UE, the base station should configure the DMRS type (dmrs-Type) or maximum DMRS length (maxLength) of mapping type A and the DMRS type (dmrs-Type) or DMRS maximum length (maxLength) of mapping type B to be the same.

That is, the base station may configure the DMRS type (dmrs-Type) or maximum DMRS length (maxLength) of mapping type A differently from the DMRS type (dmrs-Type) or maximum length (maxLength) of mapping type B, and may configure a TDRA row including different mapping types to be included in the TDRA table.

Since a PDSCH (or PUSCH) scheduled in a TDRA field of a DCI format received by the UE always has the same mapping type, the location and length of the DMRS may be determined based on the DMRS configuration of the mapping type. In addition, the UE may determine one antenna port table based on the DMRS configuration of the mapping type. One row of the one antenna port table may be indicated in the antenna port field.

According to an embodiment, an antenna port field indicates each row of two antenna port tables.

When a UE receives a TDRA row including different mapping types configured in the TDRA table, the UE may assume respective antenna port fields for mapping type A and mapping type B in a monitored DCI format. Alternatively, the UE may assume that the antenna port field in the monitored DCI format includes bit(s) for mapping type A and bit(s) for mapping type B.

The length of the antenna port field may be determined as (X₁+X₂) bits.

MSB X₁ bits of the antenna port field may be used to indicate one row of the antenna port table according to a DMRS configuration of mapping type A. LSB X₂ bits of the antenna port field may be used to indicate one row of the antenna port table according to DMRS configuration of mapping type B. Conversely, MSB X₁ bits may be used for mapping type B and LSB X₂ bits may be used for mapping type A.

For example, when a UE receives a TDRA row including different mapping types configured in the TDRA table, the UE may obtain X₁ bits for indicating the antenna port table of mapping type A and X₂ bits for indicating the antenna port table of mapping type B in the DCI format to be monitored. Since the UE may receive an indication of one row of the antenna port table of mapping type A with the X₁ bits and one row of the antenna port table of mapping type B with the X₂ bits, antenna port indication is possible in a non-restricted manner.

(X₁+X₂) bits may not always be needed in the DCI format monitored by the UE. For example, if the TDRA row indicated by the TDRA field of the DCI format received by the UE includes only scheduling information of one mapping type, (X₁+X₂) bits may not be required. To this end, in the DCI format monitored by the UE, the antenna port field may be determined as follows.

According to one method, when a TDRA table configured for a UE includes at least one TDRA row including different mapping types, a DCI format monitored by the UE may include (X₁+X₂) bits. That is, even if a TDRA row indicated by the TDRA field of the DCI format includes only scheduling information of one mapping type, the UE always receives the antenna port field of (X₁+X₂) bits. Here, the UE may obtain an index value of the row of the antenna port table of one mapping type from the antenna port field as follows.

A UE may assume that (X₁+X₂) bits are binary numbers, convert the binary numbers to decimal numbers, and then consider a value corresponding to the decimal numbers as an index of a row of the antenna port table. When the number of rows of the antenna port table is Nᵢ and the number of bits required to indicate this is X₋ᵢ (Xᵢ=ceil(log₂(Nᵢ))) bits, the UE may assume that MSB (X₁+X₂−Xᵢ) bits of the antenna port field are padded with “0”. Here, when the one mapping type is mapping type A, i=1, and when the one mapping type is mapping type B, i=2.

When the one mapping type is mapping type A, an index of a row of the antenna port table of mapping type A may be obtained using MSB X₁ bits of the antenna port field, and when the one mapping type is mapping type B, an index of a row of the antenna port table of mapping type B may be obtained using LSB X₂ bits of the antenna port field. When the one mapping type is mapping type A, the UE may assume that “0” is padded in the LSB X₂ bits of the antenna port field. When the one mapping type is mapping type B, the UE may assume that “0” is padded in the MSB X₁ bits of the antenna port field.

According to another method, the length of the antenna port field may differ according to the mapping type of a TDRA row indicated by a TDRA field of a DCI format received by a UE. In case that the TDRA row indicated by the TDRA field of the DCI format received by the UE includes only scheduling information of one mapping type, the UE may assume that the received DCI format includes an antenna port field of max{X₁,X₂} bits. That is, when the TDRA row indicated by the TDRA field of the DCI format received by the UE includes only scheduling information of one mapping type, the UE may assume that the antenna port field having the same number of bits as that of the existing one is included in the DCI format.

In case that a TDRA row indicated by a TDRA field of a DCI format received by the UE includes scheduling information of mapping type A and scheduling information of mapping type B, the UE may assume that the antenna port field of (X₁+X₂) bits is included in the received DCI format. That is, when the TDRA row indicated by the TDRA field of the DCI format received by the UE includes scheduling information of mapping type A and scheduling information of mapping type B, the UE may assume that the antenna port field of (X₁+X₂) bits is included in the DCI format.

According to another method, the length of an antenna port field may differ according to the number of scheduling information included in a TDRA row indicated by a TDRA field of a DCI format received by a UE. When the TDRA row indicated by the TDRA field of the DCI format received by the UE includes only one piece of scheduling information, the UE may assume that the received DCI format includes an antenna port field of max {X₁, X₂} bits. That is, when the TDRA row indicated by the TDRA field of the DCI format received by the UE includes only one piece of scheduling information, the UE may assume that the antenna port field having the same number of bits as that of the existing one is included in the DCI format.

In case that the TDRA row indicated by the TDRA field of the DCI format received by the UE includes multiple pieces of scheduling information, the UE may assume that the received DCI format includes an antenna port field of (X₁+X₂) bits. That is, if the TDRA row indicated by the TDRA field of the DCI format received by the UE includes multiple pieces of scheduling information, the UE may assume that the antenna port field of (X₁+X₂) bits is included in the DCI format.

The UE may assume the length of the antenna port field is determined according to the TDRA row indicated by the TDRA field of the received DCI format. When monitoring the DCI format, the UE should know the length of the DCI format in advance. Therefore, when the length of the DCI format is different according to the TDRA row indicated by the TDRA field, the UE may match the length of the DCI format to the longest DCI format length. That is, the UE may pad some bits to the shorter DCI format to match the longest DCI format length. The UE may pad some bits to the LSB of the shorter DCI format to match the length of the longest DCI format. Some bits may be “0”.

According to an embodiment, an antenna port field indicates one or more rows of an antenna port combination table.

A UE may receive, from a base station, a new antenna port combination table configured, and an antenna port field may indicate one of rows of the antenna port combination table.

A new antenna port combination table may be defined as follows.

Each row of the new antenna port combination table may have an intrinsic index.

A first index and a second index may be configured in each row of the new antenna port combination table. Here, the first index may be an index of one row among rows of an antenna port table of mapping type A. The second index may be an index of one row among rows of an antenna port table of mapping type B.

In the case of receiving a new antenna port combination table configured, a UE may obtain a row of the antenna port table as follows.

The UE may obtain an index of a row of an antenna port combination table from an antenna port field. The UE may obtain a first index and a second index configured in a row of the antenna port combination table having the index. The UE may consider the first index as an index of the antenna port table of mapping type A and the second index as an index of the antenna port table of mapping type B. Therefore, the UE may consider that a row corresponding to the first index of the antenna port table of mapping type A has been indicated as a row of the antenna port table of mapping type A, and may consider that a row corresponding to the second index of the antenna port table of mapping type B has been indicated as a row of the antenna port table of mapping type B.

The antenna port combination table may be applied to all TDRA rows or to a specific TDRA row.

When an antenna port combination table is configured, a UE may obtain information about the DMRS and antenna port of the PDSCH (or PUSCH) of all TDRA rows from the antenna port combination table.

More specifically, when a TDRA row indicated by a TDRA field of a DCI format received by the UE includes only scheduling information of mapping type A, the UE may determine a row of an antenna port combination table from an antenna port field, and the UE may determine a row of an antenna port table of mapping type A based on a first index of the row of the antenna port combination table. In this case, a second index corresponding to unscheduled mapping type B may be ignored.

In case that the TDRA row indicated by the TDRA field of the DCI format received by the UE includes only scheduling information of mapping type B, the UE may determine a row of the antenna port combination table from the antenna port field, and the UE may determine a row of an antenna port table of mapping type B based on a second index of the row of the antenna port combination table. In this case, a first index corresponding to unscheduled mapping type B may be ignored.

In case that the TDRA row indicated by the TDRA field of the DCI format received by the UE includes scheduling information of mapping type A and scheduling information of mapping type B, the UE may determine a row of the antenna port combination table from the antenna port field, and the UE may determine a row of the antenna port table of mapping type A based on a first index of a row of the antenna port combination table and a row of the antenna port table of mapping type B based on a second index.

Here, the antenna port table of mapping type A may be an antenna port table according to the DMRS type (dmrs-Type) or DMRS maximum length (maxLength) configured in mapping type A, and the antenna port table of mapping type B may be an antenna port table according to the DMRS type (dmrs-Type) or DMRS maximum length (maxLength) configured in mapping type B.

When using the 1st method, the length of the antenna port field may be determined according to the number of rows configured in the antenna port combination table. When the number of rows configured in the antenna port combination table is N_{comb}, the antenna port field may be ceil(log 2(N_{comb})) bits.

When an antenna port combination table is configured, a UE may use the antenna port combination table in case that a TDRA row including different mapping types is indicated, and may use an existing antenna port table (for example, an antenna port table according to DMRS configuration configured in mapping type A and an antenna port table according to DMRS configuration configured in mapping type B) in case that a TDRA row having only scheduling information of one mapping type is indicated.

More specifically, when a TDRA row indicated by a TDRA field of a DCI format received by the UE includes only scheduling information of mapping type A, the UE may obtain an index of a row of an antenna port table determined according to the DMRS type (dmrs-Type) or maximum DMRS length (maxLength) of mapping type A from an antenna port field. The UE may obtain antenna port information from the row of the antenna port table having the index.

In case that the TDRA row indicated by the TDRA field of the DCI format received by the UE includes only scheduling information of mapping type B, the UE may obtain an index of a row of an antenna port table determined according to the DMRS type (dmrs-Type) or maximum DMRS length (maxLength) of mapping type B from an antenna port field. The UE may obtain antenna port information from the row of the antenna port table having the index.

In case that the TDRA row indicated by the TDRA field of the DCI format received by the UE includes scheduling information of mapping type A and scheduling information of mapping type B, the UE may determine a row of the antenna port combination table from an antenna port field, and may determine a row of the antenna port table of mapping type A based on a first index of a row of the antenna port combination table and determine a row of the antenna port table of mapping type B based on a second index.

The length of the antenna port field may be determined according to the number of rows of the antenna port table of mapping type A, the number of rows of the antenna port table of mapping type B, and the number of rows configured in the antenna port combination table. When the number of rows configured in the antenna port combination table is N_{comb} and the number of bits for indicating the row of the antenna port combination table is X_{comb}=ceil(log 2(N_{comb})), for example, the length of the antenna port field may be max{X₁,X₂,X_{comb}} bits. Here, the length of an antenna port field is fixed regardless of a mapping type included in a TDRA row indicated by a TDRA field of the DCI format. Additionally or alternatively, the length of an antenna port field of a DCI format may be max{X₁,X₂} bits or X_{comb} bits. In case that a TDRA row indicated by a TDRA field of a DCI format received by the UE includes only scheduling information of one mapping type, the length of an antenna port field is max{X₁,X₂} bits, and in case that the TDRA row indicated by the TDRA field of the DCI format received by the UE includes only scheduling information of one mapping type, the length of the antenna port field may be X_{comb} bits.

When an antenna port combination table is configured, a UE may use the antenna port combination table in case that a TDRA row including multiple pieces of scheduling information is indicated, and may use an existing antenna port table (for example, an antenna port table according to DMRS configuration configured in mapping type A and/or an antenna port table according to DMRS configuration configured in mapping type B) in case that a TDRA row including multiple pieces of scheduling information is indicated.

More specifically, when a TDRA row indicated by a TDRA field of a DCI format received by the UE includes only scheduling information of mapping type A, the UE may obtain an index of a row of an antenna port table determined according to the DMRS type (dmrs-Type) or maximum DMRS length (maxLength) of mapping type A from an antenna port field. The UE may obtain antenna port information from the row of the antenna port table having the index.

In case that the TDRA row indicated by the TDRA field of the DCI format received by the UE includes only one piece of scheduling information of mapping type B, the UE may obtain an index of a row of an antenna port table determined according to the DMRS type (dmrs-Type) or maximum DMRS length (maxLength) of mapping type B from an antenna port field. The UE may obtain antenna port information from the row of the antenna port table having the index.

In case that the TDRA row indicated by the TDRA field of the DCI format received by the UE includes multiple pieces of scheduling information, the UE may determine a row of the antenna port combination table from an antenna port field, and may determine a row of the antenna port table of mapping type A based on a first index of a row of the antenna port combination table and determine a row of the antenna port table of mapping type B based on a second index.

The length of the antenna port field may be determined according to the number of rows of the antenna port table of mapping type A, the number of rows of the antenna port table of mapping type B, and the number of rows configured in the antenna port combination table. Assuming that the number of rows configured in the antenna port combination table is N_{comb} and the number of bits for indicating the row of the antenna port combination table is X_{comb}=ceil(log 2(N_{comb})). The length of the antenna port field may be max{X₁,X₂,X_{comb}} bits. Here, the length of an antenna port field is fixed regardless of the number of scheduling information included in a TDRA row indicated by a TDRA field of the DCI format. Additionally or alternatively, the length of an antenna port field of a DCI format may be max{X₁,X₂} bits or X_{comb} bits. In case that a TDRA row indicated by a TDRA field of a DCI format received by the UE includes only one piece of scheduling information, the length of an antenna port field may be max{X₁,X₂} bits, and in case that the TDRA row indicated by the TDRA field of the DCI format received by the UE includes only multiple pieces of scheduling information, the length of the antenna port field may be X_{comb} bits.

According to an embodiment, a UE may receive a configured antenna port combination table for indicating an antenna port of a PUSCH, for each rank, from a base station. More specifically, the UE may receive a configured PUSCH antenna port combination table of rank 1, the UE may receive a configured PUSCH antenna port combination table of rank 2, the UE may receive a configured PUSCH antenna port combination table of rank 3, and the UE may receive a configured PUSCH antenna port combination table of rank 4. Here, the first index of the antenna port combination table of rank r (r=1,2,3,4) may indicate a row of the antenna port table corresponding to rank r (r=1,2,3,4) and DMRS configuration of mapping type A and, and the second index may indicate a row of the antenna port table corresponding to rank r (r=1, 2, 3, 4) and DMRS configuration of mapping type B.

A UE may receive a configured antenna port combination table for indicating an antenna port of a PDSCH from a base station for each number of enabled codewords. More specifically, the UE may receive a configured antenna port combination table of PDSCH in which the number of enabled codewords is 1 (hereinafter, a first table) and a configured antenna port combination table of PDSCH in which the number of enabled codewords is 2 (hereinafter, a second table). When the PDSCH scheduled by the DCI received by the UE includes one enabled codeword, the first table may be used. That is, the first index of the first table may indicate a row of the antenna port table corresponding to the DMRS configuration of mapping type A, and may obtain DMRS information (DMRS port(s), the number of DMRS symbols, and/or the number of CDM groups without data) in case that the number of enabled codewords in the row is 1. The second index of the first table may indicate a row of the antenna port table corresponding to the DMRS configuration of mapping type B, and may obtain DMRS information (DMRS port(s), the number of DMRS symbols, and/or the number of CDM groups without data) in case that the number of enabled codewords in the row is 1. Similarly, when the PDSCH scheduled by the DCI received by the UE includes two enabled codewords, the second table may be used. That is, the first index of the second table may indicate a row of the antenna port table corresponding to the DMRS configuration of mapping type A, and may obtain DMRS information (DMRS port(s), the number of DMRS symbols, and/or the number of CDM groups without data) in case that the number of enabled codewords in the row is 1. The second index of the second table may indicate a row of the antenna port table corresponding to the DMRS configuration of mapping type B, and may obtain DMRS information (DMRS port(s), the number of DMRS symbols, and/or the number of CDM groups without data) in case that the number of enabled codewords in the row is 1.

According to an embodiment, an antenna port field value indicating the same DMRS information may be expected.

When a DCI format received by a UE indicates a TDRA row including different mapping types, even if a different antenna port table is used for each mapping type, the UE may expect an antenna port field value indicating the same DMRS information. Here, the same DMRS information includes the same DMRS port(s), the same number of DMRS symbols (number of front-load symbols), or the same number of DMRS CDM groups without data (number of DMRS CDM group(s) without data). In case that a DCI format to be transmitted indicates a TDRA row including different mapping types and different antenna port tables are used for each mapping type, a base station does not indicate an antenna port field value indicating the same DMRS information.

The same DMRS information may include at least one of the same DMRS port(s), the same number of DMRS symbols (number of front-load symbols), or the same number of DMRS CDM group(s) without data (number of DMRS CDM group(s) without data). For example, the same DMRS information may correspond to the case of the same DMRS port(s).

In other words, when the DCI format received by the UE indicates a TDRA row including different mapping types and a different antenna port table is used for each mapping type, the UE does not expect an antenna port field value indicating other DMRS information. In case that a DCI format to be transmitted indicates a TDRA row of different mapping types and different antenna port tables are used for each mapping type, the base station does not indicate an antenna port field value indicating other DMRS information.

Even if a different antenna port table is used for different mapping types, rows of the same index in the two antenna port tables may have the same DMRS port. For example, when Table 41 (in the case of dmrs-Type=1, maxLength=2) and Table 43 (in the case of dmrs-Type=2, maxLength=1) are respectively configured for PDSCH mapping types A and B, when only one codeword is enabled, rows 0 to 10 of the two tables may be identified to have the same DMRS port(s), the same number of DMRS symbols (number of front-load symbols), and the same number of DMRS CDM group(s) without data (number of DMRS CDM group(s) without data). Therefore, when one of the rows is indicated, the UE may determine DMRS and antenna port information of mapping type A and mapping type B.

According to an embodiment, antenna port field values may be applied to antenna port tables of two mapping types.

When a TDRA row including different mapping types is indicated, a UE may apply values of the antenna port field to antenna port tables of two mapping types.

The UE may expect that the value of the antenna port field indicates a valid row (a non-reserved row) in the antenna port tables of two mapping types. That is, when the value of the antenna port field is indicated as an invalid value in any one of the antenna port tables of the two mapping types, the UE may determine this as an error case and ignore a DC format including the antenna port field.

When the UE receives an indication of an invalid row (reserved row) in one antenna port table among the antenna port tables of two mapping types from the value of the antenna port field, the UE may assume that scheduling information corresponding to the mapping type using the antenna port table is not scheduled.

For example, when a TDRA row indicated by a TDRA field of a DCI format received by the UE includes scheduling information of mapping type A and scheduling information of mapping type B, the UE may determine a row by applying a value indicated by the antenna port field to each antenna port table. That is, the UE may determine DMRS information and antenna port information of mapping type A by applying the value indicated by the antenna port field to the antenna port table of mapping type A, and may determine DMRS information and antenna port information of mapping type B by applying the value indicated by the antenna port field to the antenna port table of mapping type B. If the row selected from the antenna port table of mapping type A is a valid row (a non-reserved row) and the row selected from the antenna port table of mapping type B is an invalid row (a reserved row), the UE may receive (or transmit) a PDSCH (or PUSCH) corresponding to scheduling information of mapping type A. However, the UE may not receive (or transmit) a PDSCH (or PUSCH) corresponding to scheduling information of mapping type B.

When a TDRA row including different mapping types of the received DCI format is indicated by a UE, the UE may interpret the value of the antenna port field as one of the valid rows of the antenna port table of the mapping type according to a predetermined rule.

Here, valid rows in the antenna port table may be non-reserved rows.

When Table 41 (in the case of dmrs-Type=1, maxLength=2) and Table 43 (in the case of dmrs-Type=2, maxLength=1) are configured for PDSCH mapping types A and B, and when only one codeword is enabled and the antenna port field indicates one of row 0 to row 23, the row corresponds to a valid value in two antenna port tables. That is, the row corresponds to a non-reserved row in the two antenna port tables. However, when the antenna port field indicates one of rows 24 to 30, the row corresponds to a valid value in one antenna port table (dmrs-Type=1, maxLength=2), but the row corresponds to an invalid value (reserved) in the other antenna port table (dmrs-Type=1, maxLength=2). Therefore, when a TDRA row including different mapping types is indicated, rows 24 to 30 are unable to be indicated in the antenna port field.

In order to solve this problem, the following method may be applied.

A value indicated in the antenna port field may be reinterpreted based on the number of valid rows of the antenna port table to select a row of the antenna port table. For example, a row of the antenna port table may be selected based on a value obtained by performing a modulo calculation of a value indicated in the antenna port field with the number of valid rows of the antenna port table.

For example, when Table 41 (in the case of dmrs-Type=1, maxLength=2) and Table 43 (dmrs-Type=2, maxLength=1 case) are configured for PDSCH mapping types A and B, it is assumed that only one codeword is enabled. In addition, it is assumed that the value indicated in the antenna port field is 25. As mentioned above, row 25 is an invalid value (reserved) in the antenna port table (dmrs-Type=2, maxLength=1). In order to solve this problem, the UE may obtain 25 mod 24=1 by performing a modulo calculation of 25, which is the value indicated in the antenna port field, with 24, which is the number of valid rows in the antenna port table, and may obtain DMRS information and antenna port information from row 1 of the antenna port table.

In case that a value indicated in an antenna port field indicates a valid value in one antenna port table but indicates an invalid value (reserved) in another antenna port table, a UE may interpret the case as one of the valid values as follows.

The UE may interpret the case as a specific row having a valid value of an antenna port table in which the invalid value (reserved) is indicated. Here, the specific row may be row 0. As another example, a base station may configure the specific row via a higher layer.

The UE may interpret the case as a specific row having a valid value of an antenna port table in which the valid value is indicated. Here, the index of a specific row may be a value indicated in the antenna port field. For example, row 25 is an invalid value (reserved) in an antenna port table (dmrs-Type=2, maxLength=1). In this case, row 25 of an antenna port table (dmrs-Type=1, maxLength=2) may be used.

Although the embodiments described above have been described separately for convenience of explanation, the disclosure can be implemented by combining the embodiments with each other. In addition, in various embodiments of the disclosure, for convenience of description, the operation of a UE has been mainly described, but the technical features of the various embodiments of the disclosure described as the operation of the UE may also be applied to the configuration of a base station and the operation of the base station.

A UE may receive multiple pieces of scheduling information configured in one TDRA row according to multi-PUSCH scheduling configuration, and each of the multiple pieces of scheduling information may have a SLIV and a mapping type. Accordingly, the UE may receive an indication of a TDRA row including pieces of scheduling information having different mapping types through one DCI.

Different pieces of DMRS configuration information may be configured for different mapping types. In case that the DMRS configuration information is different, a different antenna port table for DMRS port indication may be configured. Accordingly, the UE may configure different DMRS port(s) for PUSCHs of different mapping types according to different antenna port tables.

For example, it is assumed that the following is configured as the DMRS configuration of mapping type A.
DMRS type (dmrs-Type)=1
DMRS maximum length (maxLength)=1

In addition, it is assumed that the following is configured as DMRS configuration of mapping type B.
DMRS type (dmrs-Type)=1
DMRS maximum length (maxLength)=2

Further, it is assumed that rank is 2. Rank is information that a UE may obtain through a DCI format. Therefore, at the time of determining a DMRS port to transmit a PUSCH of mapping type A, the UE may use one of the rows in Table 23 (a non-reserved row corresponding to indexes 0, 1, 2, and 3), and at the time of determining a DMRS port to transmit a PUSCH of mapping type B, the UE may use one of the rows of Table 27 (a non-reserved row corresponding to indexes 0, 1, . . . , 9. For example, assuming that a base station indicates DMRS port {0,1} to transmit a PUSCH of mapping type A and DMRS port {0,2} to transmit a PUSCH of mapping type B. In this case, the UE may identify that different DMRS ports are mapped to different mapping types for PUSCH transmission. Accordingly, a DMRS port for transmitting a PUSCH of mapping type A and a DMRS port for transmitting a PUSCH of mapping type B in a UE may be different from each other.

The UE should be indicated with an index of a DMRS port for PTRS transmission. The DCI format for scheduling a PUSCH may include a PTRS-DMRS association field for indicating a DMRS port for PTRS transmission. As described above, the PTRS-DMRS association field may indicate one antenna port among DMRS ports of the scheduled PUSCH, and at the time of transmitting the PUSCH, the PTRS may be transmitted through the indicated antenna port.

As described above, the PTRS-DMRS association field may be indicated according to Table 49-1 as 1^{st} scheduled DMRS port, 2^{nd} scheduled DMRS port, 3^{rd} scheduled DMRS port, and/or 4^{th} scheduled DMRS port. It is assumed that the 2^{nd} scheduled DMRS port is indicated as the current PTRS-DMRS association field. In this case, according to the previous example, in case of mapping type A, a PUSCH is transmitted through DMRS port {0,1}, and thus a PTRS antenna port is DMRS port 1, and in the case of mapping type B, the PUSCH is transmitted through DMRS port {0, 2}, and thus the PTRS antenna port is DMRS port 2. Therefore, in case of different mapping types, different DMRS ports may be used for PTRS transmission.

The base station should select a DMRS port having the highest received signal power among DMRS ports as a PTRS antenna port in order to obtain the highest performance. This is the reason why the base station indicates one DMRS port in the PTRS-DMRS association field in the DCI format. However, in the case of different mapping types, since DMRS ports may be different depending on a mapping type, the base station may not be able to simultaneously indicate the DMRS port having the highest received signal power for two different mapping types to the UE. For example, in the above example, the UE may transmit PTRS through DMRS port 1 for a PUSCH of mapping type A, and may transmit PTRS through DMRS port 2 for a PUSCH of mapping type B. In this case, assuming that the received signal power for each DMRS port is DMRS port 1>DMRS port 0>DMRS port 2, the base station should indicate transmission of PTRS through DMRS port 1 for a PUSCH of mapping type A, and transmission of PTRS through DMRS port 0 for a PUSCH of mapping type B. However, the DCI format does not necessarily support these indications. A method for determining PTRS antenna ports of different mapping types is described below.

Introducing one or more restrictions on the same DMRS port(s) and on the same DMRS port(s) indication is described below.

A UE may expect that mapping type A and mapping type B use the same antenna port table. Here, in order to use the same antenna port table, the UE may receive the same DMRS type (dmrs-Type) and DMRS maximum length (maxLength) configured via a higher layer. The base station may configure the same DMRS type (dmrs-Type) and maximum DMRS length (maxLength) for the UE. In addition, the UE may expect to be indicated with the same DMRS port(s) for mapping type A and mapping type B.

When a TDRA table including a TDRA row including different mapping types is configured, the UE may expect that mapping type A and mapping type B use the same antenna port table. That is, when a TDRA table including a TDRA row including different mapping types is configured, the UE may expect that the DMRS type (dmrs-Type) and the maximum DMRS length (maxLength) of mapping type A and mapping type B are the same.

When a base station is to configure a TDRA table including a TDRA row including different mapping types for a UE, the base station should configure the TDRA table for the UE so that mapping type A and mapping type B use the same antenna port table. That is, when the base station is to configure a TDRA table including a TDRA row including different mapping types for the UE, the base station should configure DMRS types (dmrs-Type) and DMRS maximum lengths (maxLength) of mapping type A and mapping type B to be the same for the UE.

When a TDRA table that does not include a TDRA row including different mapping types is configured, an antenna port table of mapping type A and mapping type B of the UE may be the same or different. That is, when a TDRA table that does not include a TDRA row including different mapping types is configured, the UE may expect that the DMRS types (dmrs-Type) and maximum DMRS lengths (maxLength) of mapping type A and mapping type B are the same or different. In other words, when a TDRA table that does not include a TDRA row including different mapping types is configured in the UE, there is no configuration restriction on the DMRS type (dmrs-Type) and maximum DMRS length (maxLength) of mapping type A and mapping type B.

When a base station is to configure a TDRA table that does not include a TDRA row including different mapping types for a UE, the base station may configure the TDRA table for the UE so that mapping type A and mapping type B use the same or different antenna port tables. That is, when the base station is to configure a TDRA table that does not include a TDRA row including different mapping types for the UE, the base station may configure DMRS types (dmrs-Type) and DMRS maximum lengths (maxLength) of mapping type A and mapping type B to be the same or different for the UE. In other words, when the base station is to configure a TDRA table that does not include a TDRA row including different mapping types for the UE, the base station may freely configure for the UE the DMRS types (dmrs-Type) and maximum DMRS lengths (maxLength) of mapping type A and mapping type B without configuration restrictions thereon.

When at least one row in a TDRA table configured for the UE corresponds to a TDRA row including different mapping types, the DMRS types (dmrs-Type) and the maximum DMRS lengths (maxLength) of mapping type A and mapping type B should be the same. This also affects other TDRA rows in the TDRA table.

For example, assuming that a first TDRA row includes scheduling information of mapping type A and a second TDRA row includes scheduling information of mapping type B in the TDRA table, a base station could configure different DMRS types (dmrs-Type) or DMRS maximum lengths (maxLength) for mapping type A and mapping type B in a UE. Accordingly, a PUSCH scheduled in a first TDRA row and a PUSCH scheduled in a second TDRA row could have a DMRS of different DMRS types (dmrs-Type) or DMRS maximum lengths (maxLength). However, the PUSCH scheduled in the first TDRA row and the PUSCH scheduled in the second TDRA row may always have a DMRS of the same DMRS type (dmrs-Type) or DMRS maximum length (maxLength). This may make it difficult for the base station to configure DMRS suitable for a mapping type.

In order to solve this problem, the following embodiment may be considered.

A UE may additionally receive DMRS configuration only for a TDRA row including different mapping types via a higher layer signal (e.g., an RRC signal). The DMRS configuration may include at least a DMRS type (dmrs-Type) and a maximum DMRS length (maxLength). The UE may receive three DMRS configurations as follows:
1st DMRS configuration: DMRS configuration for a TDRA row including only scheduling information of mapping type A
2nd DMRS configuration: DMRS configuration for a TDRA row including only scheduling information of mapping type B
3rd DMRS configuration: DMRS configuration for a TDRA row including scheduling information of mapping type A and scheduling information of mapping type B For reference, the 1st DMRS configuration may be DMRS configuration configured in mapping type A (dmrs-UplinkForPUSCH-MappingTypeA), the 2nd DMRS configuration may be DMRS configuration configured in mapping type B (dmrs-UplinkForPUSCH-MappingTypeB), and the 3rd DMRS configuration may be DMRS configuration which is newly configured.

Upon receiving the DCI format, the UE may perform the following operation.

The UE may obtain an index of a TDRA row from a TDRA field of a received DCI format. The UE may obtain scheduling information included in the TDRA row and a mapping type of the scheduling information.

In case that the TDRA row includes only scheduling information of mapping type A, the UE may assume a 1st DMRS configuration. Therefore, the UE may determine a DMRS type (dmrs-Type) or a maximum DMRS length (maxLength) according to the 1st DMRS configuration, and may use an antenna port table according to the DMRS type (dmrs-Type) or the maximum DMRS length (maxLength).

When the TDRA row includes only scheduling information of mapping type B, the UE may assume a 2nd DMRS configuration. Therefore, the UE may determine a DMRS type (dmrs-Type) or a maximum DMRS length (maxLength) according to the 2nd DMRS configuration, and may use an antenna port table according to the DMRS type (dmrs-Type) or the maximum DMRS length (maxLength).

When the TDRA row includes scheduling information of mapping type A and scheduling information of mapping type B, the UE may assume a 3rd DMRS configuration. Therefore, the UE may determine a DMRS type (dmrs-Type) or a maximum DMRS length (maxLength) according to the 3rd DMRS configuration, and may use an antenna port table according to the DMRS type (dmrs-Type) or the maximum DMRS length (maxLength). Here, mapping type A and mapping type B scheduled in the TDRA row use the same antenna port table. Accordingly, DMRS configuration for mapping type A and mapping type B may have the same DMRS port(s), the same number of DMRS symbols, and the same number of CDM groups without data. However, the location of the actually transmitted DMRS may be determined differently according to mapping type A and mapping type B.

The UE may interpret an antenna port field based on the antenna port table.

The UE may obtain DMRS port(s) from the antenna port table according to the value of the antenna port field. The DMRS port(s) may be the same for PUSCH of mapping type A and PUSCH of mapping type B.

The UE may receive an indication to use one DMRS port among the DMRS port(s) as a PTRS antenna port from the PTRS-DMRS association field of the received DCI format. Since the DMRS port of the PUSCH of mapping type A and the PUSCH of mapping type B are the same, the PTRS antenna port is also the same.

The 3rd DMRS configuration may be the same as one of the 2nd DMRS configuration or the 1st DMRS configuration. That is, upon being configured with the 3rd DMRS configuration, the UE may be configured with the same configuration as one of the 1st DMRS configuration or the 2nd DMRS configuration, but may not be configured with a configuration different from the 1st DMRS configuration and the 2nd DMRS configuration. Through this restriction, the UE may be configured with up to two different DMRS configurations.

A new higher layer signal (for example, an RRC signal) is required for the 3rd DMRS configuration. This may cause design and overhead of a higher layer signal. A method for improving this problem will be described below.

A UE may not receive a configured higher layer signal for the 3rd DMRS configuration. Instead, the 3rd DMRS configuration may be determined.

A UE may assume that the 3rd DMRS configuration is always the same as the 1st DMRS configuration. That is, the UE may use, for the 3rd DMRS configuration, the DMRS configuration for a TDRA row including only scheduling information of mapping type A. In other words, the UE may determine a DMRS for a PUSCH of mapping type B, which is scheduled by a TDRA row including different mapping types, by using DMRS configuration of mapping type A, that is, DMRS type (dmrs-Type) or DMRS maximum length (maxLength) thereof. Accordingly, the UE may use an antenna port table of mapping type A, with regard to a PUSCH of mapping type B scheduled by a TDRA row including different mapping types. Here, the location of DMRS of mapping type B may follow the scheme of mapping type B as it is.

A UE may assume that the 3rd DMRS configuration is always the same as the 2nd DMRS configuration. That is, the UE may use, for the 3rd DMRS configuration, the DMRS configuration for a TDRA row including only scheduling information of mapping type B. In other words, the UE may determine DMRS for a PUSCH of mapping type A, which is scheduled by a TDRA row including different mapping types, by using DMRS configuration of mapping type B, that is, DMRS type (dmrs-Type) or DMRS maximum length (maxLength) thereof. Accordingly, the UE may use an antenna port table of mapping type B, with regard to a PUSCH of mapping type A scheduled by a TDRA row including different mapping types. Here, the location of DMRS of mapping type A may follow the scheme of mapping type A as it is.

A UE may assume that the 3rd DMRS configuration is the same as either the 1st DMRS configuration or the 2nd DMRS configuration based on the mapping type of one piece of scheduling information among pieces of scheduling information scheduled by a TDRA row including different mapping types.

For example, a UE may assume that the 3rd DMRS configuration is the same as either the 1st DMRS configuration or the 2nd DMRS configuration based on the mapping type of the earliest scheduling information among pieces of scheduling information scheduled by a TDRA row including different mapping types. When the mapping type of the earliest scheduling information is mapping type A, the UE may assume that the DMRS configuration of mapping type A, that is, the 1st DMRS configuration is the same as the 3rd DMRS configuration. When the mapping type of the earliest scheduling information is mapping type B, the UE may assume that the DMRS configuration of mapping type B, that is, the 2nd DMRS configuration is the same as the 3rd DMRS configuration.

Here, the earliest scheduling information may be replaced by the latest scheduling information. The earliest scheduling information may be the earliest scheduling information in time.

It may be assumed that a UE receives the same DMRS type (dmrs-Type) or the same configured DMRS maximum length (maxLength). However, the above conditions may be changed and applied as follows.

The UE may expect to receive the same DMRS type (dmrs-Type) configured for different mapping types. Here, different DMRS maximum lengths (maxLength) may be configured for different mapping types. According to this condition change, the UE may use different DMRS maximum lengths in different mapping types. Therefore, the base station may indicate the DMRS length suitable for the mapping type to the UE. However, the UE may expect to receive an indication of the same DMRS port(s) for mapping type A and mapping type B.

The UE may expect to receive the same DMRS maximum length (maxLength) configured for different mapping types. Here, different DMRS types (dmrs-Type) may be set for different mapping types. According to this condition change, the UE may use different DMRS types (dmrs-Type) in different mapping types. Accordingly, the base station may configure a DMRS type suitable for the mapping type to the UE. However, the UE may expect to receive an indication of the same DMRS port(s) of mapping type A and mapping type B.

The conditions for the DMRS type (dmrs-Type) and the maximum DMRS length (maxLength) of the UE have been described, but the following conditions may be added.

A UE may expect a configuration of an additional DMRS (dmrs-AdditionalPosition) other than the same first DMRS (first DMRS or front-loaded DMRS) in different mapping types.

The DMRS configuration of mapping type A and mapping type B may have restrictions. For example, with regard to mapping type A and mapping type B, the same DMRS type (dmrs-Type) or the same maximum DMRS length (maxLength) should be configured. However, without the above restriction, the UE may always expect the same DMRS port(s) to be indicated.

A UE may expect that mapping type A and mapping type B are indicated with the same DMRS port(s). Here, an antenna port table of a PUSCH of mapping type A and an antenna port table of a PUSCH of mapping type B may be the same or different. That is, the DMRS type (dmrs-Type) and the maximum DMRS length (maxLength) configured by a base station to the UE may be the same or different. Therefore, the antenna port table corresponding to mapping type A and the antenna port table corresponding to mapping type B may be the same or different. However, when a TDRA row including different mapping types is indicated in the received DCI format, the UE may expect that DMRS port(s) of mapping type A and DMRS port(s) of mapping type B, determined according to the antenna port field of the DC format, always are the same.

The base station may freely configure DMRS configurations for mapping type A and mapping type B for the UE. The DMRS configuration may include a DMRS type (dmrs-Type) or DMRS maximum length (maxLength). Here, free configuration may be understood as that DMRS configuration of mapping type A is independent of DMRS configuration of mapping type B. When the base station provides an indication of a TDRA row including different mapping types in DCI format to the UE, the base station should indicate the value of the antenna port field so that the DMRS port(s) of mapping type A and the DMRS port(s) of mapping type B indicated in the antenna port field of the DCI format are the same.

Multiple PUSCH scheduling introduces restrictions on the same mapping type.

When a UE has an antenna port table corresponding to mapping type A different from an antenna port table corresponding to mapping type B, the UE may expect that the mapping types of pieces of scheduling information included in a TDRA row are the same. When the DMRS type (dmrs-Type) or maximum DMRS length (maxLength) of mapping type A for the UE is different from the DMRS type (dmrs-Type) or maximum length (maxLength) of mapping type B, the UE may expect that the mapping types of pieces of scheduling information included in a TDRA row are the same.

In addition, when a TDRA row including different mapping types is configured in a TDRA table, the UE may assume that an antenna port table corresponding to mapping type A and an antenna port table corresponding to mapping type B are the same. When a TDRA row including different mapping types is configured in a TDRA table, the UE may assume that a DMRS type (dmrs-Type) or DMRS maximum length (maxLength) of mapping type A and a DMRS type (dmrs-Type) or DMRS maximum length (maxLength) of mapping type B are identical to each other.

That is, the UE may be configured not to expect that a DMRS type (dmrs-Type) or DMRS maximum length (maxLength) of mapping type A and a DMRS type (dmrs-Type) or DMRS maximum length (maxLength) of mapping type B are different from each other, and that a TDRA row including different mapping types is configured in the TDRA table. The UE may be configured not to expect that an antenna port table corresponding to mapping type A and an antenna port table corresponding to mapping type B are different from each other, and that a TDRA row including different mapping types is configured in the TDRA table.

When the base station configures the DMRS type (dmrs-Type) or maximum DMRS length (maxLength) of mapping type A and the DMRS type (dmrs-Type) or maximum length (maxLength) of mapping type B to be different for the UE, the base station may configure the mapping types of pieces of scheduling information included in a TDRA row to always be the same.

When the base station configures a TDRA row including different mapping types in a TDRA table for the UE, the base station should configure the DMRS type (dmrs-Type) or maximum DMRS length (maxLength) of mapping type A and the DMRS type (dmrs-Type) or DMRS maximum length (maxLength) of mapping type B to be the same.

That is, the base station may configure the DMRS type (dmrs-Type) or maximum DMRS length (maxLength) of mapping type A differently from the DMRS type (dmrs-Type) or maximum length (maxLength) of mapping type B, and may configure a TDRA row including different mapping types to be included in the TDRA table.

Since a PUSCH scheduled in a TDRA field of a DCI format received by the UE always has the same mapping type, the location and length of the DMRS may be determined based on the DMRS configuration of the mapping type. In addition, the UE may determine one antenna port table based on the DMRS configuration of the mapping type. One row of the one antenna port table may be indicated in the antenna port field.

PTRS antenna ports of two mapping types may be indicated in a PTRS-DMRS association field.

A DCI format for scheduling a PUSCH received by a UE may include a DCI field for indicating a PTRS antenna port for each mapping type.

More specifically, some bits of the PTRS-DMRS association field may indicate one of the DMRS port(s) of mapping type A as a PTRS antenna port, and the remaining bits of the PTRS-DMRS association field may indicate one of the DMRS port(s) of mapping type B as a PTRS antenna port.

When a TDRA row including different mapping types is indicated to the UE, the PTRS-DMRS association field of the DCI format may be configured by 4 bits. Here, 2 MSB bits may indicate one of the DMRS port(s) of mapping type A as a PTRS antenna port, and 2 LSB bits may indicate one of the DMRS port(s) of mapping type B as a PTRS antenna port.

When a TDRA row, which is one mapping type, is indicated to the UE, the PTRS-DMRS association field of the DCI format may be configured by 2 bits. The 2 bits may indicate one of the DMRS port(s) of the mapping type included in a TDRA row as a PTRS antenna port.

For reference, in the above example, when a UE schedules a PUSCH of different mapping types for a TDRA row in a DCI format and when scheduling a PUSCH of one mapping type, the number of bits of the PTRS-DMRS association field required by the UE in the DCI format may be different. Therefore, the following operation may be performed to match the number of bits.

In case that at least one TDRA row in a TDRA table, configured for a UE, includes different mapping types, the UE may always expect 4 bits as a PTRS-DMRS association in the DCI format. When a TDRA row of one mapping type is indicated to the UE, 2 bits among 4 bits of the PTRS-DMRS association field of the DCI format may indicate one of the DMRS port(s) of the mapping type included in the TDRA row as a PTRS antenna port. 2 bits among the 4 bits may be selected as follows.

One of DMRS port(s) of one mapping type included in a TDRA row may be used as a PTRS antenna port, using MSB 2-bits. In addition, LSB 2-bits may not be used.

One of DMRS port(s) of one mapping type included in a TDRA row may be used as a PTRS antenna port, using LSB 2-bits. In addition, MSB 2-bits may not be used.

MSB 2 bits or LSB 2 bits may be used according to one mapping type included in a TDRA row. In case that one mapping type included in the TDRA row is mapping type A, one of the DMRS port(s) of the one mapping type may be used as a PTRS antenna port by using MSB 2-bits. In case that one mapping type included in the TDRA row is mapping type B, one of the DMRS port(s) of the one mapping type may be used as a PTRS antenna port by using LSB 2-bits.

In case that a TDRA row including different mapping types is indicated to the UE and DMRS port(s) of different mapping types are different, a PTRS-DMRS association field of a DCI format may be configured by 4 bits. Here, 2 MSB bits may indicate one of the DMRS port(s) of mapping type A as a PTRS antenna port, and 2 LSB bits may indicate one of the DMRS port(s) of mapping type B as a PTRS antenna port.

When a TDRA row, which is one mapping type, is indicated to the UE, or even if a TDRA row including different mapping types is indicated, when the DMRS port(s) of the different mapping types are the same, the PTRS-DMRS association field of the DCI format may be configured by 2 bits. The 2 bits may indicate one of the DMRS port(s) of the mapping type included in a TDRA row as a PTRS antenna port.

For reference, in the above example, when a UE schedules a PUSCH of different mapping types for a TDRA row in a DCI format and when scheduling a PUSCH of one mapping type, the number of bits of the PTRS-DMRS association field required by the UE in the DCI format may be different. Therefore, the following operation may be performed to match the number of bits.

In case that at least one TDRA row in a TDRA table, configured for a UE, includes different mapping types, and DMRS port(s) of different mapping types can be indicated differently, the UE may always expect 4 bits as a PTRS-DMRS association in the DCI format. When a TDRA row of one mapping type is indicated to the UE, or even if a TDRA row including different mapping types is indicated, when the DMRS port(s) of the different mapping types are the same, 2 bits among 4 bits of the PTRS-DMRS association field of the DCI format may indicate one of the DMRS port(s) of the mapping type included in the TDRA row as a PTRS antenna port. 2 bits among the 4 bits may be selected based on the methods described above.

In other words, the conditions for the presence of a 4-bit PTRS-DMRS association field in DCI format are as follows:
Condition 1: a case in which at least one row in a TDRA table includes different mapping types or,
Condition 2: a case in which at least one row in a TDRA table includes different mapping types and different DMRS port(s) may be indicated for different mapping types.

For reference, in case that the UE expects that the same DMRS port(s) to always be indicated, when condition 1 is used, a 4-bits PTRS-DMRS association field exists in the DCI format. However, when condition 2 is used, a 2-bits PTRS-DMRS association field exists in the DCI format.

Different bits for indicating PTRS antenna ports of different mapping types may be included in one PTRS-DMSR association field, but a new DCI field may be defined. That is, the 4-bits PTRS-DMRS association field may be represented by a first 2-bits PTRS-DMRS association field and a second 2-bits PTRS-DMRS association field. Preferably, the first 2-bits PTRS-DMRS association field may be MSB 2-bits of the 4-bits PTRS-DMRS association field described above, and the second 2-bits PTRS-DMRS association field may be LSB 2-bits of the 4-bits PTRS-DMRS association field described above.

A PTRS-DMRS association field may indicate one or more DMRS ports commonly scheduled for both mapping types.

A UE may receive, from a PTRS-DMRS association field, an indication of one or more commonly selected DMRS port(s) among DMRS port(s) of different mapping types. Here, the PTRS-DMRS association field may be 2 bits.

For example, it is assumed that a UE has received {3,4,5} as DMRS port(s) of mapping type A and {2,3,5} as DMRS port(s) of mapping type B. Here, the mapping type A corresponds to a case in which DMRS type (dmrs-Type) is 2, the maximum DMRS length (maxLength) is 2, rank of 3, and a row corresponding to the value of 2 in an antenna port table are indicated. The mapping type B corresponds to a case in which DMRS type (dmrs-Type) is 1, the maximum DMRS length (maxLength) is 2, rank of 3, and a row corresponding to the value of 2 in an antenna port table are indicated.

The UE may generate commonly scheduled DMRS port(s) by collecting DMRS port(s) included in common between DMRS port(s) of mapping type A and DMRS port(s) of mapping type B. That is, between the DMRS port(s) {3,4,5} of mapping type A and the DMRS port(s) {2,3,5} of mapping type B, {3,5} which is the commonly included DMRS port(s) may be generated as commonly scheduled DMRS port(s).

The UE may receive an indication of one DMRS port among commonly scheduled DMRS port(s) in the PTRS-DMRS association field, and may use the DMRS port to perform PTRS transmission. The PTRS-DMRS association field may indicate the value of one of “1^{st} commonly scheduled DMRS port”, “2^{nd} commonly scheduled DMRS port”, “3^{rd} commonly scheduled DMRS port”, and “4^{th} commonly scheduled DMRS port”.

Here, the DMRS port for PTRS transmission may be used in an ascending order of the value indicated by the PTRS-DMRS association field. For example, when the commonly scheduled DMRS port(s) are {3,5} and the PTRS-DMRS association field indicates “1^{st} commonly scheduled DMRS port”, the UE may use DMRS port(s) 3 as an antenna port for PTRS transmission. When the PTRS-DMRS association field indicates “2^{nd} commonly scheduled DMRS port”, the UE may use DMRS port(s) 5 as an antenna port for PTRS transmission.

Accordingly, the DMRS port having the highest received signal power may be included in two different mapping types. That is, when the base station schedules the PUSCH of mapping type A and the PUSCH of mapping type B to the UE, scheduling the DMRS port with the highest received power for one mapping type and not for the other mapping type may not be a proper operation. Therefore, at least one of DMRS port(s) commonly scheduled for two different mapping types may have the highest received signal power, and one of the at least one DMRS port may be used as an antenna port for PTRS transmission.

However, the above assumption may not always be valid. Therefore, a DMRS port with the highest received power may belong to only one mapping type, as described below.

A PTRS-DMRS association field may indicate one or more DMRS ports scheduled for two mapping types.

A UE may receive, from a PTRS-DMRS association field, an indication of one or more DMRS port(s) obtained by collecting all of DMRS port(s) of different mapping types. Here, the PTRS-DMRS association field may be larger than 2 bits. For example, the PTRS-DMRS association field may be 3 bits.

For example, it is assumed that a UE has received {3,4,5} as DMRS port(s) of mapping type A and {2,3,6} as DMRS port(s) of mapping type B. Here, the mapping type A corresponds to a case in which DMRS type (dmrs-Type) is 2, the maximum DMRS length (maxLength) is 2, rank of 3, and a row corresponding to the value of 2 in an antenna port table are indicated. The mapping type B corresponds to a case in which DMRS type (dmrs-Type) is 1, the maximum DMRS length (maxLength) is 2, rank of 3, and a row corresponding to the value of 2 in an antenna port table are indicated.

The UE may generate all of scheduled DMRS port(s) by collecting both DMRS port(s) of mapping type A and DMRS port(s) of mapping type B. That is, the UE may collect both DMRS port(s) {3,4,5} of mapping type A and DMRS port(s) {2,3,6} of mapping type B, to generate all DMRS port(s) {3,4,5,6} as all of scheduled DMRS port(s).

The UE may receive an indication of one DMRS port among all of scheduled DMRS port(s) in the PTRS-DMRS association field, and may use the DMRS port to perform PTRS transmission. The PTRS-DMRS association fields may indicate the value of one of the “1^{st} all of scheduled DMRS port”, “2^{nd} all of scheduled DMRS port”, “3^{rd} all of scheduled DMRS port”, “4^{th} all of scheduled DMRS port”, “5^{th} all of scheduled DMRS port”, “6^{th} all of scheduled DMRS port”, “7^{th} all of scheduled DMRS port”, and “8^{th} all of scheduled DMRS port”. Here, the DMRS port for PTRS transmission may be used in an ascending order of the value indicated by the PTRS-DMRS association field.

For example, when all of scheduled DMRS port(s) are {3,4,5,6} and the PTRS-DMRS association field indicates “1^{st} all of scheduled DMRS port”, the UE may use DMRS port(s) 3 as an antenna port for PTRS transmission. When the PTRS-DMRS association field indicates “2^{nd} all of scheduled DMRS port”, the UE may use DMRS port(s) 4 as an antenna port for PTRS transmission. When the PTRS-DMRS association field indicates “3^{rd} all of scheduled DMRS port”, the UE may use DMRS port(s) 5 as an antenna port for PTRS transmission. When the PTRS-DMRS association field indicates “4^{th} all of scheduled DMRS port”, the UE may use DMRS port(s) 6 as an antenna port for PTRS transmission.

A PTRS-DMRS association field may directly indicate the index of the DMRS antenna port.

A UE may have received, from the PTRS-DMRS association field, an indication of one of the DMRS port(s) scheduled for different mapping types, and may have used one DMRS port to perform PTRS transmission based on the indication. The UE may be indicated to use one of possible DMRS port(s) regardless of scheduling. That is, the PTRS-DMRS association field may indicate an index of one DMRS port.

Here, DMRS ports that can be indicated may be all DMRS ports usable according to the DMRS type (dmrs-Type). For example, when 1 is configured as the DMRS type (dmrs-type), the usable DMRS ports may be DMRS ports 0 to 7. When 2 is configured as the DMRS type (dmrs-type), the usable DMRS ports may be DMRS ports 0 to 11. When DMRS ports 1 and 2 are simultaneously configured as DMRS types (dmrs-type) for different mapping types, the usable DMRS ports may be DMRS ports 0 to 11. The PTRS-DMRS association field may indicate an index of one of the usable DMRS ports.

Here, DMRS ports that can be indicated may be all DMRS ports usable according to the DMRS type (dmrs-Type) and the maximum DMRS length (maxLength). When 1 is configured as the DMRS type (dmrs-type) and the maximum DMRS length is 1, the usable DMRS ports may be DMRS ports 0 to 3. When 1 is configured as the DMRS type (dmrs-type) and the maximum DMRS length is 2, the usable DMRS ports may be DMRS ports 0 to 7. When 2 is configured as the DMRS type (dmrs-type) and the maximum DMRS length is 1, the usable DMRS ports may be DMRS ports 0 to 5. When 2 is configured as the DMRS type (dmrs-type) and the maximum DMRS length is 2, the usable DMRS ports may be DMRS ports 0 to 11. When a DMRS type (dmrs-type) or a maximum DMRS length are configured for different mapping types, the maximum DMRS port of each configuration may be a usable DMRS port.

Here, DMRS ports that can be indicated may be some of the DMRS port(s) of DMRS configuration. Some of the DMRS port(s) may be configured via a separate higher layer signal.

The UE may receive an indication of one DMRS port among usable DMRS port(s) from the PTRS-DMRS association field, and may use the DMRS port to perform PTRS transmission. The PTRS-DMRS association field may indicate the value of one of “DMRS port 0”, “DMRS port 1”, and/or “DMRS port 2”. Here, the order of the DMRS port for PTRS transmission may be used in ascending order. For example, when the PTRS-DMRS association field indicates “DMRS port 3”, the UE may use DMRS port(s) 3 as an antenna port for PTRS transmission.

The length of the PTRS-DMRS association field may be determined according to the number of usable DMRS port(s). For example, the length of the PTRS-DMRS association field may be determined as ceil(log 2 (the number of usable DMRS port(s)).

A PTRS-DMRS association field may indicate a PTRS antenna port of one mapping type, and this PTRS antenna port may be used in all PUSCHs.

A UE may receive an indication, from the PTRS-DMRS association field, of one of the DMRS port(s) scheduled for different mapping types, and use one DMRS port to perform PTRS transmission based on the indication. However, the UE may receive, from the PTRS-DMRS association field, an indication of one of DMRS port (s) scheduled for one mapping type, and may transmit a PTRS through an antenna port obtained through the indication. The UE may transmit a PTRS for another mapping type through the same antenna port as the antenna port obtained through the above indication.

When the UE receives an indication of a TDRA row including different mapping types, the UE may select one of mapping type A and mapping type B to apply the PTRS-DMRS association field. For example, the selection may be made based on at least one of the following:
The UE may always select mapping type A. That is, the PTRS-DMRS association field may indicate one of DMRS port(s) of mapping type A.
The UE may always select mapping type B. That is, the PTRS-DMRS association field may indicate one of DMRS port(s) of mapping type B.
The UE may select a mapping type of the first scheduled PUSCH. That is, the PTRS-DMRS association field may indicate one of the DMRS port(s) of the mapping type of the first scheduled PUSCH. Here, the first scheduled PUSCH may be a PUSCH scheduled at the earliest position in time. Here, the first scheduled PUSCH may be a PUSCH corresponding to scheduling information configured first from a higher layer in the indicated TDRA row.

For example, it is assumed that a UE has received {3,4,5} as the DMRS port(s) of mapping type A and {2,3,6} as the DMRS port(s) of mapping type B. Here, mapping type A corresponds to a case in which DMRS type (dmrs-Type) is 2, the maximum DMRS length (maxLength) is 2, rank of 3, and a row corresponding to the value of 2 in an antenna port table are indicated. Mapping type B corresponds to a case in which DMRS type (dmrs-Type) is 1, the maximum DMRS length (maxLength) is 2, rank of 3, and a row corresponding to the value of 2 in an antenna port table are indicated.

The UE may receive an indication of one DMRS port among DMRS port(s) selected from in the PTRS-DMRS association field, and may use the DMRS port to perform PTRS transmission. The PTRS-DMRS association field may indicate the value of one of “1^{st} commonly scheduled DMRS port”, “2^{nd} commonly scheduled DMRS port”, “3^{rd} commonly scheduled DMRS port”, and “4^{th} commonly scheduled DMRS port”.

Here, the DMRS port for PTRS transmission may be used in an ascending order of the value indicated by the PTRS-DMRS association field. For example, when the selected mapping type is mapping type A, the scheduled DMRS port(s) are {3,4,5}, and when the PTRS-DMRS association field indicates “1^{st} commonly scheduled DMRS port”, the UE may use DMRS port(s) 3 as an antenna port for PTRS transmission. When the PTRS-DMRS association field indicates “2^{nd} commonly scheduled DMRS port”, the UE may use DMRS port(s) 4 as an antenna port for PTRS transmission. When the PTRS-DMRS association field indicates “3^{rd} commonly scheduled DMRS port”, the UE may use DMRS port(s) 5 as an antenna port for PTRS transmission.

When all of the antenna ports are included in the scheduled DMRS port(s) of two different mapping types, a PTRS may be transmitted through the antenna ports. However, the determined antenna port may be included in the scheduled DMRS port(s) of one mapping type, but may not be included in the scheduled DMRS port(s) of another mapping type. In this case, the UE may perform the following operations.

As a first operation, when the determined antenna port is not included in the scheduled DMRS port(s) of another mapping type, a PTRS may not be transmitted through the PUSCH of the mapping type. That is, a PTRS may be transmitted only in the case of one mapping type.

As a second operation, when the determined antenna port is not included in the scheduled DMRS port(s) of another mapping type, a PTRS may be transmitted through a specific DMRS port in the PUSCH of the mapping type. Here, a specific DMRS port may be a DMRS port with the lowest index among scheduled DMRS ports.

Although embodiments have been separately described above, this is for convenience of explanation, and it is also possible to implement a combination of embodiments. In addition, in various embodiments of the disclosure, for convenience of explanation, the operation of a UE has been mainly described, but the technical features of the various embodiments of the disclosure described as the operation of the UE may also be applied to the configuration of a base station and the operation of the base station.

As described above, a specific embodiment of an antenna port association field and a specific embodiment of a PTRS association field have been separately described, but this is only for convenience of explanation, and embodiments relating to an antenna port association field and a PTRS association field can be combined and implemented. In addition, it should be noted that the term “embodiment” is also for convenience of explanation, and embodiments can be selectively combined and implemented within a non-contradictory range.

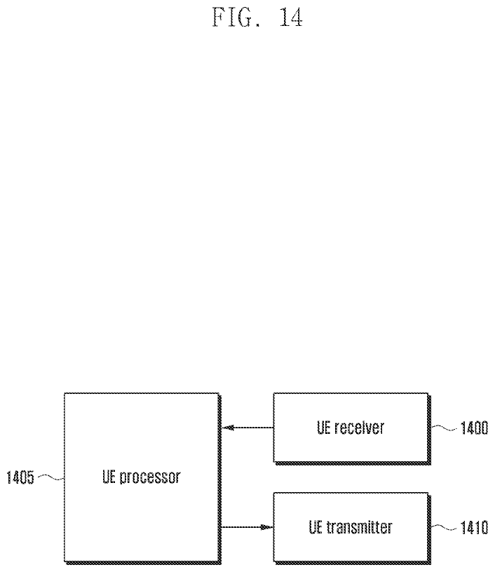

FIG. 14 illustrates the structure of a UE in a wireless communication system, according to an embodiment.

Referring to FIG. 14, a UE may include a transceiver referring to a UE receiver 1400 and a UE transmitter 1410, a memory, and a UE processor 1405 (or a UE controller or processor). According to the communication method of the UE described above, the transceiver (receiver 1400 and transmitter 1410), the memory, and the UE processor 1405 of the UE may operate. However, the elements of the UE are not limited to the above-described examples. For example, the UE may include more or fewer elements than the aforementioned elements. In addition, the transceiver, memory, and processor may be implemented in a single chip.

The transceiver may transmit/receive a signal to/from a base station. Here, the signal may include control information and data. To this end, the transceiver may include a radio frequency (RF) transmitter configured to up-convert and amplify the frequency of a transmitted signal, and an RF receiver configured to perform low-noise amplification of a received signal and down-convert the frequency thereof. However, this is only one embodiment of the transceiver, and elements of the transceiver are not limited to the RF transmitter and the RF receiver.

In addition, the transceiver may receive a signal through a wireless channel, output the signal to the processor, and transmit a signal output from the processor through the wireless channel.

The memory may store programs and data required for operation of the UE. In addition, the memory may store control information or data included in signals transmitted and received by the UE. The memory may include a storage medium such as a read only memory (ROM), a random access memory (RAM), a hard disk, a compact disc (CD)-ROM, a digital versatile disc (DVD), or a combination of storage media. In addition, there may be multiple memories.

In addition, the processor may control a series of processes so that the UE may operate according to the above-described embodiment. For example, the processor may control elements of the UE so as to receive DCI configured by two layers and simultaneously receive multiple PDSCHs. There may be multiple processors, and the processors may perform an operation of controlling elements of the UE by executing a program stored in a memory.

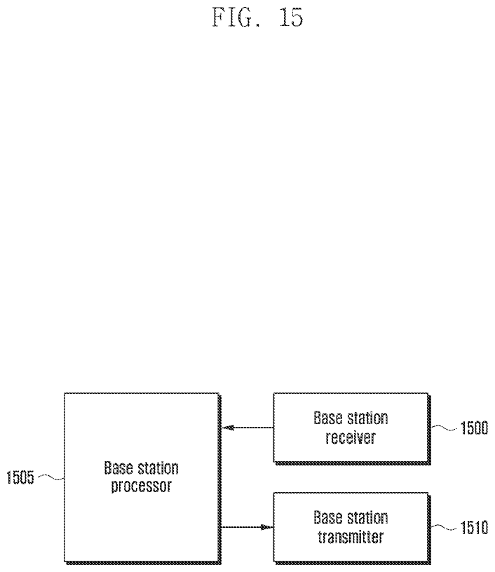

FIG. 15 illustrates the structure of a base station in a wireless communication system, according to an embodiment.

Referring to FIG. 15, a base station may include a transceiver referring to a base station receiver 1500 and a base station transmitter 1510, a memory, and a base station processor 1505 (or a base station controller or processor). According to the communication method of the base station described above, the transceiver (receiver 1500 and transmitter 1510), the memory, and the base station processor 1505 of the base station may operate. However, the elements of the base station are not limited to the above-described examples. For example, the base station may include more or fewer elements than the aforementioned elements. In addition, the transceiver, memory, and processor may be implemented in a single chip.

The transceiver may transmit/receive a signal to/from a UE. Here, the signal may include control information and data. To this end, the transceiver may include an RF transmitter configured to up-convert and amplify the frequency of a transmitted signal, and an RF receiver configured to perform low-noise amplification of a received signal and down-convert the frequency thereof. However, this is only one embodiment of the transceiver, and elements of the transceiver are not limited to the RF transmitter and the RF receiver.

In addition, the transceiver may receive a signal through a wireless channel, output the signal to the processor, and transmit a signal output from the processor through the wireless channel.

The memory may store programs and data required for operation of the base station. In addition, the memory may store control information or data included in signals transmitted and received by the base station. The memory may include a storage medium such as a ROM, a RAM, a hard disk, a CD-ROM, and a DVD, or a combination of storage media. In addition, there may be multiple memories.

The processor may control a series of processes so that the base station operates according to the above-described embodiment of the disclosure. For example, the processor may control each element of the base station so as to configure and transmit two layers of DCI including allocation information for multiple PDSCHs. There may be multiple processors, and the processors may perform operation of controlling elements of the base station by executing a program stored in a memory.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a ROM, an electrically erasable programmable read only memory (EEPROM), a magnetic disc storage device, a CD-ROM, DVDs, other type optical storage devices, or a magnetic cassette. Alternatively, any combination of some or all of the memories may form a memory in which the program is stored. Further, a plurality of such memories may be included in the electronic device.

In addition, the programs may be stored in an attachable storage device which may access the electronic device through communication networks such as the Internet, an intranet, a local area network (LAN), a wide LAN (WLAN), a storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected for convenience of description, and the disclosure is not limited by elements expressed in the singular or the plural. Therefore, either an element expressed in the plural form may also include a single element or an element expressed in the singular form may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. Moreover, although the above embodiments have been described based on the FDD LTE system, other variants based on the technical idea of the embodiments may also be implemented in other systems such as TDD LTE, 5G, and NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and some elements may be included therein without departing from the essential spirit and scope of the disclosure.

Furthermore, in methods of the disclosure, some or all of the contents of each embodiment may be implemented in combination without departing from the essential spirit and scope of the disclosure.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, a higher layer signal including time domain resource assignment (TDRA) information;
receiving, from the base station, downlink control information (DCI) including an antenna port field; and
identifying an antenna port table of a first mapping type and an antenna port table of a second mapping type based on the antenna port field, in case that the DCI includes multiple scheduling information of different mapping types.

2. The method of claim 1, wherein the antenna port field is composed of a first bit field for the antenna port table of the first mapping type and a second bit field for the antenna port table of the second mapping type.

3. The method of claim 1, wherein the antenna port field is composed of a single bit field for indicating the antenna port table of the first mapping type and the antenna port table of the second mapping type.

4. The method of claim 1, wherein the DCI includes a phase tracking reference signal (PTRS) demodulation reference signal (DMRS) related field, and
wherein the PTRS DMRS related field is composed of a first bit field for the antenna port table of the first mapping type and a second bit field for the antenna port table of the second mapping type.

5. A method performed by a base station in a wireless communication system, the method comprising:
transmitting, to a terminal, a higher layer signal including time domain resource assignment (TDRA) information; and
transmitting, to the terminal, downlink control information (DCI) including an antenna port field,
wherein an antenna port table of a first mapping type and an antenna port table of a second mapping type are identified based on the antenna port field, in case that the DCI includes multiple scheduling information of different mapping types.

6. The method of claim 5, wherein the antenna port field is composed of a first bit field for the antenna port table of the first mapping type and a second bit field for the antenna port table of the second mapping type.

7. The method of claim 5, wherein the antenna port field is composed of a single bit field for indicating the antenna port table of the first mapping type and the antenna port table of the second mapping type.

8. The method of claim 5, wherein the DCI includes a phase tracking reference signal (PTRS) demodulation reference signal (DMRS) related field,
wherein the PTRS DMRS related field is composed of a first bit field for the antenna port table of the first mapping type and a second bit field for the antenna port table of the second mapping type.

9. A terminal in a wireless communication system, the terminal comprising:
a transceiver; and
a controller configured to:
receive, from a base station, higher layer signal including time domain resource assignment (TDRA) information,
receive, from the base station, downlink control information (DCI) including an antenna port field, and
identify an antenna port table of a first mapping type and an antenna port table of a second mapping type based on the antenna port field, in case that the DCI includes multiple scheduling information of different mapping types.

10. The terminal of claim 9, wherein the antenna port field is composed of a first bit field for the antenna port table of the first mapping type and a second bit field for the antenna port table of the second mapping type.

11. The terminal of claim 9, wherein the antenna port field is composed of a single bit field for indicating the antenna port table of the first mapping type and the antenna port table of the second mapping type.

12. The terminal of claim 9, wherein the DCI includes a phase tracking reference signal (PTRS) demodulation reference signal (DMRS) related field, and
wherein the PTRS DMRS related field is composed of a first bit field for the antenna port table of the first mapping type and a second bit field for the antenna port table of the second mapping type.

13. A base station in a wireless communication system, the base station comprising:
a transceiver; and
a controller configured to:
transmit, to a terminal, a higher layer signal including time domain resource assignment (TDRA) information, and
transmit, to the terminal, downlink control information (DCI) including an antenna port field,
wherein an antenna port table of a first mapping type and an antenna port table of a second mapping type are identified based on the antenna port field, in case that the DCI includes multiple scheduling information of different mapping types.

14. The base station of claim 13, wherein the antenna port field is composed of a first bit field for the antenna port table of the first mapping type and a second bit field for the antenna port table of the second mapping type.

15. The base station of claim 13, wherein the antenna port field is composed of a single bit field for indicating the antenna port table of the first mapping type and the antenna port table of the second mapping type.

16. The base station of claim 13, wherein the DCI includes a phase tracking reference signal (PTRS) demodulation reference signal (DMRS) related field, and
wherein the PTRS DMRS related field is composed of a first bit field for the antenna port table of the first mapping type and a second bit field for the antenna port table of the second mapping type.
